(19) United States
(12) Patent Application Publication
(10) Pub. No.: US 2009/0228777 A1
(43) Pub. Date: Sep. 10, 2009

(54) System and Method for Search

(75) Inventors: Daniel J. Henry, Troy, MI (US); Michael R. Bascobert, Clarkston, MI (US)

Correspondence Address: Daniel J. Henry, 2980 Townhill, Troy, MI, 48084, US

(73) Assignee: AccuPatent, Inc., Troy, MI (US)

(21) Appl. No.: 12/389,366

(22) Filed: Feb. 19, 2009

Related U.S. Application Data
(63) Continuation-in-part of application No. 12/193,039, filed on Aug. 17, 2008.
(60) Provisional application No. 60/956,407, filed on Aug. 17, 2007.
(60) Provisional application No. 61/049,813, filed on May 2, 2008.
(60) Provisional application No. 61/142,651, filed on Jan. 6, 2009.
(60) Provisional application No. 61/151,506, filed on Feb. 10, 2009.

(51) Int. Cl. G06F 17/00; G06F 17/30

(52) U.S. Cl. 715/230; 715/255; 707/5; 707/E17.014

(57) ABSTRACT

A method for associating graphical information and text information includes providing the graphical information, the graphical information comprising at least one identifier in the graphical information for identifying at least one portion of the graphical information. The method further includes providing the text information and associating the portion with the text information through a commonality between the identifier and the text information.

### RELATED APPLICATIONS

The present application is a continuation in part of U.S. patent application Ser. No. 12/193,039, titled “System and Method for Analyzing a Document”, filed Aug. 17, 2008, which in turn claims priority to U.S. Provisional Application Ser. No. 60/956,407, titled “System and Method for Analyzing a Document,” filed on Aug. 17, 2007, and also claims priority to U.S. Provisional Application Ser. No. 61/049,813, titled “System and Method for Analyzing Documents,” filed on May 2, 2008, the present application also claims priority to U.S. Provisional Application Ser. No. 61/142,651, titled “System and Method for Search”, filed Jan. 6, 2009 and U.S. Provisional Application Ser. No. 61/151,506, titled “System and Method for Search”, filed Feb. 10, 2009, the contents of the above mentioned applications are hereby incorporated by reference in their entirety.

### TECHNICAL FIELD

The embodiments described herein are generally directed to document analysis and search technology.

### BACKGROUND

Conventional word processing, typing or creation of complex legal documents, such as patents, commonly utilizes a detailed review to ensure accuracy. Litigators and other analysts that review issued patents many times look for critical information related to those documents for a multitude of purposes.

As discussed herein, the systems and methods provide for document analysis. Systems such as spell checkers and grammar checkers only look to a particular word (in the case of a spell checker) and a sentence (in the case of a grammar checker) and only attempt to identify basic spelling and grammar errors. However, these systems do not provide for checking or verification within the context of an entire document that may also include graphical elements and do not look for more complex errors or to extract particular information.

Conventional document display devices provide text or graphical information related to a document, such as a patent download service. However, such conventional document display devices do not interrelate critical information in such documents to allow correlation of important information across multiple information sources. Moreover, such devices do not interrelate graphical and textual elements.

With respect to programming languages, certain tools are used by compilers and/or interpreters to verify the accuracy of structured-software language code. However, software-language lexers (e.g., a lexical analysis tool) differ from natural language documents (e.g., a document produced for humans) in that lexers use rigid rules for interpreting keywords and structure. Natural language documents such as patent application or legal briefs are loosely structured when compared to rigid programming language requirements. Thus, strict rule-based application of lexical analysis is not possible. Moreover, current natural language processing (NLP) systems are not capable of document-based analysis.

Moreover, conventional search methods may not provide relevant information. In an example, documents are produced from a search that may include search keywords, but are cluttered through the document, or non-existent. Thus, an improved search method is desired.

### BRIEF DESCRIPTION OF THE DRAWINGS

The present invention will now be described, by way of example, with reference to the accompanying drawings, in which:

FIG. 1 shows an example of a high-level processing apparatus for use with the examples described herein.

FIG. 1A is an alternative system that may further include sources of information external to the information provided by the user.

FIG. 2 shows an example of a system for information analysis that includes a server/processor, a user, and multiple information repositories.

FIG. 3 shows a flow diagram of the overview for information analysis, shown as an example of a patent application document analysis.

FIG. 4 shows another analysis example.

FIG. 5 shows an example of a process for extracting information or identifying errors related to the specification and claim sections in a patent or patent application;

FIG. 6 shows an example of a process for identifying errors in the specification and claims of a patent document;

FIG. 7 shows an example for processing drawing information is shown and described;

FIG. 8 shows another example for a process flow 700 is shown for identifying specification and drawing errors is described;

FIG. 9 shows association of specification terms, claim terms and drawing element numbers;

FIG. 10 shows an output to a user;

FIG. 11 shows prosecution history analysis of a patent application or patent;

FIG. 12 shows a search in an attempt to identify web pages that employ or use certain claim or specification terms;

FIG. 13 shows another example relating to classification and sub-classification;

FIG. 14 shows an alternative output for a user;

FIG. 15 shows an alternative example that employs a translation program to allow for searching of foreign patent databases;

FIG. 16 shows an alternative example employing heuristics to generate claims that include specification element numbers;

FIG. 17 shows an alternative example that generates a summary and an abstract from the claims of a patent document;

FIG. 18 shows an alternative example to output drawings for the user that include the element number and specification element name;

FIG. 19 shows an OCR process adapted to reading patent drawings and figures;

FIG. 20 includes an exemplary patent drawing page that includes multiple non-contacting regions;

FIG. 21 is a functional flow diagram of a document analysis system for use with the methods and systems described herein; and

FIG. 22 shows a word distribution map for use with the methods and systems described herein.

FIG. 23 shows an example of a processing apparatus according to examples described herein.

FIG. 24 shows an example of a processing apparatus according to examples described herein.

FIG. 25 shows an example of a processing apparatus according to examples described herein.

FIG. 26 shows a diagrammatical view according to an example of an example described herein.

FIG. 27 shows a diagrammatical view according to an example described herein.

FIG. 28 shows a diagrammatical view according to an example described herein.

FIG. 29 shows a diagrammatical view according to an example described herein.

FIG. 30 shows a diagrammatical view according to an example described herein.

FIG. 31 shows a diagrammatical view according to an example described herein.

FIG. 32 shows a diagrammatical view according to an example described herein.

FIG. 33 is an example of a document type classification tree.

FIG. 34 is an example of a document having sections.

FIG. 35 is an example of document analysis for improved indexing, searching, and display.

FIG. 36 shows an analysis of a document to determine the highly relevant text that may be used in indexing and searching.

FIG. 37 is an example of a general web page that may be sectionalized and analyzed by a general web page rule.

FIG. 38 is an example of a document analysis method.

FIG. 39 is an example of a document indexing method.

FIG. 40 is an example of a document search method.

FIG. 41 is a method for indexing, searching, presenting results, and post processing documents in a search and review system.

FIG. 42 is a method of searching a document based on document type.

FIG. 43 shows the fields used for search, where each field may be searched and weighted individually to determine relevancy.

FIG. 44 is a relevancy ranking method where each field may have boosting applied to make the field more relevant than others.

FIG. 45 is a relevancy ranking method for a patent “infringement” search.

FIG. 46 is a general relevancy ranking method for patent documents.

FIG. 47 is a method of performing a search based on a document identifier.

FIG. 48 is a method of creating combinations of search results related to search terms.

FIG. 49 is a method of identifying the most relevant image related to search terms.

FIG. 50 is a method of relating images to certain portions of a text document.

FIG. 51 is a method of determining relevancy of documents (or sections of documents) based on the location of search terms within the text.

FIG. 52 is a method of determining relevancy of images based on the location of search terms within the image and/or the document.

FIG. 53 is a search term broadening method.

FIG. 54 is an example of a method of determining relevancy after search results are retrieved.

FIG. 55 is an example of a method for generally indexing and searching documents.

FIG. 56 is an example, where indexing may be performed on the document text and document analysis and relevancy determination is performed after indexing.

FIG. 57 is a method for identifying text elements in graphical objects, which may include patent documents.

FIG. 58 is an example of a method for extracting relevant elements and/or terms from a document.

FIG. 59 is a method for relating text and/or terms within a document.

FIG. 60 is a method of listing element names and numbers on a drawing page of a patent.

FIG. 61 is an example of a drawing page before markup.

FIG. 62 is an example of a drawing page after markup.

FIG. 63 is an example of a search results screen for review by a user.

FIG. 64 is an example of a system for processing documents.

FIG. 65 is an example of a system for identifying embodiments.

FIG. 66 is an example of a system for processing documents.

FIG. 67 is an example of a system providing for processing of the text portions of a document.

FIG. 68 is an example of a system providing for processing of the graphical portions of a document.

FIG. 69 is an example of a system that combines text and graphics processing.

FIG. 70 is an example of a method for identifying an embodiment.

FIG. 71 is an example of a method for identifying an embodiment.

FIG. 72 is an example of a method for determining relations any document based on both text information and graphics information.

FIG. 73 is an example of relations within a patent document.

FIG. 74 is an example of a system for indexing document.

FIG. 75 is an example of an index record for a document that includes embodiments.

FIG. 76 is an example an index record for an embodiment.

FIG. 77 is an example of different types of search systems.

FIG. 78 is an example of a system for searching documents.

FIG. 79 is an example of a method for searching a collection of documents.

FIG. 80 is an example output of a result system output that provides a list of ranked documents based on the user's search input.

FIG. 81 is an example of a visual search result.

FIG. 82 is an example of a single document search.

FIG. 83 is an example of a scoring for a particular document based on search terms or other information.

FIG. 84 is an example of a system for scoring embodiments.

FIG. 85 is an example of a search system.

FIG. 86 is an example of a synonym expanded search.

FIG. 87 is an example of a search term suggestion system.

FIG. 88 is an example of a report generation system.

FIG. 89 is an example of a report method.

FIG. 90 is an example of report generation that provides document markup.

FIG. 91 is an example report.

FIG. 92 is an example of a method for generating a report.

FIG. 93 is an example of a report generator system.

FIG. 94 is an example of a visual report.

FIG. 95 is an example of a blended report.

FIG. 96 is an example of a method for generating a report.

FIG. 97 is an example of a report.

FIG. 98 is an example of a method for generating a report including citations.

FIG. 99 is an example of a system for performing OCR on a document.

FIG. 100 is an example of a method for performing OCR on a document.

FIG. 101 is an example of an invalidation search method.

FIG. 102 is an example of an invalidation argument generation method.

FIG. 103 is an example of a weak combination of §103 art.

FIG. 104 is an example of a stronger combination of §103 art.

FIG. 105 is an example showing a combination of three pieces of prior to invalidate two claim terms.

FIG. 106 shows an example of a flow chart in accordance with one aspect of the invention.

FIG. 107 shows an example of a screen shot of a display for use with the embodiments described herein.

FIG. 108 shows an example of a flow chart in accordance with one aspect of the invention.

FIG. 109 shows an example of a screen shot of a display for use with the embodiments described herein.

FIG. 110 shows an example of a flow chart in accordance with one aspect of the invention.

FIG. 111 shows an example of a screen shot of a display for use with the embodiments described herein.

FIG. 112 shows an example of a flow chart in accordance with one aspect of the invention.

FIG. 113 shows an example of a flow chart in accordance with one aspect of the invention.

FIG. 114 shows an example of a screen shot of a display for use with the embodiments described herein.

FIG. 115 shows an example of a flow chart in accordance with one aspect of the invention.

FIG. 116 shows an example of a flow chart in accordance with one aspect of the invention.

FIG. 117 shows an example of a flow chart in accordance with one aspect of the invention.

FIG. 118 shows an example of a screen shot of a display for use with the embodiments described herein.

FIG. 119 shows an example of a flow chart in accordance with one aspect of the invention.

FIG. 120 shows an example of a flow chart in accordance with one aspect of the invention.

FIG. 121 shows an example of a screen shot of a display for use with the embodiments described herein.

FIG. 122 shows an example of a flow chart in accordance with one aspect of the invention.

FIG. 123 shows an example of a flow chart in accordance with one aspect of the invention.

FIG. 124 shows an example of a flow chart in accordance with one aspect of the invention.

FIG. 125 shows an example of a flow chart in accordance with one aspect of the invention.

FIG. 126 shows a diagram according to one aspect of the invention.

FIG. 127 shows an example of a flow chart in accordance with one aspect of the invention.

FIG. 128 shows an example of a flow chart in accordance with one aspect of the invention.

FIG. 129 shows an example of a flow chart in accordance with one aspect of the invention.

FIG. 130 shows an example of a flow chart in accordance with one aspect of the invention.

FIG. 131 shows an example of a flow chart in accordance with one aspect of the invention.

FIG. 132 shows an example of a flow chart in accordance with one aspect of the invention.

FIG. 133 shows an example of a flow chart in accordance with one aspect of the invention.

FIG. 134 shows an example of a flow chart in accordance with one aspect of the invention.

FIG. 135 shows an example of a flow chart in accordance with one aspect of the invention.

FIG. 136 shows an example of a flow chart in accordance with one aspect of the invention.

FIG. 137 shows an example of a flow chart in accordance with one aspect of the invention.

FIG. 138 shows an example of a flow chart in accordance with one aspect of the invention.

FIG. 139 shows an example of a flow chart in accordance with one aspect of the invention.

### DETAILED DESCRIPTION

The present application is a continuation in part of U.S. patent application Ser. No. 12/193,039, titled “System and Method for Analyzing a Document”, filed Aug. 17, 2008, which in turn claims priority to U.S. Provisional Application Ser. No. 60/956,407, titled “System and Method for Analyzing a Document,” filed on Aug. 17, 2007, and also claims priority to U.S. Provisional Application Ser. No. 61/049,813, titled “System and Method for Analyzing Documents,” filed on May 2, 2008, the present application also claims priority to U.S. Provisional Application Ser. No. 61/142,651, titled “System and Method for Search”, filed Jan. 6, 2009 and U.S. Provisional Application Ser. No. 61/151,506, titled “System and Method for Search”, filed Feb. 10, 2009, the contents of the above mentioned applications are hereby incorporated by reference in their entirety into the specification and drawings.

Referring now to the drawings, illustrative embodiments are shown in detail. Although the drawings represent the embodiments, the drawings are not necessarily to scale and certain features may be exaggerated to better illustrate and explain an embodiment. Further, the embodiments described herein are not intended to be exhaustive or otherwise limit or restrict the invention to the precise form and configuration shown in the drawings and disclosed in the following detailed description.

Discussed herein are examples of document analysis and searching. The methods disclosed herein may be applied to a variety of document types, including text-based documents, mixed-text and graphics, video, audio, and combinations thereof. Information for analyzing the document may come from the document itself, as contained in metadata, for example, or it may be generated from the document using rules. The rules may be determined by classifying the document type, or manually. Using the rules, the document may be processed to determine which words or images are more relevant than others. Additionally, the document may be processed to allow for tuned relevancy depending upon the type of search applied, and how to present the results with improved or enhanced relevancy. In addition, the presentation of each search result may be improved by providing the most relevant portion of the document for initial review by the user, including the most relevant image. The documents discussed herein may apply to patent documents, books, web pages, medical records, SEC documents, legal documents, etc. Examples of document types are provided herein and are not intended to be exhaustive. The examples show that different rules may apply depending upon the document type, and where documents are encountered that are not discussed herein, rules may be developed for those documents in the spirit of rule building shown in the examples below.

One example described herein is a system and method for verifying a patent document or patent application. However, other applications may include analyzing a patent document itself, as well as placing the elements of the patent document in context of other documents, including the patent file wrapper. Yet another application may include verifying the contents of legal briefs. Although a patent or patent application is used in the following examples, it will be understood that the processes described herein apply to and may be used with any document.

In one example, a document is either uploaded to a computer system by a user or extracted from a storage device. The document may be any form of a written or graphical instrument, such as a 10-K, 10-Q, FDA phase trial documents, patent, publication, patent application, trial or appellate brief, legal opinion, doctoral thesis, or any other document having text, graphical components or both.

The document is processed by the computer system for errors, to extract specific pieces of information, or to mark-up the document. For example, the text portion of the document may be analyzed to identify errors therein. The errors may be determined based on the type of document. For example, where a patent application is processed the claim terms may be checked against the detailed description. Graphical components may be referenced by or associated with text portions referencing such graphical portions of a figure (e.g., a figure of a patent drawing). Relevant portions of either the text or graphics may be extracted from the document and output in a form, report format, or placed back into the document as comments. The graphical components or text may be marked with relevant information such as element names or colorized to distinguish each graphical element from each other.

Upon identifying such relevant information, further analysis can be conducted relevant to the document or information contained therein. For example, based on information extracted from the document, analysis of other sources of information or other documents may be conducted to obtain additional information relating to the document.

An output is then provided to the user. For example, a report may be generated made available to the user as a file (e.g., a Word® document, a PDF document, a spreadsheet, a text file, etc.) or a hard copy. Alternatively, a marked up version of the original document may be presented to the user in a digital or hardcopy format. In another example, an output comprising a hybrid of any of these output formats may be provided to the user as well.

Other types of documents that may use verification or checking include a response to an office action or an appeal brief (both relating to the USPTO). Here, any quotations or block text may be checked for accuracy against a reference. In an example, the text of a block quote or quotation is checked against the patent document for accuracy as well as the column & line number citation. In another example, a quote from an Examiner may be checked for accuracy against an office action that is in PDF form and loaded into the system. In another example, claim quotes from the argument section of a response may be checked against the as-amended claims for final accuracy.

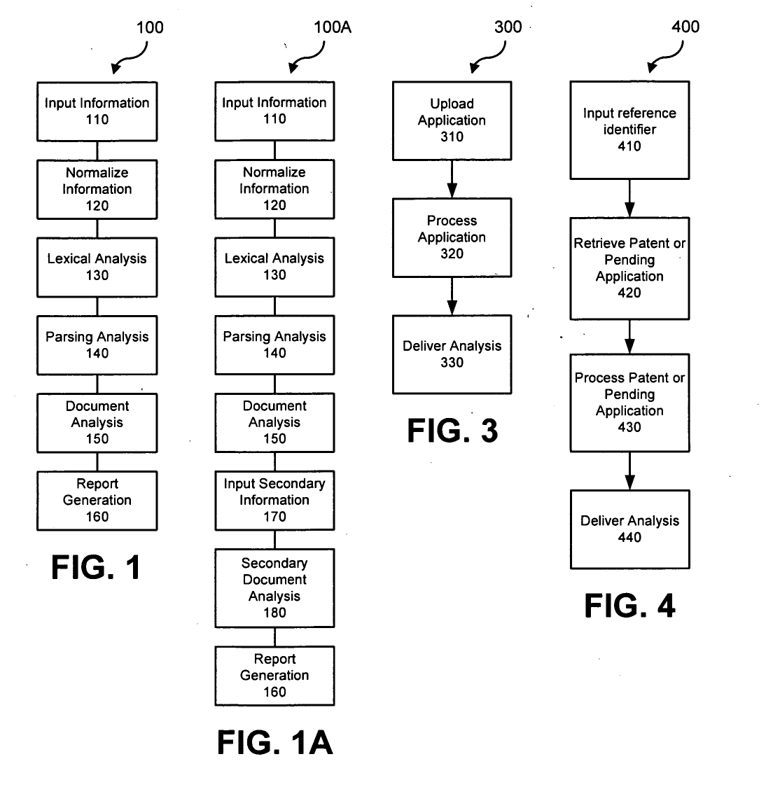

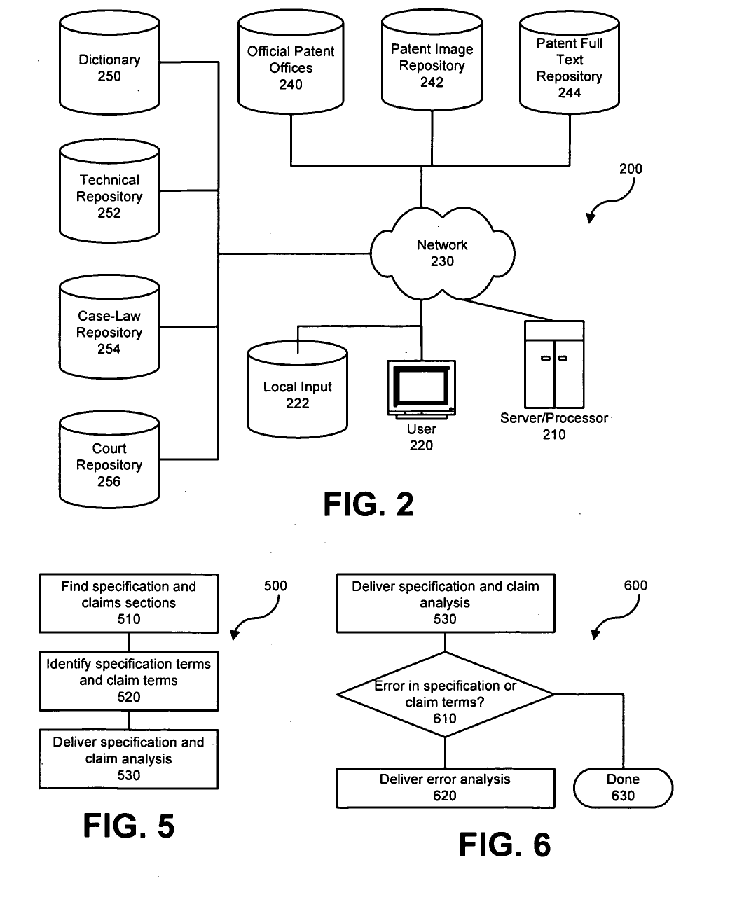

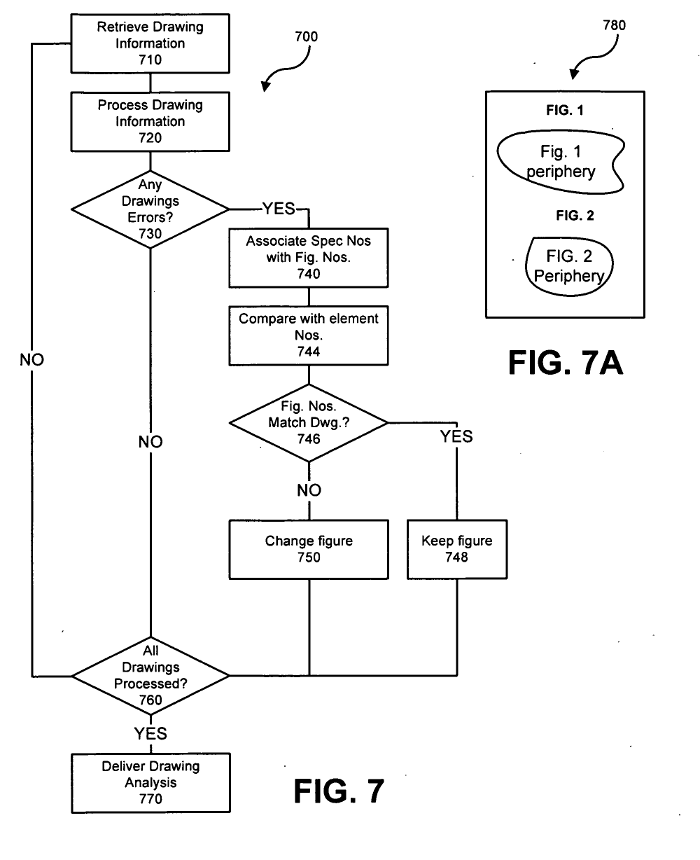

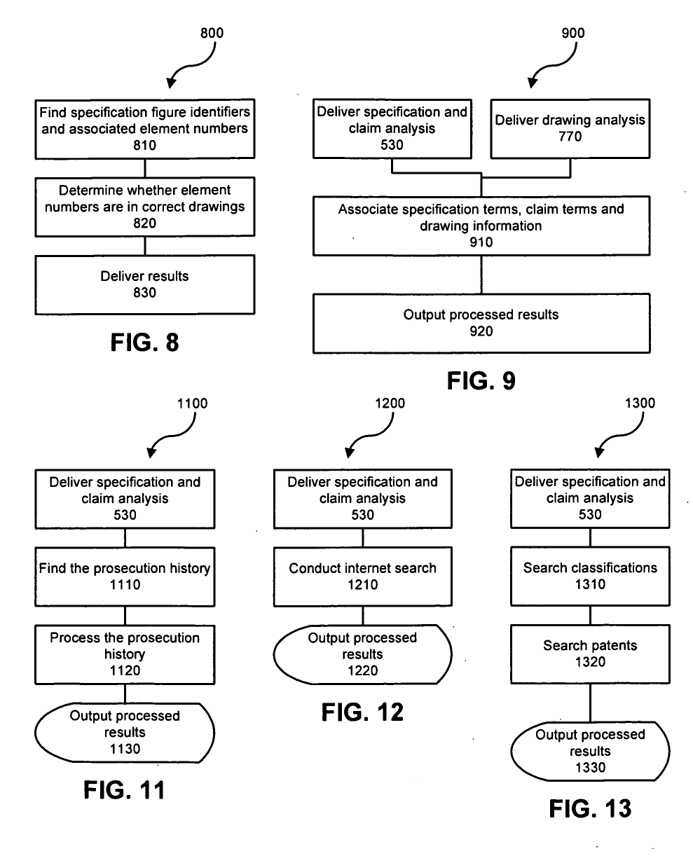

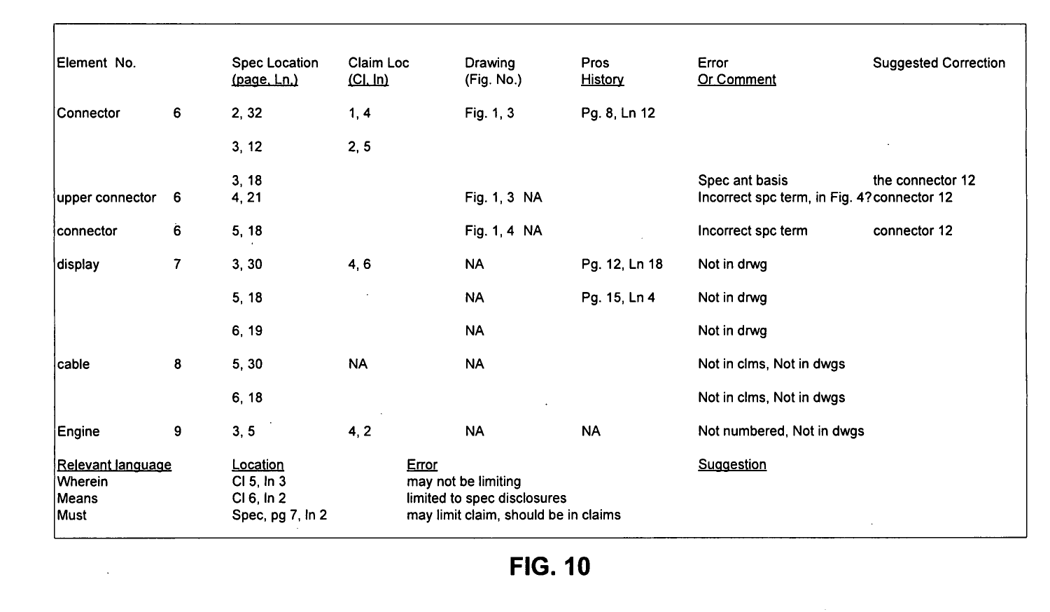

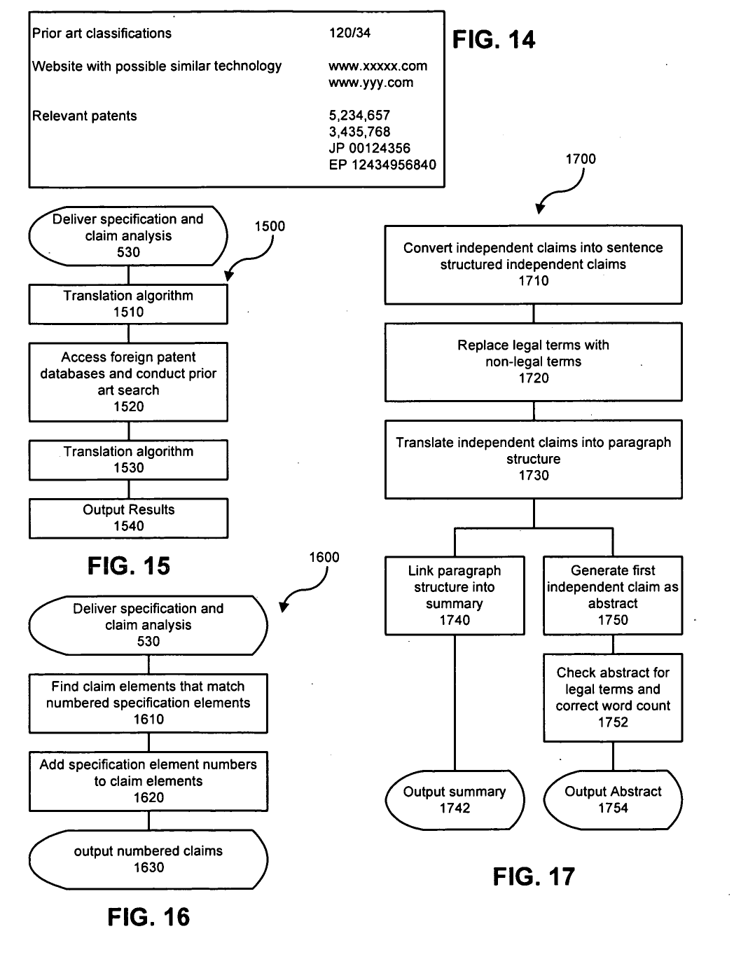

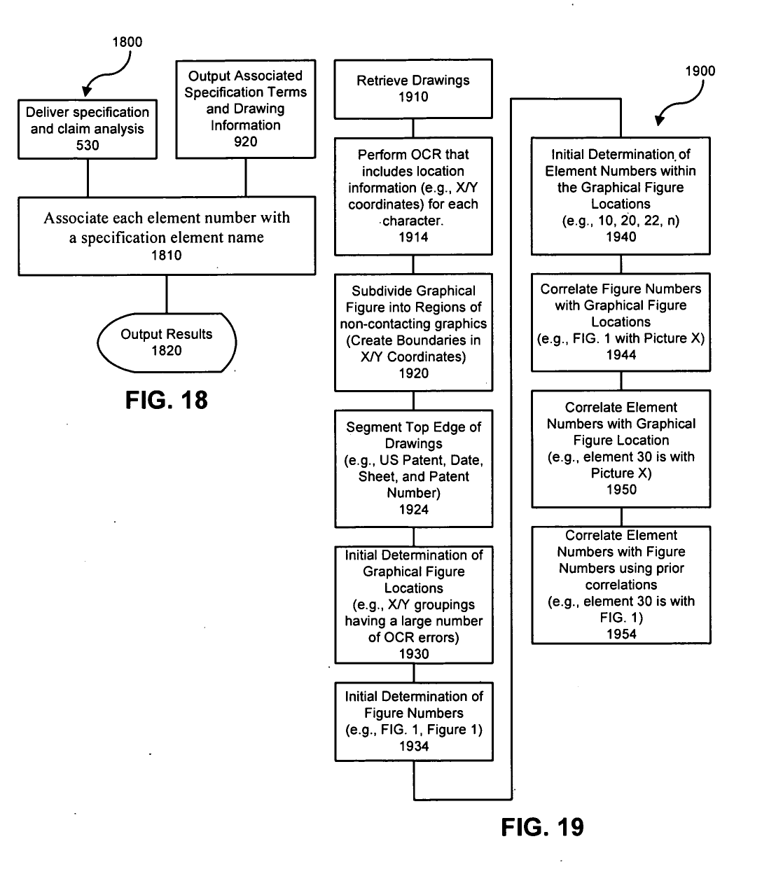

FIG. 1 is an example of a high-level processing apparatus 100 which is used to input files or information, process the information, and report findings to a user. At input information block 110, a user may select the starting documents to be analyzed. In an example, the user may input a patent application and drawings. The inputs may be in the form of Microsoft Word® documents, PDF documents, TIFF files, images (e.g., TIFF, JPEG, etc.) HTML/XML format, flat text, and/or other formats storing information.

Normalize information block 120 is used to convert the information into a standard format and store metadata about the information, files, and their contents. For example, a portion of a patent application may include “DETAILED DESCRIPTION” which may be in upper case, bold, and/or underlined. Thus, the normalized data will include the upper case, bold, and underlined information as well as that data's position in the input. For inputs that are in graphical format, such as a TIFF file or PDF file that does not contain metadata, the text and symbol information are converted first using optical character recognition (OCR) and then metadata is captured. In another example, where a PDF file (or other format) includes graphical information and metadata, e.g. a tagged PDF, the files may contain structure information. Such information may include embedded text information (e.g., the graphical representation and the text), figure information, and location for graphical elements, lists, tables etc. In an example of graphical information in a patent drawing, the element numbers, and/or figure numbers may be determined using OCR methods and metadata including position information in the graphical context of the drawing sheet and/or figure may be recorded.

Lexical analysis block 130 then takes the normalized information (e.g., characters) and converts them into a sequence of tokens. The tokens are typically words, for example, the characters “a”, “n”, “d” in sequence and adjacent to one another are tokenized into “and” and the metadata is then normalized between each of the characters into a normalized metadata for the token. In the example, character “a” comes before character “n” and “d” at which time lexical analysis block 130 normalizes the position information for the token to the position of “a” as the start location of the token and the position of “d” as the end location. Location of the “n” may be less relevant and discarded if desired. In an example of a graphical patent drawing, the normalized metadata may include the position information in two dimensions and may include the boundaries of an element number found in the OCR process. For example, the found element number “100” may include metadata that includes normalized rectangular pixel information, e.g. what are the location of the pixels occupied by element number “100” (explained below in detail).

Parsing analysis block 140 then takes the tokens provided by lexical analysis block 130 and provides meaning to tokens and/or groups of tokens. To an extent, parsing analysis block 140 may further group the tokens provided by lexical analysis block 130 and create larger tokens (e.g., chunks) that have meaning. In a preliminary search, chunks may be found using the Backus-Naur algorithm (e.g. using a system such as Yacc). A Yacc-based search may find simple structures such as dates (e.g., “Jan. 1, 2007” or “Jan. 1, 2007”), patent numbers (e.g., 9,999,999), patent application numbers (e.g., 99/999,999), or other chunks that have deterministic definitions as to structure. Parsing analysis block 140 then defines metadata for the particular chunk (e.g., “Jan. 1, 2007” includes metadata identifying the chunk as a “date”).

Further analysis includes parsing through element numbers of a specification. For example, an element may be located by identifying a series of tokens such as “an”, “engine”, “20”. Here, parsing analysis block 140 identifies an element in the specification by pattern matching the token “an” followed by a noun token “engine” followed by a number token “20”. Thus, the element is identified as “engine” which includes metadata defining the use of “a” or “an” as the first introduction as well as the element number “20”. The first introduction metadata is useful, for example, when later identifying in the information whether the element is improperly re-introduced with “a” or “an” rather than used with “the”. Such analysis is explained in detail below.

Other chunks may be determined from the information structure, such as the title, cross-reference to related applications, statements regarding federally sponsored research or development, background of the invention, summary, brief description of the drawings, detailed description, claims, abstract, a reference to a sequence listing, a table, a computer program listing, a compact disc appendix, etc. In this sense, parsing analysis block 140 generates a hierarchical view of the information that may include smaller chunks as contained within larger chunks. For example, the element chunks may be included in the detailed description chunk. In this way, the context or location and/or use for the chunks is resolved for further analysis of the entire document (e.g., a cumulative document analysis).

Document analysis 150 then reviews the entirety of the information in the context of a particular document. For example, the specification elements may be checked for consistency against the claims. In another example, the specification element numbers may be checked for consistency against the figures. Moreover, the specification element numbers may be checked against the claims. In another example, the claim terms may be checked against the specification for usage (e.g., claim terms should generally be used in the specification). In another example, the claim terms also used in the specification are checked for usage in the figures.

An example of document analysis tasks may include, for example, those included in consistent element naming, consistent element numbering, specification elements are used in the figures, claim elements cross reference to figures, identify keywords (e.g., must, necessary, etc.) in information (e.g., spec., claims), appropriate antecedent basis for claim elements, does each claim start with a capital letter and end in a period, proper claim dependency, does the abstract contain the appropriate word count, etc. Document analysis 150 is further explained in detail below.

Report generation block 160 takes the chunks, tokens, and analysis performed and constructs an organized report for the user that indicates errors, warnings, and other useful information (e.g., a parts list of element names and element numbers, an accounting of claims and claim types such as 3 independent claims and 20 total claims). The errors, warnings, and other information may be placed in a separate document or they may be added to the original document.

FIG. 1A is an alternative system 100A that may further include sources of information external to the information provided in input information block 110. Input secondary information block 170 provides external information from other sources, e.g. documents, databases, etc. that facilitates further analysis of the document, chunks, and/or tokens. The secondary information may use identified tokens or chunks and further input external information. For example, a standard dictionary may be used to check whether or not the claim words are present and defined in the dictionary. If so, the dictionary definition may be reported to the user in a separate report of claim terms. In another example, where a token or chunk is identified as a patent that may be included by reference, a patent repository may be queried for particular information used to check the inventor name (if used), the filing date, etc.

Secondary document analysis block 180 takes tokens/chunks from the information and processes it in light of the secondary information obtained in input secondary information block 170. For example, where a claim term is not included in a dictionary, a warning may be generated that indicates that the claim term is not a “common” word. Moreover, if the claim term is not used in the specification, a warning may be generated that indicates that the word may require further use or definition. An example may be a claim that includes “a hose sealingly connected to a fitting”. The claim term “sealingly” may not be present in either the specification or the dictionary. In this case, although the word “seal” is maintained in the dictionary and may be used in the specification, the warning may allow the user to add a sentence or paragraph explaining the broad meaning of “sealingly” if so desired rather than relying on an unknown person's interpretation of “sealingly” in light of “to seal”.

In another example, a patent included by reference is checked against the secondary information for consistency. For example, the information may include an incorrect filing date or inventor which is found by comparing the chunk with the secondary information from the patent repository (e.g., inventor name, filing date, assignee, etc.). Other examples may include verifying information such as chemical formulas and/or sequences (e.g., whether they are reference properly and used consistently).

Examples of secondary information used for litigation analysis may include court records (e.g., PACER records), file histories (obtained, e.g., from the USPTO database), or case law (e.g., obtained from LEXIS®, WESTLAW®, BNA®, etc.). Using case law, for example, claim terms may be identified as litigated by a particular judge or court, such as the Federal Circuit. These cases may then be reviewed by the user for possible adverse meanings as interpreted by the courts.

Report generation block 160 then includes further errors, warnings, or other useful information including warnings or errors utilizing the secondary information.

Referring now to FIG. 2, an example of a system for information analysis 200 includes a server/processor 210 and a user 220. A network 230 generally provides a medium for information interchange between any number of components, including server/processor 210 and user 220. As discussed herein, network 230 may include a single network or any number of networks providing connectivity to certain components (e.g. a wired, wireless, optical network that may include in part the Internet). Alternatively, network 230 is not a necessary component and may be omitted where more than one component is part of a single computing unit. In an example, network 230 may not be required where the system and methods described herein are part of a stand-alone system.

Local inputs 222 may be used by user 220 to provide inputs, e.g. files such as Microsoft Word® documents, PDF documents, TIFF files etc. to the system. Processor 210 then takes the files input by user 220, analyzes/processes them, and sends a report back to user 220. The user may use a secure communication path to server/processor 210 such as “HTTPS” (a common network encryption/authentication system) or other encrypted communication protocols to avoid the possibility of privileged documents being intercepted. In general, upload to processor 210 may include a web-based interface that allows the user to select local files, input patent numbers or published application numbers, a docket number (e.g., for bill tracking), and other information. Delivery of analyzed files may be performed by processor 210 by sending the user an e-mail or the user may log-in using a web interface that allows the user to download the files.

In the example of a patent document, each document sent by user 220 is kept in secrecy and is not viewed, or viewable, by a human. All files are analyzed by machine and files sent from user 220 and any temporary files are on-the-fly encrypted when received and stored only temporarily during the analyzing process. Then analysis is complete and reports are sent to user 220 and any temporary files are permanently erased. Such encryption algorithms are readily available. An example of encryption systems is TrueCrypt available at “http://www.truecrypt.org/”. Any intermediate results or temporary files are also encrypted on-the-fly so that there is no possibility of human readable materials being readable, even temporarily. Such safeguards are used, for example, to avoid the possibility of disclosure. In an example of preserving foreign patent rights, a patent application should be kept confidential or under the provisions of a confidentiality agreement to prevent disclosure before filing.

Other information repositories may also be used by processor 210 such as when the user requests analysis of a published application or patent. In such cases, server processor 210 may receive an identifier, such as a patent number or published application number, and queries other information repositories to get the information. For example, an official patent source 240 (e.g., the United States Patent and Trademark Office, foreign patent offices such as the European Patent Office or Japanese Patent Office, WIPO, Esp@cenet, or other public or private patent offices or repositories) may be queried for relevant information. Other private sources may also be used that may include a patent image repository 242 and/or a patent full-text repository 244. In general, patent repositories 240, 242, 244 may be any storage facility or device for storing or maintaining text, drawing, patent family information (e.g. continuity data), or other information.

If the user requests secondary information being brought to bear on the analysis, other repositories may also be queried to provide data. Examples of secondary repositories may include a dictionary 250, a technical repository 252, a case-law repository 254, and a court repository 256. Other information repositories may be simply added and queried depending upon the type of information analyzed or if other sources of information become available. In the example where dictionary 250 is utilized, claim language may be compared against words contained in dictionary 250 to determine whether the words exist and/or whether they are common words. Technical repository 252 may be used to determine if certain words are terms of art, if for example the words are not found in a dictionary. To determine if claim terms have been litigated, construed by a District Court (or a particular District Court Judge), and whether the Federal Circuit or other appellate court has weighed in on claim construction, case-law repository 254 may be queried. In other cases, for example when the user requests a litigation report, court repository 256 may be queried to determine if the patent identified by the user is currently in litigation.

Referring now to FIGS. 2 and 3, a flow diagram 300 is shown of the overview for information analysis, shown here as an example of a patent application document.

The process begins at step 310 where a patent or patent application is retrieved from a source location and loaded onto server/processor 310. The patent or patent application may be retrieved from official patent offices 240, patent image repository 242, patent full text repository 244, and/or uploaded by user 220. Regarding any document other than a patent or patent application, any known source or device may be employed for storage and retrieval of such document. It will be understood by those skilled in the art that the patent or patent application may be obtained from any storage area whether stored locally or external to server/processor 210.

In step 320, the patent or patent application is processed by a server/processor 210 to extract information or identify errors. In one example, the drawings are reviewed for errors or associated with specification and claim information (described in detail below). In another example, the specification is reviewed for consistency of terms, proper language usage or other features as may be required by appropriate patent laws. In yet a further example, the claims are reviewed for antecedent basis or other errors. It will be readily understood by one skilled in the art that the patent or patent application may be reviewed for any known or foreseeable errors or any information may be extracted therefrom.

In step 330, an analysis of the processed application is output or delivered by server/processor 210 to user 220. The output may take any known form, including a report printed by or displayed on the terminal of user 220 or may be locally stored or otherwise employed by server/processor 210. In one example, user 220 includes a terminal that provides an interactive display showing the marked-up patent or patent application that allows the user to interactively review extracted information in an easily readable format, correct errors, or request additional information. In another example, the interactive display provides drop-down boxes with suggested corrections to the identified errors. In yet a further example, server/processor 210 prints a hard copy of the results of the analysis. It will be readily understood that any other known means of displaying or providing an output of the processed patents or patent application may be employed.

Other marked-up forms of documents may also be created by processor 210 and sent to user 220 as an output. For example, a Microsoft Word® document may use a red-line or comment feature to provide warnings and errors within the source document provided by user 220. In this way, modification and tracking of each warning or error is shown for simple modifications or when appropriate user 220 may ignore the warnings. User 220 may then “delete” a comment after, for example, an element name or number is modified. Additionally, marked-up PDF documents may be sent to user 220 that display in the text or in the drawings where error and/or warnings are present. An example may be where element numbers are used in a figure but not referenced in the specification of a patent application, the number in the drawing may have a red circle superimposed or highlighted over the drawing that identifies it to the user. In another example, where a PDF text file was provided by the user, errors and warnings may be provided as highlighted regions of the document.

Referring to FIG. 4, another example of a process 400 according to an example is shown and described. A patent or patent application reference identifier, such as an application number, docket number, publication number or patent number, is input by user 220 in step 410. The reference identifier may also be a computer indicator or other non-human entered identifier such as a cookie stored on the user's computer. In step 420, server/processor 210 retrieves the patent or patent application from patent repositories 240, 242, 244 or another repository through referencing the appropriate document in the repository with the reference identifier. The repository responds by retrieving and dispatching the appropriate patent or patent application information to server/processor 210 which may include full-text information, front-page information, and/or graphical information (e.g., figures and drawings). Server/processor 210 then processes the patent or patent application in step 430 for errors or to extract information. In step 440, results of the processed patent or patent application are output to user 220.

It will be understood that the above referenced processes may take place through a network, such as network 230, the Internet or other medium, or may be performed entirely locally by the user's local computer.

Referring now to FIG. 5, an example of a process 500 for extracting information or identifying errors related to the specification and claim sections in a patent or patent application is shown and described. In FIG. 5, the specification and claim sections in a patent or patent application are identified in step 510. In one example, server/processor 210 identifies the top portion of the specification by conducting a search for the word “specification” in a specific text, font or format that is commonly used or required as the title of the specification section in the patent or patent application. For example, a search may be conducted for the word “specification” in all caps, bold text, underlined text, centered or other font or text specific format. In another example, the word “specification” is identified by looking for the word “specification” in a single paragraph having no more than three words, one of which is the word “specification” having a first capital letter or being in all caps. As will be understood by one skilled in the art, such formats are commonly associated with traditional patent drafting methods or storage formats of patents. However, the present examples are not intended to be limited by the specific examples herein and any format commonly associated with such terms may be searched.

When multiple methods are used to determine a section in the document, a confidence of the correctness of assigning the section may also be employed. For example, where “specification” is in all caps and centered, there is a higher confidence than when “specification” is found within in a paragraph or at the end of the document vs. a general location more towards the beginning of the document. In this way, multiple possible beginnings of a section may be found, but the one with the highest confidence will be used to determine the section start. Such a confidence test may be used for all sections within the document, given their own unique wording, structure, and location within the document. Of course, for a patent application as filed, the specification and claims section are different than the full-text information taken from the United States Patent Office, as an example. Thus, for each section there may be different locations and structures depending upon the source of the document, each of which is detectable and easily added to the applicable heuristic.

In the claim section, server/processor 210 may, for example, identify the beginning of the claims section of the patent or patent application in a similar fashion as for the specification by searching for the word “claims” with text or format specific identifiers. The end of the “claims” section thereafter may be identified by similar means as described above, such as by looking for the term “abstract” at the end of the claims or the term “abstract” that follows the last claim number.

In an example, the area between the start of the specification and the start of the claims is deemed as the specification for example in a patent application or a published patent, while the area from the start of the claims to the end of the claims is deemed as the claims section. When the document is a full-text published patent (e.g., from the USPTO), then the claims may be immediately following the front-page information and ending just before the “field of the invention” text or “description” delimiter. Moreover, such formats may change over time as when the USPTO may update the format in which patents are displayed, and thus the heuristics for determining document sections would then also be updated accordingly.

One skilled in the art will readily recognize that other indicators may be used for identifying the specification and claims sections, such as looking for claim numbers in the claim sections, and to check that the present application is not limited by that disclosed herein.

In step 520, specification terms and claim terms are identified in the specification and claims. As one skilled in the patent arts will understand, specification terms (also referred to as specification elements) and claim terms (also referred to as claim elements) represent elements in the specification and claims respectively used to denote structural components, functional components, and process components or attributes of an invention. In one example, a sentence in a patent specification stating “the connector 12 is attached to the engine crank case 14 of the engine 16” includes specification terms: “connector 12”, “engine crank case 14”, and “engine 16.” In another example, a sentence in the claims “the connector connected to an engine crank case of an engine” includes claim terms: “connector”, “engine crank case”, and “engine.” One skilled in the art will readily recognize the numerous variations of the above described examples.

In one example, server/processor 210 looks for specification terms by searching for words in the specification located between markers. In an example, an element number and the most previous preceding determiner is used to identify the beginning and end of the specification term. In one example, the end marker is an element number and the beginning marker is a determiner. As will be understood, a determiner as used herein is the grammatical term represented by words such as: a, an, the, said, in, on, out . . . . One skilled in the art will readily know and understand the full listing of available determiners and all determiners are contemplated in the present examples. For example, in the sentence “the connector 12 is attached to the engine crank case 14 of the engine 16”, the element numbers are 12, 14 and 16. The determiners before each element number are respectively “the . . . 12”, “the . . . 14”, and “the . . . 16.” The specification terms are “respectively “connector”, “engine crank case”, and “engine.” In the preceding sentence, the words “is” and “to” are also determiners. However, because they are not the most recent determiners preceding an element number, in the present example, they are not used to define the start of a specification term.

Server/processor 210, in an example, identifies specification terms and records each location of each specification term in the patent or application (for example by page and line number, paragraph number, column and line number, etc.), each specification term itself, each preceding determiner, and each element number (12, 14 or 16 in the above example) in a database.

In another example, the specification terms are identified by using a noun identification algorithm, such as, for example, that entitled Statistical Parsing of English Sentences by Richard Northedge located at “http://www.codeproject.com/csharp/englishparsing.asp”, the entirety of which is hereby incorporated by reference. In the presently described example, server/processor 210 employs the algorithm to identify strings of adjacent nouns, noun phrases, adverbs and adjectives that define each element. Thereby, the markers of the specification term are the start and end of the noun phrase. Identification of nouns, noun phrases, adverbs and adjectives may also come from repositories (e.g., a database) that contain information relating to terms of art for the particular type of document being analyzed. For example, where a patent application is being analyzed, certain patent terms of art may be used (e.g., sealingly, thereto, thereupon, therefrom, etc.) for identification. The repository of terms-of-art may be developed by inputting manually the words or by statistical analysis of a number of documents (e.g., statistical analysis of patent documents) to populate the repository with terms-of-art. Moreover, depending upon a classification or sub-classification for a particular document, the terms of art may be derived from analyzing the other patent documents within a class or sub-class (see also the USPTO “Handbook of Classification” found at “http://www.uspto.gov/web/offices/opc/documents/handbook.pdf”, the entirety of which is hereby incorporated by reference).

Alternatively, server/processor 210 may use the element number as the end marker after the specification term and may use the start of the noun phrase as the marker before the specification term. For example, the string “the upper red connector” would include the noun “connector” adjectives “red” and “upper.” Server/processor, in an example, records the words before the marker, the location of the specification term, the term itself, and any element number after the specification term (if one exists).

In an example for identifying the claim terms, server/processor 210 first determines claim dependency. Claim dependency is defined according to its understanding in the patent arts. In one example, the claim dependency is determined by server/processor 210 by first finding the claim numbers in the claims. Paragraphs in the claim section starting with a number are identified as the start of a claim. Each claim continues until the start of the next claim is identified.

The claim from which a claim depends is then identified by finding the words “claim” followed by a number in the first sentence after the claim number. The number following the word “claim” is the claim from which the current claim depends. If there is no word “claim”, then the claim is deemed an independent claim. For example, in the claim “2. The engine according to claim 1, comprising . . . ”, the first number of the paragraph is “2”, and the number after the word “claim” is “1”. Therefore, the claim number is 2 and the dependency of the claim terms in claim 2 depend from claim 1. Likewise, the dependency of the claim terms within claim 2 is in accordance with their order. For example, where the term “engine” is found twice in claim 2, server/processor 210 assigns the second occurrence of the term to depend from the first occurrence.

The claim terms are identified by employing a grammar algorithm such as that described above to identify the markers of a noun clause. For example, in the claim “a connector attached to an engine crank case in an engine”, the claim terms would constitute: connector, engine crank case, and engine. In another example, the claim terms are identified by looking to the determiners surrounding each claim term as markers. In an example, the claim term, its location in the claims (such as by claim number and a line number), and its dependency are recorded by server/processor 210. Thus, the algorithm will record each claim term such as “connector”, whether it is the first or a depending occurrence of the term, the preceding word (for example “a”) and in what claim and at what line number each is located.

In step 530, information processed related to the specification terms and claim terms is delivered in any format to user 220. The processed output may be delivered in a separate document (e.g., a Word® document, a spreadsheet, a text file, a PDF file, etc.) and it may be added or overlaid with the original document (e.g., in the form of a marked-up version, a commented version (e.g., using Word® commenting feature, or overlaid text in a PDF file). The delivery methods may be, for example, via e-mail, a web-page allowing user 220 to download the files or reports, a secure FTP site, etc.

Referring now to FIG. 6, an example of a process 600 for identifying errors in the specification and claims is described. In step 610, server/processor 210 processes and analyzes the specification terms and claim terms output by step 530 (see FIG. 5). Server/processor 210 compares the specification terms to see whether any of the same specification terms, for example “connector”, includes different element numbers. If so, then one version may be correct while the other version is incorrect. Therefore, server/processor 210 determines which version of the specification term occurs more frequently in the specification to determine which of the ambiguously-used specification terms is correct.

In step 620, server/processor 210 outputs an error/warning for the term and associated element number having the least number of occurrences, such as “incorrect element number.” For example, if the specification term “connector 12” is found in the specification three times and the term “connector 14” is found once, then for the term “connector 14”, an error will be output for the term “connector 14.” The error may also include helpful information to correct the error such as “connector 14 may mislabeled connector 12 that is first defined at page 9, line 9 of paragraph 9”.

In another example, server processor 210 looks to see whether the same element number is associated with different specification terms in step 610. If so, then one version may be correct while the other version is incorrect. Therefore, server/processor 210 determines which version of the specification term occurs more frequently in the specification. Then, in step 620, server/processor 210 outputs an error for the term and associated element number having the least number of occurrences, such as “incorrect specification element.” For example, if the term “connector 12” is found in the specification three times and the term “carriage 12” is found once, then an appropriate error statement is output for the term “carriage 12.”

In another example, server/processor 210 looks to see whether proper antecedent basis is found for the specification terms in step 610. As stated previously, server/processor 210 records the determiners or words preceding the specification elements. In step 610, server/processor 210 reviews those words in order of their occurrence and determines whether proper antecedent basis exists based on the term's location in the specification. For example, the first occurrence of the term “connector 12” is reviewed to see if it includes the term “a” or “an.” If not, then an error statement is output for the term at that particular location. Likewise, subsequent occurrences of a specification term in the specification may be reviewed to ensure that the specification terms include the words “said” or “the.” If not, then an appropriate error response is output in step 620.

In another example, server/processor 210 reviews the claim terms for correct antecedent basis similar to that discussed above in step 610. As stated previously, server/processor 210 records the word before each claim term. Accordingly, in step 610, the claim terms are reviewed to see that the first occurrence of the claim term in accordance with claim dependency (discussed previously herein) uses the appropriate words such as “a” or “an” and the subsequent occurrences in order of dependency include the appropriate terms such as “the” or “said.” If not, then an appropriate error response is output in step 620.

In another example, server/processor 210 in step 610 reviews the specification terms against the claim terms to ensure that all claim terms are supported in the specification. More specifically, in step 610, server/processor 210 records each specification term that has an element number. Server/processor 210 then determines whether any of the claim terms are not found among the set of recorded specification terms. If claim terms are found that are not in the specification, then server/processor 210 outputs an error message for that claim term accordingly. This error may then be used by the user to determine whether that term should be used in the specification or at least defined.

In another example, server/processor 210 identifies specification terms that should be numbered. In step 610, server/processor 210 identifies specification terms without element numbers that match any of the claim terms. In step 620, server/processor 220 outputs an error message for each unnumbered term accordingly. For example, server/processor 210 may iterate through the specification and match claim terms with the sequence of tokens. If a match is found with the series of tokens and no element number is used thereafter, server/processor 210 determines that an element is used without a reference numeral or other identifier (e.g., a symbol).

In another example, specification terms or claim terms having specific or important meaning are identified. Here, server/processor 210 in step 610 reviews the specification and claims to determine whether words of specific meaning are used in the specification or claims. If so, then in step 620 an error message is output. For example, if the words “must”, “required”, “always”, “critical”, “essential” or other similar words are used in the specification or claims, then a statement is output such as “limiting words are being used in the specification.” Likewise, if the terms “whereby” “means” or other types of words are used in the claims, then a statement describing the implications of such usage is output. Such implications and other such words will be readily understandable to one of skill in the art.

In another example, server/processor 210 looks for differing terms from specification and claim terms that, although different, are correct variations of such specification or claim terms. As stated previously, server/processor 210 records each specification term and claim term. Server/processor 210 compares each of the specification terms. Server/processor 210 also compares each of the claim terms. If server/processor 210 identifies variant forms of the same terms in step 610, then in step 620, server/processor 210 outputs a statement indicating that the variant term may be the same as the main term. In one example, server/processor 210 compares each word of each term, starting from the end marker and working toward the beginning marker, to see if there is a match in such words or element numbers. If there is a match and the number of words between markers for the subsequently occurring term is shorter than its first occurrence, then a statement for the subsequently occurring term is output. For example, where the first occurrence in the specification of the term is “electrical connector 12” and a second occurrence in the specification of a term is “connector 12”, this second occurrence of the specification term “connector” is determined by server/processor 210 as one of the occurrences of the specification term “electrical connector 12.” Accordingly, for the term “connector 12”, server/processor 210 outputs “this is the same term as upper connector 12.” Other similar variations of terms that are consistent with Patent Office practice and procedure are also reviewed.

Where a specification or claim term includes two different modifiers and a subsequent term is truncated, then server/processor 210 outputs “clear to which prior term this term refers” in step 610. For example, where the terms “upper connector” and “lower connector” are used and a subsequent term “connector” is also used, then the process outputs an appropriate error response in step 620 for the term “connector.”

In the instance where a term is not identified as a subset term, then in an example, it is output as a new term. For example, if the first occurrence of a specification term is “upper connector 12” and “lower connector 12”, then the term “upper connector 12” will be output. “Lower connector 12” will also be output as a different element at different locations in the specification.

It will be understood that the application is not limited to the specific responses as referenced above, and that any suitable output is contemplated in accordance with the invention including automatically making the appropriate correction. If no errors are found, then the process ends at step 630.

Referring now to FIG. 7, an example for processing drawing information 700 is shown and described. As will be understood by one skilled in the patent arts, patents include associated sheets of drawings, wherein each sheet may have one or more figures thereon. The figures themselves are the actual physical drawing of the device or process or other feature for each figure number. The figure numbers are numbers that identify the figure (for example figure “1”), while element numbers typically point to specific elements (“24”) on the figure. In step 710, drawing information may be uploaded by a user 220 or retrieved from a repository by server/processor 210 as discussed previously. Server/processor 210 may, in an example, identify the information as drawing information by either reading user input identifying the drawing as such, by recognizing the file type as a PDF or other drawing file, or other known means.

In step 720, server/processor 210 processes the drawing information to extract figure numbers and element numbers. In an example, an optical character recognition OCR algorithm is employed by server/processor 210 to read the written information on the drawings. The OCR algorithm searches for numbers, in an example, no greater than three digits, which have no digits separated by punctuation such as commas, and of a certain size to ensure the numbers are element numbers or figure numbers and not other numbers on drawing sheets such as patent or patent application numbers (which contain commas) or parts of the figures themselves. One skilled in the art will readily recognize that other features may be used to distinguish element numbers from background noise or other information, such as patent numbers, titles, the actual figures or other information. This example is not limited by the examples set forth herein.

When searching for the figure numbers, server/processor 210 may use an OCR algorithm to look for the words “Fig. 1”, “FIG. 1”, “Figure 1” or other suitable word representing the term “figure” in the drawings (hereinafter “figure identifier”). The OCR algorithm records the associated figure number, such as 1, 2 etc. For example, “figure 1” has a figure identifier “figure 1” and a figure number “1.” In addition to identifying the figure identifier, server/processor 210 obtains the X-Y location of the figure identifier and element numbers. It is understood that such an OCR heuristic may be tuned for different search purposes. For example, the figure number may include the word “FIGURE” in an odd font or font size, which may also be underlined and bold, otherwise unacceptable for element numbers or used in the specification.

In an example, server/processor 210 in step 720 first determines the number of occurrences of the figure identifier on a sheet. If the number of occurrences is more than one on a particular sheet, then the sheet is deemed to contain more than one figure. In this case, server/processor 210 identifies each figure and the element numbers and figure number associated therewith. To accomplish this, in one example, a location of the outermost perimeter is identified for each figure. The outer perimeter is identified by starting from the outermost border of the sheet and working in to find a continuous outermost set of connected points or lines which form the outer most boundary of a figure.

In another example, a distribution of lines and points that are not element numbers or figure identifiers is obtained. This information (background pixels not related to element numbers or figure identifiers) is plotted according to the X/Y locations of such information on the sheet to thereby allow server/processor 210 to determine general locations of background noise (e.g., pixels which are considered “background noise” to the OCR method) and therefore, form the basic regions of the figures. Server/processor 210 then identifies lines extending from each element number by looking for lines or arrows having ends located close to the element numbers. Server/processor 210 then determines to which figure the lines or arrows extend.

Additionally, server/processor 210 determines a magnitude of each element's distance from the closest figure relative to the next closest figure. If the order of magnitude provides a degree of accuracy that the element number is associated with a figure (for example, if element “24” is five times closer to a particular figure than the next closest figure), then that element number will be deemed to be associated with the closest figure. Thereby, each of the element numbers is associated with the figure to which it points or is closest to, or both. In other examples, server/processor 210 may find a line extending from an element number and follows the line to a particular figure boundary (as explained above) to assign the element number as being shown in the particular figure.

The figure identifiers are then associated with the figures by determining where each figure identifier is located relative to the actual figures (e.g., the proximity of a figure identifier relative to the periphery of a figure). One example is to rank each figure number with the distance to each figure periphery. For example, figure identifier “Figure 1” may be 5 pixels from the periphery of a first undetermined figure and 200 pixels from a second undetermined figure. In this case, the heuristic orders the distances for “Figure 1” with the first undetermined figure and then the second undetermined figure. When each of the figure identifiers is ordered with the undetermined figure, the heuristic may identify each figure identifier with the closest undetermined figure. Moreover, where there is sufficient ambiguity between undetermined figures and figure identifiers (e.g., the distances of more than one figure identifier are below a predetermined threshold of 20 pixels), then a warning may be reported to the user that the figure identifiers are ambiguous.

In another example, where more than one figure number is assigned to the same figure and other figures have not been assigned a figure number, the system will modify the search heuristic to further identify the correct figure numbers and figures. An example is shown in FIG. 7A, where two figures are close together vertically on a sheet 780. A first figure identifier is at the top of a first figure and a second figure number is between them. The heuristic may determine that the top figure has a figure number on the top and the bottom figure should be assigned the figure number between them. In this case, the second figure number may be an equal distance from the first and second figure, but it is clear that the second figure number (between the first and second figures) should be assigned to the second figure.

When the initial drawing processing is complete, e.g. from step 720, the drawing processing is checked for errors and/or ambiguities in step 730. For example, it may be determined whether there are figure peripheries that do not have figure identifiers associated with them. In another example, it may be determined whether there are any ambiguous figure identifiers (e.g., figure identifier below a proximity threshold more than one figure periphery). In another example, if the magnitude/distance of a figure identifier to a figure periphery is not within a margin of error (for example if “figure 1” is less than five times closer to its closest figure than the next closest figure), the process continues where additional processing occurs to disambiguate the figure identifiers and figures (as discussed below in detail with respect to steps 740-750).

If no errors occur in figure processing, control proceeds to step 760. Otherwise, if drawing errors have been detected, the process continues with step 740. At step 760, the process checks whether each drawing sheet has been processed. If all drawings have been processed, control proceeds to step 770. Otherwise, the process repeats at step 710 until each drawing sheet has been processed.

In step 770, when the drawing analysis is delivered, the heuristic transitively associates each figure number of its figure identifier with the element numbers through its common figure (e.g., Figure 1 includes elements 10, 12, 14 . . . ).

With reference to step 740, additional processing is employed to create a greater confidence in the assignment of a figure number by determining whether some logical scheme can be identified to assist with correctly associating figures with figure identifiers. For example, in step 740, server/processor 210 determines whether the figures are oriented vertically from top to bottom on the page and whether the figure identifier is consistently located below the figures. If so, then server/processor 210 associates each figure identifier and number with the figure located directly above. Similarly, server/processor 210 may look for any other patterns of consistency between the location of the figure identifier and the location of the actual figure. For example, if the figure identifier is consistently located to the left of all figures, then server/processor 210 associates each figure with the figure identifier to its left.

In another example, in step 740, server/processor 210 identifies paragraphs in the specification that began with the sentence having the term “figure 1”, “fig. 2” or other term indicating reference to a figure in the sentence (hereinafter “specification figure identifier”). Server/processor 210 then looks for the next specification figure identifier. If the next specification figure identifier does not occur until the next paragraph, server/processor 210 then identifies the element numbers in its paragraph and associates those element numbers with that specification figure identifier. If the next specification figure identifier does not occur until a later paragraph, server/processor 210 identifies each element number in every paragraph before the next specification figure identifier. If the next specification figure identifier occurs in the same paragraph, server/processor 210 uses the element numbers from its paragraph. This process is repeated for each specification figure identifier occurring in the first sentence of a paragraph. As a result, groups of specification figure identifiers are grouped with sets of specification numbers.

In step 744, the figure numbers associated with the element numbers in the actual figures (see step 720) are then compared with the sets of specification figure identifiers and their associated element numbers. In step 746, if the specification figure identifier and its associated element numbers substantially match the figure identifier and its associated element numbers in the drawings (for example, more than 80% match), then step 748 outputs the figure identifier and its associated elements as determined in step 720. If not and if the specification figure identifier and its associated element numbers substantially match the next closest figure identifier and its associated element numbers in the drawings, then step 750 changes the figure number obtained in step 720 to this next closest figure number.

For example, the first sentence in a paragraph contains “figure 1” and that paragraph contains element numbers 12, 14 and 16. The specification figure identifier is figure 1, the figure number is “1” and the element numbers are 12, 14 and 16. A figure number on a sheet of drawings is determined to be “figure 2” in step 720 and associated with element numbers 12, 14 and 16. Likewise, figure 1 on the sheet of drawings is determined to contain elements 8, 10 and 12 in step 720. Furthermore, steps 720 and 730 determined that figure 1 and figure 2 are located on the same sheet and that there is an unacceptable margin of error as to which figure is associated with which figure number, and therefore, which element numbers are associated with which figure number. Here, server/processor 210 in step 746 determines that “figure 2” should be actually be “figure 1” as “figure 1” has the elements 12, 14 and 16. Therefore, in step 750, the figure number “2” is changed to the figure number “1” in the analysis of steps 720 and output in accordance therewith in the same manner as that for step 748. As will be described hereinafter, the output information related to the figure numbers and specification numbers can be used to extract information related to which figures are associated with what elements and to identify errors.

Alternatively, where two ambiguous figures include the same element number, but one of the two ambiguous figures also includes an element not present in the other, processor/server 210 may match figure numbers based on the specification figure identifiers and their respective element numbers. For example, a first ambiguous figure includes element numbers 10, 12, and 14. A second ambiguous figure includes element numbers 10, 12, 14, and 20. Server/processor 210 then compares specification figure identifiers and their respective element numbers with the element numbers of first ambiguous figure and second ambiguous figure. In this way, server/processor 210 can match second ambiguous figure with the appropriate specification figure identifier.

Referring now to FIG. 8, another example for a process flow 800 is shown for identifying specification and drawing errors is described. In step 810, server/processor 210 identifies the specification figure identifier in the first sentence of any paragraph and associates elements as previously discussed herein. In step 820, server/processor 210 then reviews each figure number and element number in the drawings to determine whether element numbers in the specification are found in the correct drawings. If not, then an appropriate error is output in step 830. For example, where a paragraph in the specification begins with a specification figure identifier “figure 1” and its paragraph contains elements 12, 14 and 16, figure 1 in the drawings is reviewed to determine whether each of those element numbers are found in figure 1 in the drawings. If not, then an error is output stating such.

In FIG. 9, a process flow 900 shows an example of how server/processor 210 processes outputs from FIGS. 5 and 6 to associate the specification terms, claim terms and drawing element numbers in step 910. For example, information from steps 530 and 670 relating to specification terms, element numbers, claim terms and drawing element numbers, figures and locations are matched up. In step 920, server/processor 210 outputs results to the user 220 as shown in FIG. 10 or for further processing.

In one example, all of the information generated by the process of FIG. 9 is output as shown in FIG. 10. For example, the element “connector” is shown having the term “connector” with an element number 12. The location in the specification of this specification term is at page 2, line 32. Its location in the claims is at claim 1, line 4. This information was generated through the process discussed in connection with FIG. 7. The element number 12 is located in Figures 1 and 3 as was obtained in connection with the process of figure B3.

Additionally, server/processor 210 outputs errors under the column entitled “error or comment” in FIG. 10. By way of example, for the term “connector” located at page 3, line 18, the listing in FIG. 10 instructs the user 220 that the specification term lacks antecedent basis. Similarly, for the term “upper connector”, an error is output stating that the term may be an incorrect specification term. Likewise, for the term “cable”, an error is output stating that the term is not found in the claims and that there is no corresponding element number “16” in the drawings. Upper connector 12 is determined that it should be in figure 4, but is not as determined by the process of FIG. 8. The processing described in figures B14 and B12, in one example, was used to identify such errors.

Referring now to FIG. 11, another example shown by process 1100 is shown and described. The process starts at step 530 where the specification terms and claim terms are output. In step 1110, server/processor 210 obtains a prosecution history from the user 220, patent repositories 240, 242, 244, or other sources. In step 1120, server/processor 210 then conducts a search through the prosecution history for specification terms and claim terms. In one example, server/processor 210 conducts this search based on specification terms and claim terms requested by the user 220. For example, the user 220 is prompted by the output as shown in FIG. 10 to select certain terms in the left-hand most column of which a user is interested. In response, server/processor 210 conducts a search through the prosecution history, finds the terms in the prosecution history, and extracts language related to the term.

In one example, server/processor 210 records the location of the term in the prosecution history and lists its location in FIG. 10 under the title “pros history” as shown therein. In another example, server/processor 210 retrieves language around each occurrence of the identified term from the prosecution history three sentences before the occurrence of the term and three sentences after the occurrence of the term. As a result, user 220 retrieves the specific language relating to that term and the processed results are output at step 1130.

Other examples including prosecution history analysis may include the presenting the user with a report detailing the changes to the claims, and when they occurred. For example, a chart may be created showing the claims as-filed, each amendment, and the final or current version of the claims. The arguments from each response or paper filed by the applicant may also be included in the report allowing the user to quickly identify potential prosecution history estoppel issues.

Another example, may include the Examiner's comments (e.g., rejections or objections), the art cited against each claim, the claim amendments, and the Applicant's arguments. In another example, the Applicant's amendments to the specification may be detailed to show the possibility of new matter additions.

In another example, as shown by process 1200 in FIG. 12, server/processor 210 in step 1210 conducts a search (e.g., a search of the Internet by way of a search engine) in an attempt to identify web pages that employ or use the terms output from step 530. Such a search, for example, may identify web pages that use the specification terms and claim terms. Server/processor 210 may employ a statistical processing scheme to determine search terms based on words (and their relation to each other) as used in a patent document. In step 1220, server/processor 210 outputs the results to user 220 as shown in FIG. 14 next to the statement “web site with possible similar technology.”

As shown in FIG. 13, another example includes a process 1300 where server/processor 210 receives the specification terms and claim terms from step 530. In step 1310, server/processor 210 conducts a search through the classifications index, such as that associated with the United States Patent and Trademark Office and estimates the class and subclass based on the occurrence of specification terms and claim terms in the title of the classification. In one example, as shown in FIG. 14, server/processor 210 outputs the class and subclass as shown next to the title “prior art classifications.” Again, as will be described in greater detail, a statistical processing method may be employed to conduct the search with greater accuracy. In step 1320, server/processor 210 then conducts a search through patent databases, such as those maintained by the United States Patent and Trademark Office, based on the class and subclass estimated in step B256 and the specification terms and claim terms. Again, a statistical processing method may be employed to increase the accuracy as will be described. In step 1330, server/processor 210 then outputs the results to the user 220 as shown, for example, in FIG. 14 next to the title “relevant patents.”

Referring now to FIG. 15, another example includes a process flow 1500 where server/processor 210 employs a translation program to allow for searching of foreign patent databases. For example, the process starts where server/processor 210 receives the specification terms and claim terms from step 530 (see FIG. 5). In step 1510, server/processor 210 then translates them into a foreign language, such as for example, Japanese.

In step 1520, foreign patent databases are searched similar to that described above.

In step 1530, the results of the search are then translated back into a desired language.

In step 1540, the results are output to the user 220.

As referenced above, a statistical processing method may be employed in any of the above searching strategies based on the specification terms, claim terms, or other information. More specifically, in one example, specification terms or claim terms are given particular weights for searching. For example, terms found in both the independent claims and as numbered specification terms of the source application are given a relatively higher weight. Likewise, specification terms having element numbers that are found in the specification more than a certain number of times or specification terms found in the specification with the most frequency are given a higher weight. In response, identification of the higher weighted terms in the searched classification title or patents is given greater relevance than the identification of lesser weighted terms.

Referring now to FIG. 16, another example includes a process flow 1600 where server/processor 210 employs heuristics to generate claims that include specification element numbers (e.g., per some foreign patent practices). Server/processor 210 receives the specification terms and claim terms from step 530 (see FIG. 5). In step 1610, the claim terms are reviewed to determine which claim terms match specification terms that have element numbers. In step 1620, server/processor 210 inserts the element numbers to the claim terms such that the claim terms are numbered (e.g., claim element “engine” becomes “engine (10)”). In step 1630, the numbered claim terms are output to the user 220 in a suitable format such as a text file of the numbered claims.

Referring now to FIG. 17, another example includes a process flow 1700 where server/processor 210 generates a summary and an abstract from the claims. The process starts at step 1710 where the independent claims are converted into sentence structured claims. This is accomplished by removing semicolons and replacing with periods and other suitable grammar substitutions. In step 1720, server/processor 210 replaces legal terms such as “said” and “comprising” with non-legal words such as respectively “the” and “including.” In step 1730, server/processor 210 strings the independent claims, now in sentence structure, together to form paragraphs in order of dependency. In step 1740, the paragraph structured independent claims are then linked into the summary and in step 1742, the summary's output to the user 220. In step 1750, server/processor 210 extracts the first independent claim for the summary (as that practice is understood by one skilled in the patent arts). In step 1752, server/processor 210 conducts a word count to insure that a number of words in the summary do not exceed the number allowed by the appropriate patent offices. In step 1754, server/processor 210 outputs the abstract and, if found, word number error to the user 220.

Referring now to FIG. 18, another example includes a process 1800 to output drawings for the user that include the element number and specification element name. Process 1800 may be run as a standalone process or it may further process results from step 920 (of FIG. 9) to achieve an output that merges the specification element names with the figures. The results are used to process the drawings with the specification and claim terms delivered from step 530 of FIG. 5. In one example, the specification terms having numbers that match the element numbers on the drawing sheets are listed on the drawings next to those element numbers. For example, the specification terms can be listed long the left-hand column of the drawings next to each figure number where the element numbers may be found. Alternatively, the specification terms are listed immediately next to the element numbers (e.g., element “10” in the figures may be converted to “10—engine” which defines the name of the specification term immediately after the reference numeral in the figure). In step 1810, server/processor 210 locates each element number used in the figure and searches for that element number in the specification output. Server/processor 210 then associates each particular element number with a specification element name. At step 1820, the drawings are output by server/processor 210 to the user 220, which may include, for example, a listing of element numbers and element names, or an element name next to each element number in the figures.

FIG. 19 shows an OCR process 1900 adapted to reading patent drawings and figures. In step 1910, patent figures or drawings are retrieved in a graphical format. For example, the patent figures or drawings may be in PDF or Tiff file formats. Next, in step 1914, OCR is performed and location information is recorded for each character or symbol recognized as well as OCR error position information. For example, the location information may be X/Y coordinates for each character start as well as the X/Y coordinates that define the boundaries of each character.

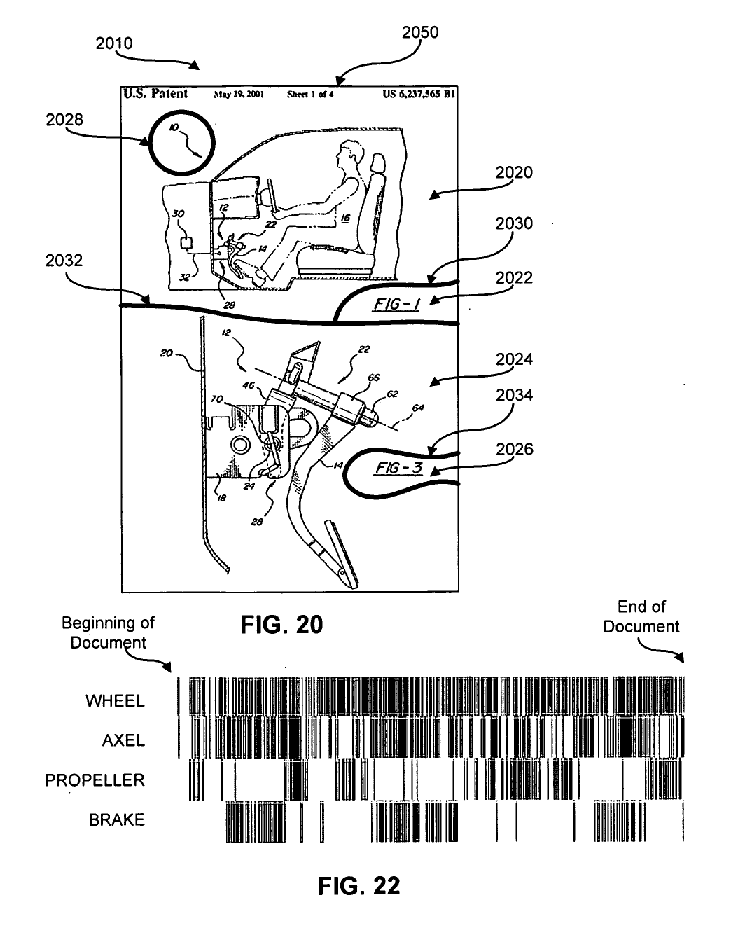

In step 1920, the graphical figures are subdivided into regions of non-contacting graphics. For example, FIG. 20 includes an exemplary patent drawing page 2010 that includes multiple non-contacting regions. A first region 2020 generally includes the graphics for “FIG-1”. A second region 2022 includes the text identifier for “FIG-1”. First region 2020 and second region 2022 are separated by a first delimiting line 2030 and a second delimiting line 2032. Second delimiting line 2032 further separates first region 2022 from a third region 2024 that includes the graphics for “FIG-3”. A third delimiting line 2034 surrounds fourth region 2026 that contains the text identifier for “FIG-3” and further separates third region 2024 from fourth region 2026.

In addition to region detection, the OCR heuristic may identify lead lines with or without arrows. As shown in FIG. 20, an element number “10” with a lead line is captured within a fifth region 2028.

In step 1924, the top edge of the drawing 2050 is segmented from the rest of the drawing sheet which may contain patent information such as the patent number (or publication number), date, drawing sheet numbering, etc.

In step 1930, an initial determination of the graphical figure location is made and position information is recorded for each, for example, where a large number of OCR errors are found (e.g., figures will not be recognized by the OCR algorithm and will generate an error signal for that position). The X/Y locations of the errors are then recorded to generally assemble a map (e.g., a map of graphical blobs) of the figures given their positional locations (e.g., X/Y groupings). In a manner similar to a scatter-plot, groupings of OCR errors may be used to determine the bulk or center location of a figure. This figure position data is then used with other heuristics discussed herein to correlate figure numbers and element numbers to the appropriate graphical figure.

In step 1934, an initial determination of the figure numbers, as associated with a graphical figure, is performed. For example, the proximity of an OCR recognized “FIG. 1”, “Figure 1”, “FIG-1”, etc. are correlated with the closest figure by a nearest neighbor algorithm (or other algorithm as discussed above). Once the first iteration is performed, other information may be brought to bear on the issue of resolving the figure number for each graphical blob.

In step 1940, an initial determination of element numbers within the graphical figure locations is performed. For example, each element number (e.g., 10, 20, 22, n) is associated with the appropriate graphical figure blob by a nearest neighbor method. Where some element numbers are outside the graphical figure blob region, the lead lines from the element number to a particular figure are used to indicate which graphical blob is appropriate. As shown by region 2028, the element number “10” has a lead line that goes to the graphical region for FIG. 1.

In step 1944, the figure numbers are correlated with the graphical figure locations (e.g., FIG. 1 is associated with the graphical blob pointed to in region 2020).

In step 1950, the element numbers are correlated with the graphical figure locations (e.g., elements 10, 12, 14, 16, 22, 28, 30, 32 are with the graphical blob pointed to in region 2020).

In step 1954, the element numbers are correlated with the figure numbers using the prior correlations of steps 1944, 1950 (e.g., element 30 is with FIG. 1).

This process may proceed with each page until complete. Moreover, disambiguation of figure numbers and element numbers may proceed in a manner as described above with regard to searching the specification for element numbers that appear with particular figure numbers to further refine the analysis.

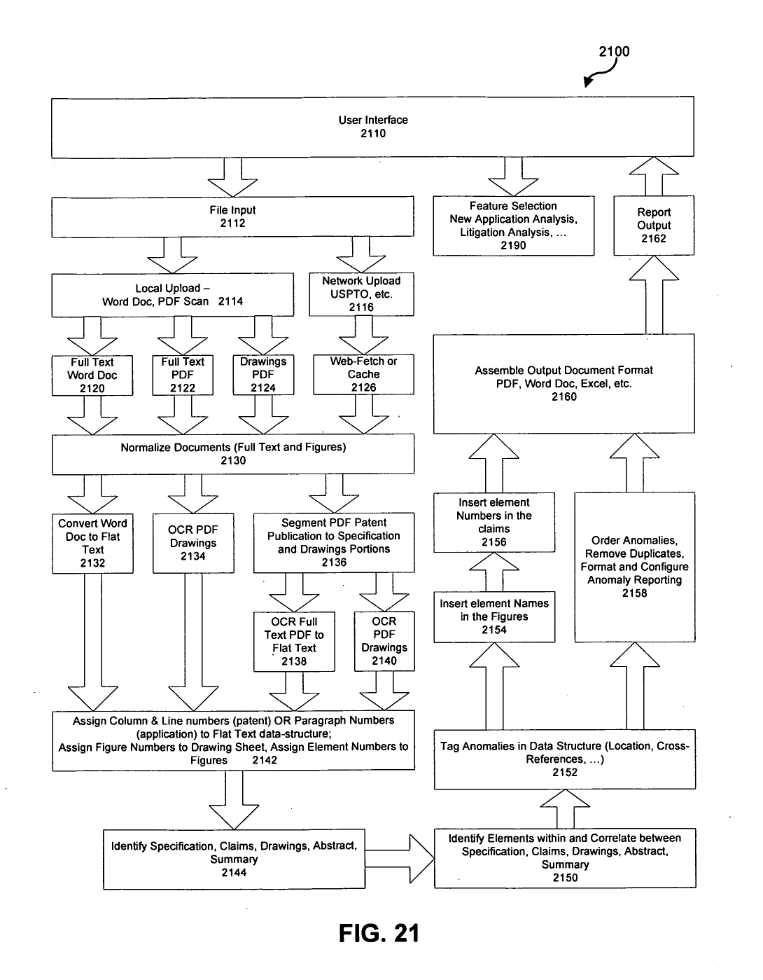

FIG. 21 is a functional flow diagram 2100 of a document analysis system for use with the methods and systems described herein. Block 2110 described a user interface that may be a network interface (e.g., for use over a network such as the Internet) or a local program interface (e.g., a program that operates on the Windows® operating system). User 220 may use a feature selection process 2190 to identify to the system what type of analysis is requested (e.g., application filing, litigation, etc.) for the particular documents identified (e.g., new patent application, published application, issued patent). In block 2112, the user inputs files or document identifiers. Local upload block 2114 allows user 220 to provide the files directly to the system, for example through an HTTPS interface from a local computer or a local network. When user 220 identifies a file, rather than uploading it directly, the system will search out the file to download through a network upload protocol 2116. In an example where user 220 identifies a patent or a published patent application, the system will locate the appropriate files from a repository (e.g., the USPTO). In block 2126, the system will fetch the files via the network or may also load the files from a cache (e.g., a local disk or networked repository).

In blocks 2120, 2122, 2124 the full text (e.g., a Word® document) is uploaded, a PDF file is uploaded, and PDF drawings are uploaded. It is understood that other document forms may be utilized other than those specified herein.

In step 2130, the files are normalized to a standard format for processing. For example, a Word® document may be converted to flat-text, the PDF files may be OCRed to provide flat text, etc., as shown by blocks 2132, 2134. In block 2136, document types such as a patent publication etc., may be segmented into different portions so that the full-text portion may be OCRed (as in step 2138) and the drawings may be OCRed (as in step 2140) using different methods tailored to the particular nature of each section. For example, the drawings may use a text/graphics separation method to identify figure numbers and element numbers in the drawings that would otherwise confuse a standard OCR method.

For example, the text/graphics is provided by an OCR system that is optimized to detect numbers, words and/or letters in a cluttered image space, such as, for example, that entitled “Text/Graphics Separation Revisited” by Karl Tombre et al. located at “http://www.loria.fr/˜tombre/tombre-das02.pdf”, the entirety of which is hereby incorporated by reference. In another example, separation of textual parts from graphical parts in a binarized image is shown and described at “http://www.qgar.org/static.php?demoName=QAtextGraphicsSeparation&demoTitre=Text/graphics %20separation”.

In block 2142, location identifiers may be added as metadata to the normalized files. In an example of an issued patent, the column and line numbers may be added as metadata to the OCR text. In another example, the location of element numbers and figure numbers may be assigned to the figures. It is understood that the location of the information contained in the documents may also be added directly in the OCR method, for example, or at other points in the method.

In block 2144, the portions of the documents analyzed are identified. In the example of a patent document, the specification, claims, drawings, abstract, and summary may be identified and metadata added to identify them.

In block 2150, the elements and element numbers may be identified within the document and may be related between different sections. In the example of a patent document, the element numbers in the specification are related to the element names in the specification and claims. Additionally, the element names may be related to the element numbers in the figures. Also, the figure numbers in the drawings may be related to the figure numbers in the specification. Such relations may be performed for each related term in the document, and for each section in the document.

In block 2152, any anomalies within each section and between sections may be tagged for future reporting to user 220. For example, the anomaly may be tagged in metadata with an anomaly type (e.g., inconsistent element name, inconsistent element number, wrong figure referenced, element number not referenced in the figure, etc.) and also the location of the anomaly in the document (e.g., paragraph number, column, line number, etc.). Moreover, cross-references to the appropriate usage may also be included in metadata (e.g., the first defined element name that would correlate with the anomaly).

Additional processing may occur when, for example, the user selects to have element names identified in the figures and/or element numbers identified in the claims. In block 2154, the element names are inserted or overlaid into the figures. For example, where each element number appears in the figures, the element name is placed near the element number in the figures. Alternatively, the element numbers and names may be added in a table, for example, on the side of the drawing page in which they appear. In block 2156, the element numbers may be added to the claims to simplify the lookup process for user 220 or to format the claims for foreign practice. For example, where the claim reads “said engine is connected to said transmission” the process may insert the claim numbers as “said engine (10) is connected to said transmission (12)”.

When processing is complete, the system may assemble the output (e.g., a reporting of the process findings) for the user which may be in the format of a Word® document, an Excel® spreadsheet, a PDF file, an HTML-based filed, etc.

At block 2162, the output is sent to user 220, for example via e-mail or a secure web-page, etc.

In another example, the system recognizes closed portion of the figures and/or differentiates cross-hatching or shading of each of the figures. In doing so, the system may assign a particular color to the closed portion or the particular cross-hatched elements. Thus, the user is presented with a color-identified figure for easier viewing of the elements.

In another example, the user may wish to identify particular element names, element numbers, and/or figure portions throughout the entire document. When user 220 identifies an element number of interest, the system shows each occurrence of the element number, each occurrence of the element name associated with the element number, each occurrence of the element in the claims, summary, and abstract, and the element as used in the figures. Moreover, the system may also highlight variants of the element name as used in the specification, for example, in a slightly different shade than is used for the other highlights (where color highlighting is used).

In another example, the system may recognize cross-hatching patterns and colorizes the figures based on the cross-hatching patterns and/or closed regions in the figures. Closed regions in the figures are those that are closed by a line and are not open to the background region of the document. Thus, where an element number (with a leader line or an arrow) points to a closed region the system interprets this as an element. Similarly, cross-hatches of matching patterns may be colorized with the same colors. Cross-hatches of different patterns may be colorized in different colors to distinguish them from each other.

In another example, the system may highlight portions of the figures when the user moves a cursor over an element name or element number. Such highlighting may also be performed, for example, when the user is presented with an input box. The user may then input, for example, a “12” or an “engine”. The system then highlights each occurrence in the document including the specification and drawings. Alternatively, the system highlights a drawing portion that the user has moved the cursor over. Additionally, the system determines the element number associated with the highlighted drawing portion and also highlights each of the element numbers, element names, claim terms, etc. that are associate with that highlighted drawing portion.

In another example, an interactive patent file may be configured based on document analysis and text/graphical analysis of the drawings. For example, an interactive graphical document may be presented to the user that initially appears as a standard graphical-based PDF. However, the user may select and copy text that has been overlaid onto the document by using OCR methods as well as reconciling a full-text version of the document (if available). Moreover, on the copy operation the user may also receive the column and line number citation for the selection (which may assist user 220 in preparing, for example, a response to an office action). When the user pastes the selected text into another document, the copied text appears in quotations along with the column/line number, and if desired, the patent's first inventor to identify the reference (e.g., “text” (inventor; col. N, lines N-N)).

In another example, the user may request an enhanced patent document, fore example, in the form of an interactive PDF file. The enhanced patent document may appear at first instance as a typical PDF patent document. Additional functionality, e.g. the enhancements, allow the user to select text out of the document (using the select tool) and copy it. The user may also be provided with a tip (e.g., a bubble over the cursor) that gives then column and line number. Additionally, the user may select or otherwise identify a claim element or a specification element (e.g., by using a double-click) that will highlight and identify other instances in the document (e.g., claims, specification, and drawings).

FIG. 22 shows a word distribution map 2200 which is a graphical indication of word frequency starting from the beginning of a document (or section thereof) and the end of the document and includes the word's position in the document (in a linear document form). Each time the word on the left is mentioned in the text, a bar is indicated with its position in the document. Using such mapping the system can draw inferences as to the relevancy of each word to another (or lack of relevancy).

Examples of inferences drawn from distribution map 2200 include the relevancy of certain specification elements (e.g., “wheel” and “axel”) to each other. The system can readily determine that “wheel” and “axel” are not only discussed frequently throughout the text, but usually together because multiple lines appear in the text in close proximity to each other. Thus, there is a strong correlation between them. Moreover, it appears that “wheel” and “axel” are introduced nearly at the same time (in this example near the beginning of the document) indicating that they may be together part of a larger assembly. This information may be added as metadata to the document for later searching and used as weighting factors to determine relevancy based on search terms.

In another example, the system may determine that “brake” is frequently discussed with “wheel” and “axel”, but not that “wheel” or “axel” is not frequently discussed with “brake”. In another example, the system can determine that “propeller” is not discussed as frequently as “wheel” or “axel”, and that it is usually not discussed in the context of “brake”. E.g., “propeller” and “brake” are substantially mutually exclusive and thus, are not relevant to each other.

Examples of how the systems and methods used herein may be used are described below. For example, a practitioner or lawyer may be interested in particular features at different stages in the life of a document. In this example, a patent application and/or a patent may be analyzed for different purposes for use by user 220. Before filing, for example, user 220 may want to analyze only the patent application documents themselves (including the specification, claims, and drawings) for correctness. However, user 220 may also want to determine if claim terms used have been litigated, or have been interpreted by the Federal Circuit. In another example, a patent document may be analyzed for the purposes of litigation. In other examples, a patent document may be analyzed for the prosecution history. In another example, the patent or patent application may be analyzed for case law or proper patent practice. In another example, the documents may require preparation for foreign practice (e.g., in the PCT). In another example, an automated system to locate prior art may be used before filing (in the case of an application) to allow user 220 to further distinguish the application before filing. Alternatively, a prior art search may be performed to determine possible invalidity issues.

Checking a patent application for consistency and correctness may include a number of methods listed below: C1—Element Names Consistent, C2—Element Numbers Consistent, C3—Spec Elements cross ref to figures, C4—Claim Elements cross ref to figures, C8—Are limiting words present?, C9—Does each claim term have antecedent basis?, C10—Does each claim start with capital, end with period, C11—Is the claim dependency proper, C13—Count words for abstract—warn if over limit, C15—No element numbers in brief description of drawings.

Moreover, reports may be generated including: C5—Insert Element Numbers in claims, C6—Insert Element Names in figures, C7—Report Claim elements/words not in Spec, C12—Count claims (independent, dependent, multiple-dependent), C16—create abstract and summary from independent claims.

Additionally, secondary source analysis may include: C14—Check claim words against a standard dictionary—are any words not found, e.g. sealingly or fixedly that may merit definition in the specification, C17—Inclusions by reference include correct title, inventor, filing date . . . (queried from PTO database to verify), C18—Verify specialty stuff like chemical formulas and/or sequences (reference properly, used consistently).

When analyzing a document for litigation purposes, the above methods may be employed (e.g., C1, C2, C3, C4, C5, C6, C7, C8, C9) and more specialized methods including: L1—Charts for Claim elements and their location in the specification, L3—Was small entity status properly updated? (e.g., an accounting of fees), L4—Is small entity status claims where other patents for same inventor/assignee is large entity?, L5—Cite changes in the final patent specification from the as-filed specification (e.g., new matter additions), L6—Was the filed specification for a continuation etc. exactly the same as the first filed specification? (e.g., new matter added improperly), L7-Does the as-issued abstract follow claim 1? (e.g., was claim 1 amended in prosecution and the abstract never updated?), L8—Do the summary paragraphs follow the claims? (e.g., were the claims amended in prosecution and the summary never updated?), L9—Given a judge's name, have any claim terms come before the judge? any in Markman hearing?, L10—Have any claim terms been analyzed by the Fed. Cir.? (e.g., claim interpretation?)

With regard to prosecution history: H1—Which claims were amended, H2—Show History of claim amendments, concise, and per-claim (cite relevant amendment or paper for each), H3—Show prosecution arguments per claim, e.g. claim 1, prosecution argument 1, prosecution argument 2, etc., as taken from the applicant's responses in the prosecution history, H4—Are the issued claims correct? (e.g., exact in original filing and/or last amendment), H5—Timeline of amendment, H6—Timeline of papers filed, H7—Are all inventors listed in oath/declaration?, H8—Show reference to claim terms or specification in the prosecution history. In other words, how a particular claim term was treated in the prosecution history to provide additional arguments regarding claim construction or interpretation.

With respect to case law: L1—Search for whether the patent been litigated. If so, which cases?, L2—Search for claim language litigated, better if in Markman hearing or Fed Cir opinion, L3—Has certain claim language been construed in MPEP-warning and MPEP citation (e.g. “adapted to” see MPEP 2111.04)

With respect to foreign practice: C5—Insert Element Numbers in claims (e.g., for the PCT), F1—Look for PCT limiting words, F2—Report PCT format discrepancies.

With respect to validity analysis: V1—Is there functional language in apparatus claim?, V2—Are limiting words present?, V3—claim brevity (goes to the likelihood of prior art being available)

With respect to prior art location, keywords & grouped synonyms along with location in sentences, claims, figures (or the document generally) may be used to determine relevant prior art. In an example, a wheel and an axel in the same sentence or paragraph means they are related. A1—Read claims—search classification for same/similar terms, rank by claim terms in context of disclosure

With respect to portfolio management: P1—Generate Family Tree View (use continuity data from USPTO and Foreign databases if requested), P2—Generate Timeline View, P3—Group patents from Assignee/Inventor by Type (e.g., axel vs. brake technology are lumped separately by the claims and class/subclass assigned).

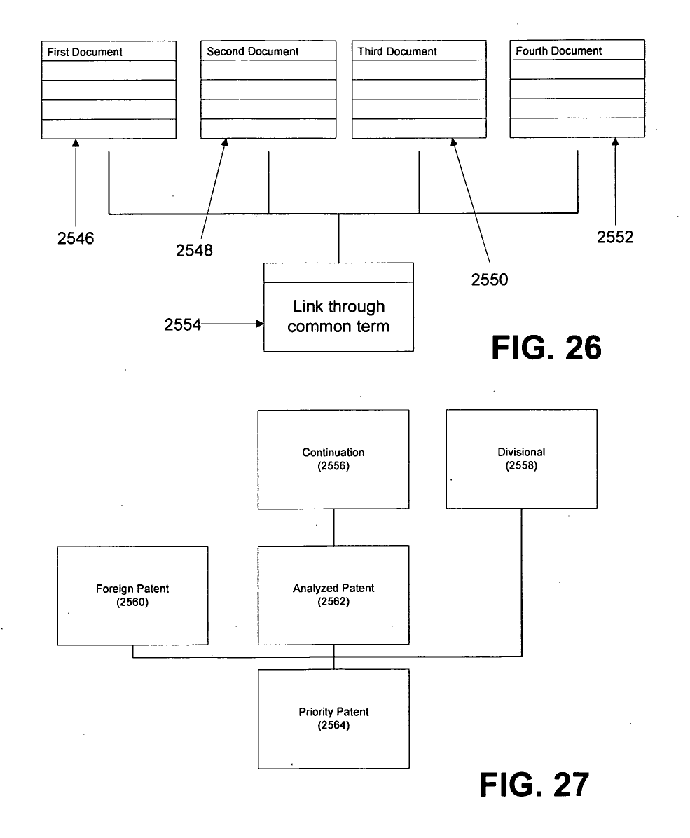

Referring now to FIG. 26, another example is described. In FIG. 26, a first document 2546, second document 2548, third document 2550, and forth document 2552 are shown being linked through a common identifier 2554. The common identifier may include any alphanumeric or other character or set of characters, drawing, design, word or set of words, a definition or meaning (for example, light bulb in one document and illumination device in another document), or other feature common and unique to at least two of the documents illustrated in FIG. 4. In one example, the common identifier is highlighted in first documents 2546, second document 2548, third document 2550 and forth document 2552. In another example, a master list is provided listing each common identifier. In such example, selecting the common identifier in the master list will cause the common identifier to be highlighted or otherwise identified in each of the first documents 2546, second document 2548, third document 2550 and forth document 2552. In another example, the common identifier is a same word or number or other alphanumeric identifier that is found in each of the documents.

In yet another example, the common identifier in one document, such as first document 2546, is a number while the common identifier in another document, such as second document 2548, is that number combined with a set of alphanumeric characters such as a word. The number, in one example, may be positioned next two or adjacent to the word in the second document 2548, or the number and word may be associated in some other way in the second document 2548. For example, the first document 2546 can be a drawing having a common identifier such as the number “6” pointing to a feature in the drawing, while the second document 2548 is the specification of the patent having the common identifier “connector 6.” This example illustrates that the common identifier need not be identical in both documents and instead should only be related in some unique fashion. Likewise, a common identifier in the first document 2546 may be simply a number pointing to a feature on a drawing while the common identifier in the second document 2548 may also be the same number pointing to a feature in a drawing in the second document. It will also be understood that the present example may be applied to any number of documents. Likewise, the common identifier may link less than all the documents provided. For example, in FIG. 26, only first document 2546 and third document 2550 may be linked through a common identifier, and the remaining documents unlinked. Likewise, the term “link” is given its broadest possible interpretation and includes any form or means of associating or commonly identifying a unique feature among documents. Non-limiting examples of linking will be described in the examples below.

Referring now to FIG. 30, an example of a process for linking common identifiers is shown and described. In FIG. 30, a first document is obtained in step 2566 and a second document is obtained in step 2570. The documents may be obtained through any means, such as those described in the present application including but not limited to the descriptions associated with FIGS. 2, 3, 4, 5 and 7 in the present application.

In steps 2568 and 2572, the document information is processed to find the common identifiers. In one example, one of the documents is a patent, prosecution history or other text based document, and a process such as that described with respect to FIGS. 1-5 and 11 is employed to find common identifiers such as specification terms or claim terms. In another example, where one of the documents is a drawing, the common identifiers may be found by employing the process described with respect to FIGS. 7 and 7A to provide a listing of element numbers. More specifically, the drawings may be processed to identify and provide a listing of element numbers in the drawings, locations of such drawing element numbers, and/or figures associated therewith.

In step 2574, the common identifiers are linked. In one example, the common identifiers are linked as described with respect to (but not limited to) the process described in FIG. 9 of the present application. As shown in FIG. 10, the location of each of the specification terms and claim terms (common identifiers in this example) for each document is provided. For example, the location of connector 6 is shown in the specification, claims, drawing and prosecution history. In such a way, common identifiers such as “connector 6” are linked across the specification, claims and prosecution history of the patent. Likewise, the common identifiers “connectors 6” and “6” are linked across the textual specification, claims and prosecution history and the graphical drawings.

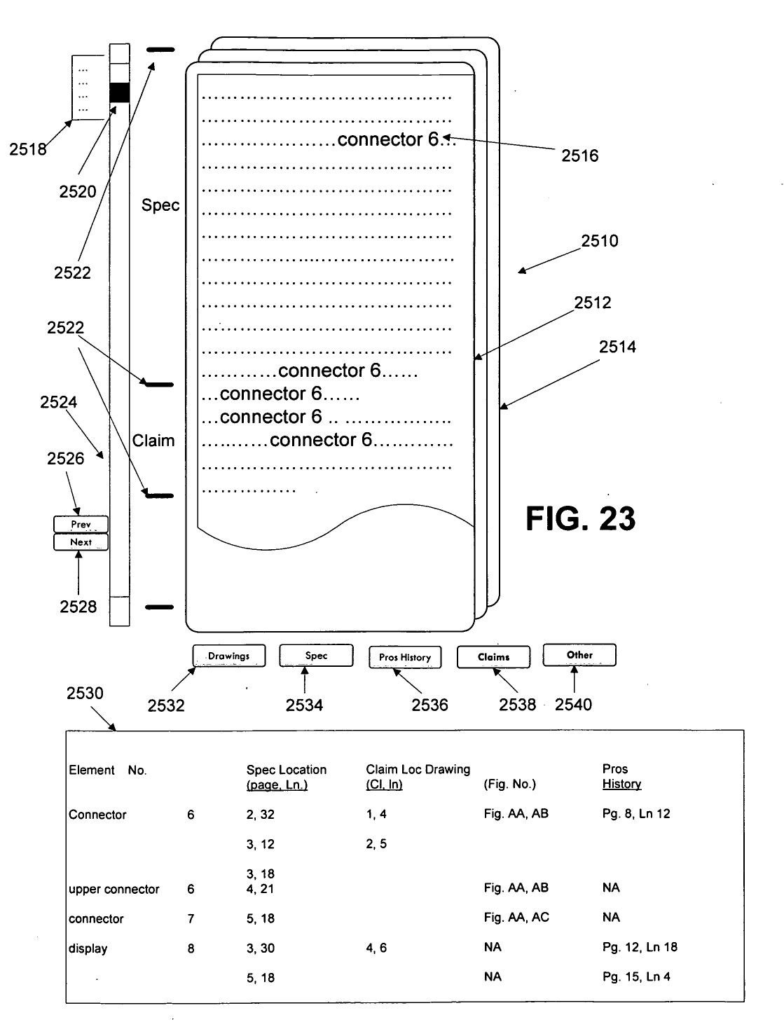

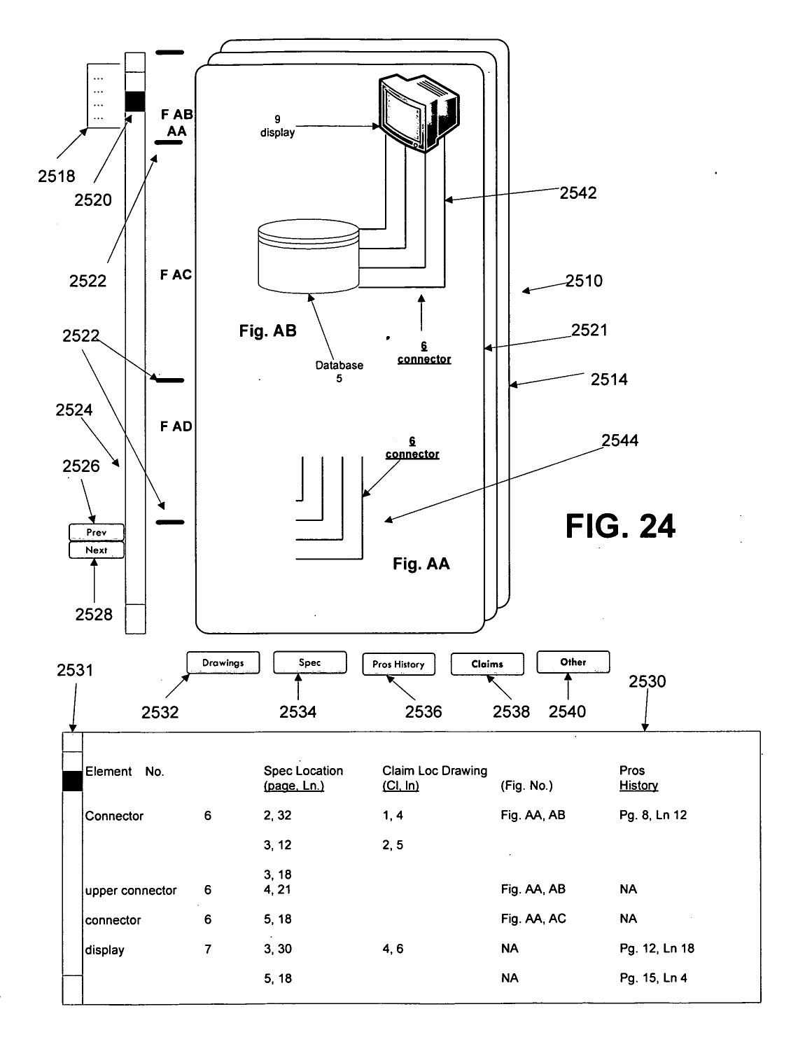

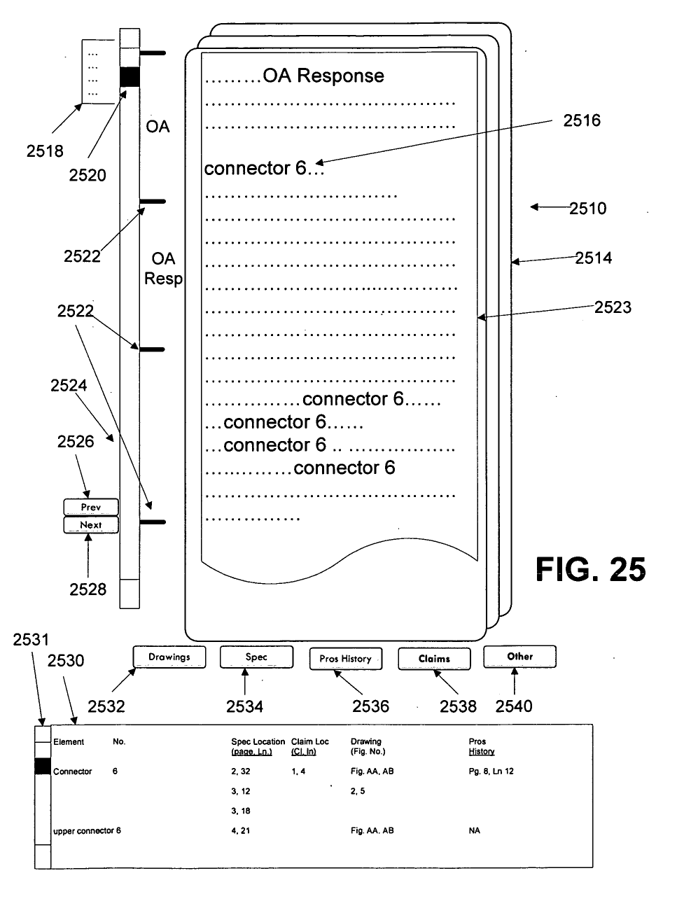

Referring now to FIG. 23, another example showing a format for the output of linked common identifiers generated in step 2574 is shown and described. In FIG. 23, a display 10 is shown having the specification page 2512 at a front or displayed location and back pages 2514 not displayed. In the example of FIG. 23, each of the pages provides a view of a different document. In the example shown in FIG. 23, specification page 2512 displays the specification of a patent at a front or displayed location and highlights the common identifier (specification element) “connector 6.” In the example, back pages 2514 include, drawings, prosecution history, claims, and other documents. As shown in FIGS. 24 and 25, drawings page 2521 and prosecution history page 2523 may be moved to a displayed or front page position by selection of drawing button 2532 or prosecution history button 2536 respectively. Likewise, one will readily understand that selecting claims but in 2538 or other button 2540 will provide likewise displays of a claim section or another document (as will be described) to the front-page display.

At the lower portion of FIG. 23, a linking display 2530 is provided. Like that described for FIG. 10, linking display 2530 provides an index of common identifiers, in this case specification elements or claim elements, as well as additional information (as discussed with respect to FIG. 10) regarding such common identifiers. In the example, selection of a common identifier in the linking display causes that common identifier in the front-page portion (whether the drawings, specification, prosecution history, claims or other is currently in the front page position) to be identified such as, but not limited to, highlighting or bolding. As shown in FIG. 23, the common identifier connector 6 is in bold when connector 6 in the linking display 2530 is selected. Likewise, in FIG. 25, the element number “6” and the drawings is bolded and also labeled with the term “connector” when that common identifier is selected in the linking display 2530. Similar identification may be used for prosecution history, claims or alternate source. It will be understood that the present invention contemplates any means or form of identification beyond highlighting or bolding, and may include any known means or feature of identification.

Scrollbar 2524 is shown at a left side region of FIGS. 23, 24 and 25. In one example, the length of the scrollbar represents the entire length of the document in the display 2510. The scrollbar 2524 includes a display region 2518 that illustrates what portion of the entire document is currently being displayed in the front page of view. More specifically, the upper and lower brackets of the display region 2518 represent the upper and lower borders of the specification page 2512 in FIG. 23. One will readily understand that when the scrollbar is scrolled down, the display at the front-page view will move up exposing lower features and hiding upper displayed features of the document and will cause the display region 2518 to move down along the scrollbar 2524.

The scrollbar 2524 also includes a hit map representing the location of common identifiers in the document at the front page position in the display 2510. In the example of FIG. 23, location 2520 represented by a dark block represents a high concentration of common identifiers (in the example, connector 6 at 2516) located on the portion of the specification that is currently being displayed. When one looks at the display to the right, one sees a high concentration of the term “connector 6.”

Section breaks 2522 are provided to divide a document into sub regions. For example, in FIG. 23, the section breaks break the specification into a specification section and a claim section. In FIG. 24, section breaks 2522 break the drawings into different figures. In FIG. 25, section breaks 2522 break the prosecution history into different features such as office action, office action response, restriction requirements or other known distinctions. Identification of each of these regions or breaks may be performed as described with respect to FIGS. 1-5 in the present application. As stated previously, a document may represent an entire piece of information such as the entirety of a written patent or may represent individual components of a patent such as a specification section or claim section. In the example presently described, a document in FIG. 23 includes both the specification section and claim section. By this way, one can tell from the scrollbar, hit map and section breaks as to what part of a document they are currently viewing and where the common identifiers are located in such document.

Previous button 2526 and next button 2528 allows the user to jump to the most previous and next common identifier in the document. For example, selecting next button 2528 causes the scrollbar to move down and display the next common identifier such as “connector 6” that is not currently being displayed in the front-page view.

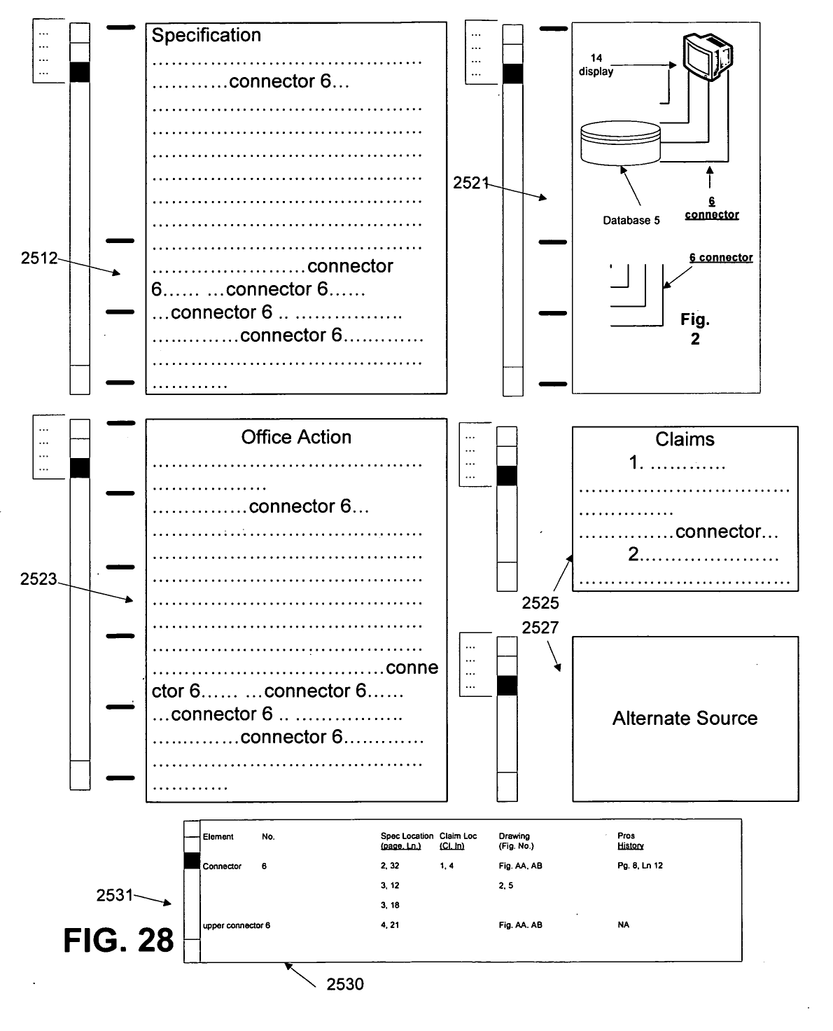

Referring now to FIG. 28, another example is shown and described. In FIG. 28, multiple document displays are shown in a single display. More specifically, the specification page 2512 is positioned at an upper left location with its associated scrollbar and breaks, prosecution history 2523 is shown at a lower left portion with its associated features, drawing page 2521 is shown at an upper right position with its associated features, claims page 2525 shown at a middle right position, and alternate source page 2527 is shown at a lower right position. It will be understood that the alternate source page 2527 may be displayed by selecting the other button 2540 in any of the described examples.

Referring now to FIG. 27, an example for the alternate source 2527 is shown and described. In FIG. 27, a tree diagram is provided that shows branches of prosecution for an example patent. In the example illustrated, a priority patent is filed at block 2564. The patent currently being analyzed (such as in specification page 2512, drawing page 2521, or prosecution history page 2523) is represented at block 2562. An associated foreign patent application based on the priority application referenced at block 2564 is shown at block 2560. Likewise, a continuation application is shown at block 2556 and a divisional application is shown at lock 2558. It will also be understood that the alternate source 2527 may include additional features of any one of these applications such as the prosecution history.

In the example of FIG. 27, selection of any one of the blocks illustrated therein positions that corresponding document into the alternate source 2527. The alternate source positioned in the display, as will be understood, is processed in accordance with the processing of documents as described in FIG. 30. By this way, the user may view additional documents related to the displayed document.

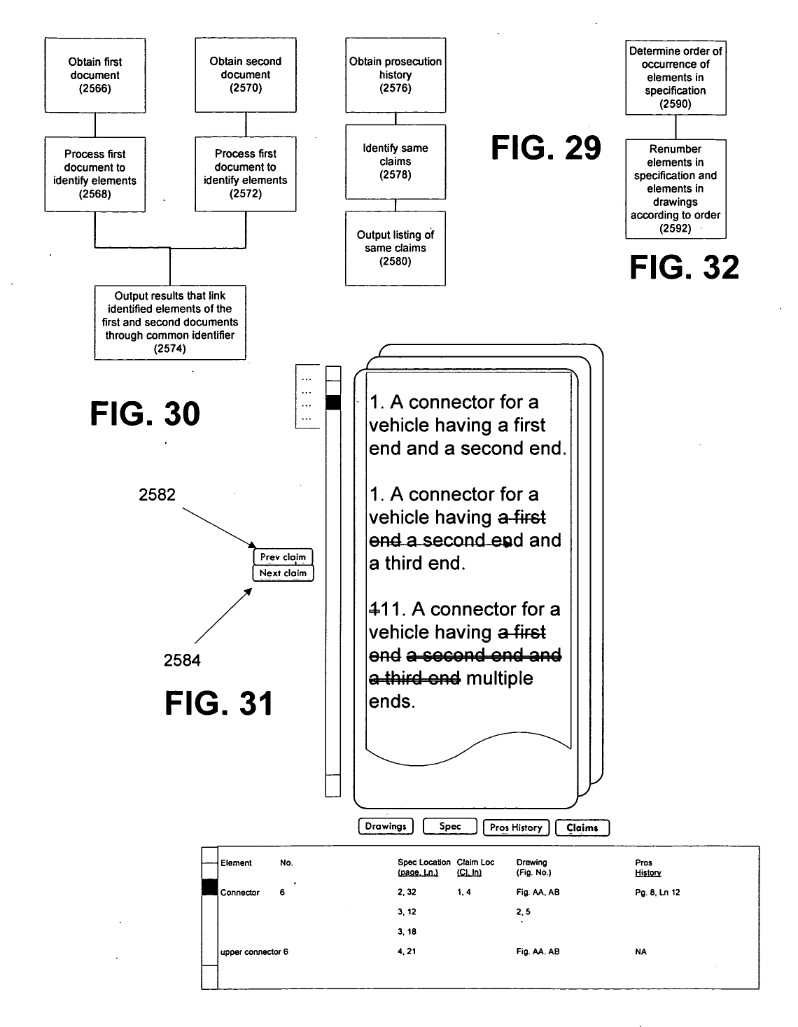

Referring now to FIG. 29, another example is shown in described. In FIG. 29, claim amendments conducted during prosecution are identified to determine changes in alterations thereto. In one example, an analysis in accordance with FIG. 22 is performed throughout the prosecution history of a patent to identify the same claims. In step 2576, such prosecution history is obtained. In step 2578, the claims throughout the prosecution history are analyzed to determine which of the claims are the same. For example, where each claim includes the claim number 1 am very similar claim language, such claims will be deemed to be the same. The claims are then analyzed to determine similarities and differences from the beginning of the prosecution to the end of the prosecution. Such analysis may be accomplished by known word and language comparisons. In step 2580, the claims as amended is output in a display format. Referring to FIG. 31, the claims are listed in order from start of prosecution to end of prosecution from the top of the displayed document to the bottom. As can be seen, when a claim is change or altered, such change or alteration is displayed in the view.

Referring now to FIG. 32, another example is shown in described. In the example of FIG. 32, the first document is a textual document of a patent, such as the specification, and a second document is a graphical document of a patent such as the drawings. During patent drafting, it sometimes occurs that patent drafters do not number or label drawings in order and have to come at some later time to renumber the element numbers in the patent drawings in renumber specification elements in the specification. In FIG. 32, the output from step 2574 in FIG. 30 is fed into step 2590. In step 2590, the order of occurrence of each of the word portion of the specification elements is determined. For example, if the specification element “connector 6” occurs first in the specification and the specification element “hitch 2” occurs next in the specification, then the term connector 6 will be deemed first in order and the term “hitch 2” will be deemed second in order. Again, such ordering may be determined through the process is described in the present application including but not limited to those described with respect to FIGS. 1-5. In step 2592, the specification elements in the text document and the element numbers in a drawing document are then relabeled in accordance with their order in the specification. In the example described above, “connector 6” would be relabeled “connector 2” and the term “hitch 2” would be relabeled “hitch 4.” Such labeling may be performed through process as described in this application as well as common find/paste operations in word processing applications. In the drawings, the element number “6” would be relabeled as “2.” Likewise, the element number “2” in the drawings would be relabeled as “4.” Again, such may be performed through process is described in the present application.

As discussed herein, the identification of text associated with documents, documents sections, and graphical images/figures, may be provided by analysis of the text or images themselves and/or may also be provided by data associated with the document, or graphical images/figures. For example, an image file may contain information related to it, such as a thumbnail description, date, notes, or other text that may contain information. Alternatively, a document such as a XML document or HTML document may contain additional information in linking, descriptors, comments, or other information. Alternatively, a document such as a PDF file may contain text overlays for graphical sections, the location of the text overlay, or metadata such as an index or tabs, may additionally provide information. Such information, from various sources, and the information source itself, may provide information that may be analyzed in the document's context.

Document. A document is generally a representation of an instrument used to communication an idea or information. The document may be a web page, an image, a combination of text and graphics, audio, video, and/or a combination thereof. Where OCR is discussed herein, it is understood that video may also be scanned for textual information as well as audio for sound information that may relate to words or text.

Document Content Classification. Documents groups may be classified and related to a collection of documents by their content. An example of document groups in the context of patent documents may include a class, a subclass, patents, or published applications. Other classes of documents may include business documents such as human resources, policy manuals, purchasing documents, accounting documents, or payroll.

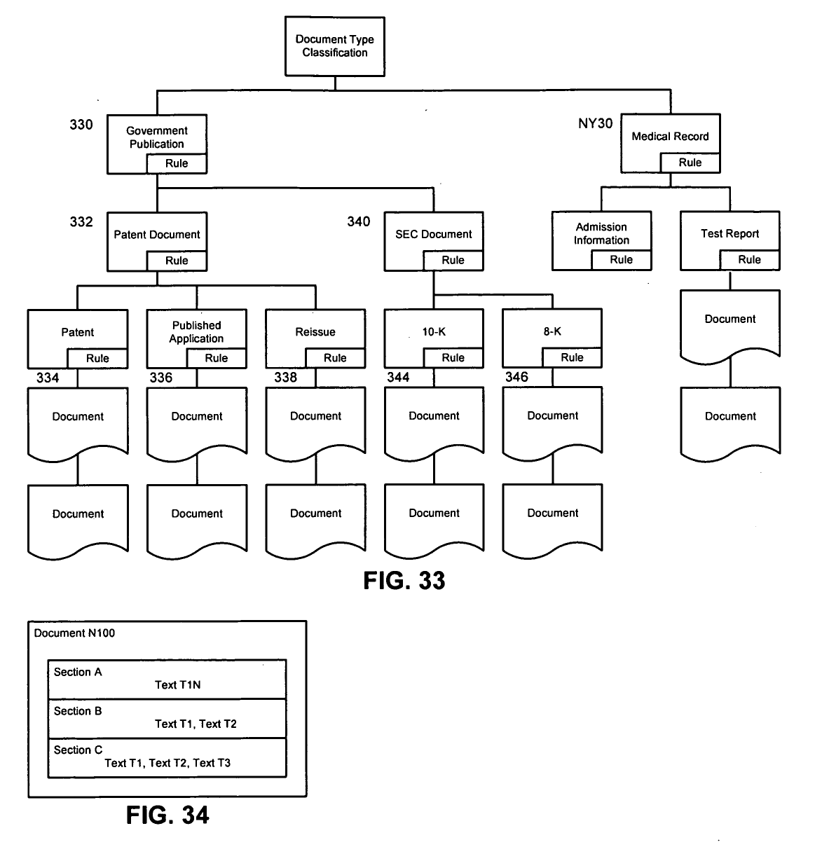

Document Type Classification. Documents may be classified into document types by the nature of the document, the intended recipient of the document, and/or the document format. Document types may include a patent document, a SEC filing, a legal opinion, etc. The documents may be related to a common theme to determine the document type. For example, FIG. 33 is a document Type classification tree that includes a document type for government publications (330) and medical records (NY30). Government publications (330) may be further sub-classified as a patent document (332) or a SEC document (340). They may further be subdivided by type (e.g., a patent document (334), a published application (336), a reissue patent (338), an SEC 10-K (344), and an SEC 8-K (346)). Moreover, each classification may include a rule to be associated with preprocessing to generate metadata (see below), indexing, or searching. The rules provide structure for determining where information should be subdivided into sections, whether linking of information is appropriate, and/or how to assign relevancy to the information, linking, and document sections based on the desired search type (e.g., a novelty search vs. an infringement search). The rules may be generated automatically by analyzing the document structure, or by user input. For example, the patent document (332) may have user defined rules such as sectionalizing the document by drawings, detailed description, and claims, having elements extracted therefrom, and element linking added to the document. Each document type classification may have its own rules, as well as more particularized rules for each sub-classification.

Document Section. FIG. 34 is an example of a document having sections. Documents may be examined to divide the document into document sections. Each document may then be analyzed, indexed and/or searched according to its content, the indexing and searching being customized based on the document type. Information types may broadly include many representations of information for the document, some which may be visible to the user, some that may be embedded. Examples of information types may include text, graphics, mixed graphics and text, metadata, charts (e.g., pie and bar), flowcharts tables, timelines, organizational diagrams, etc. The document sections may be determined by a rule, for example, the rules associated with certain document type classifications (e.g., see FIG. 33). For example, FIG. 34 shows Section A, Section B, and Section C. Where Document N100 is a patent document (e.g., 334 of FIG. 33), Section A includes drawing pages and drawing figures, Section B includes the detailed description, and Section C includes the claims.

Document sections may have different meaning based on the document type. For example, a patent document (e.g., a patent or a patent application) may include a “background section” a “detailed description section” and a “claims section”, among others. An SEC filing 10-K document may include an “index”, a “part” (e.g., Part I, Part II), and Items. Further, these document sections may be further assigned sub-sections. For example, the “claims” section of a patent may be assigned sub-sections based on the independent claims. For an SEC document, the sub-sections may include financial data (including tables) and risk section(s). Sections may also be determined that contain certain information that may be relevant to specialized searches. Examples may include terms being sectionalized into a risk area, a write down area, an acquisition area, a divestment area, and forward looking statements area. Legal documents may be sectionalized into a facts section, each issue may be sectionalized, and the holding may be sectionalized. In the search or indexing (as described herein), the proximity of search terms within each section may be used to determine the relevancy of the document. In an example, where only the facts section includes the search terms, the document may be less relevant. In another example, where the search terms appear together in a specific section (e.g., the discussion of one of the issues) the document may become more. In another example, where search terms are broken across different sections, the document may become less relevant. In this way, a document may be analyzed for relevancy based on document sections, where existing keyword searches may look to the text of the document as a whole, they may not analyze whether the keywords are used together in the appropriate sections to determine higher or lower document relevancy.

Text. Text may be comprised of letter, numbers, symbols, and control characters that are represented in a computer readable format. These may be represented as ASCII, ISO, Unicode, or other encoding, and may be presented within a document as readable text or as metadata.

Image. An image may be comprised of graphics, graphical text, layout, and metadata. Graphics may include a photograph, a drawing (e.g., a technical drawing), a map, or other graphical source. Graphical text may include text, but as a graphical format, rather than computer readable text as described above.

Audio. Audio information may be the document itself or it may be embedded in the document. Using voice recognition technology, a transcript of the audio may be generated and the methods discussed herein may be applied to analyze the audio.

Video. A video may be included in the document, or the document itself. As discussed herein, the various frames of the video may be analyzed similarly to an image. Alternatively, a sampling of frames (e.g., one frame per second) may be used to analyze the video without having to analyze every frame.

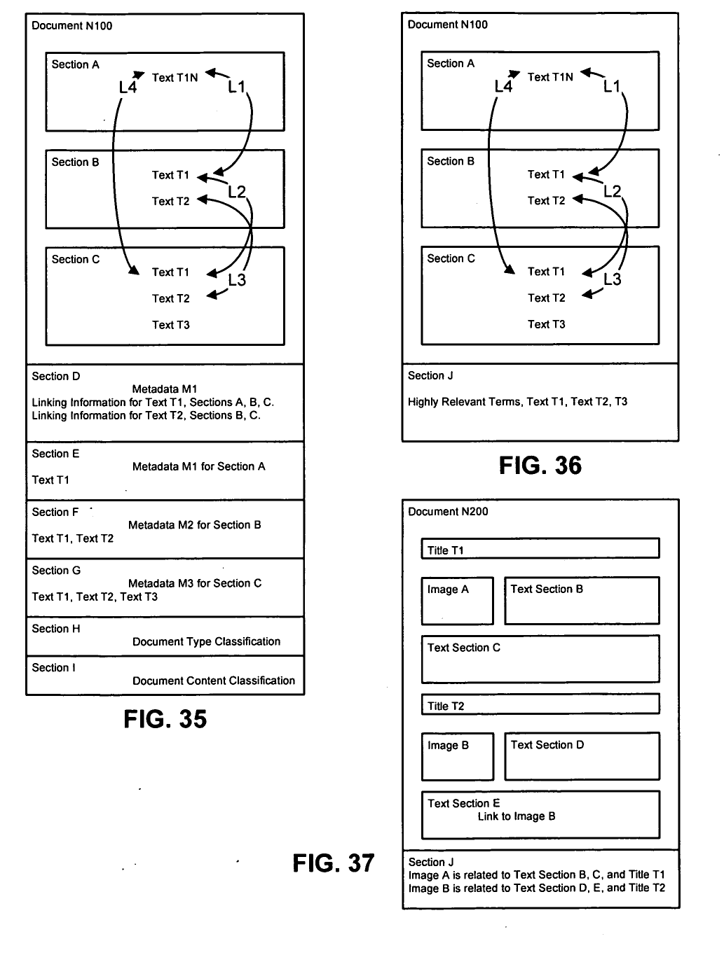

Document Analysis. FIG. 35 is an example of document analysis for improved indexing, searching, and display. A document N100 includes, for example, three sections, Section A, Section B, and Section C. The document sections (A, B, C) may be determined from the Document Type Classification. In a patent document, Section A may include drawing images (and may further include subsections for each drawing page and drawing figure), Section B may include the detailed description (and may further include subsections for drawing figure references, paragraphs, tables, etc.), and Section C may include the claims (and may further include subsections for each independent claim, and dependent claims).

An information linking method may be performed on the Document N100 to provide links between text in each section (e.g., Sections A, B, C), see FIG. 35 for a detailed description on information linking within a document. Such linking information may be included in a generated metadata section, Section D, that contains linking information for the text within each of Sections A, B, C. In general, keywords or general text may be associated with each other between sections. In an example, Text T1 appearing in the claims Section C as a “transmission” may be associated by link L2 to an appearance of “transmission” in the detailed description Section B. In another Example, the Text T1 appearing in the detailed description Section B as “transmission 10” may be linked L1 with a drawing figure in Section A where element number “10” appears. In another example, the Text T1 appearing in the claims Section C as “transmission” may be linked L4 with a drawing figure in Section A by the appearance of element number “10”, the relation of element name “transmission” and element number “10” provided by the detailed description. In another example, Text T2 appearing in the claims Section C as a “bearing” may be associated by link L3 to an appearance of “bearing” in the detailed description Section B.

Another generated metadata section, Section E, may include additional information on Section A. For example, where Section A is a graphical object or set of objects, such as drawing figures, Section E may include keyword text that relates to section A. In an example where Section A is a drawing figure that includes the element number “10” as Text T1N, relational information from the detailed description Section B, may be used to relate the element name “transmission” (defined in the detailed description as “transmission 10”) with element number “10” in Section A. Thus, an example of metadata generated from the Document N100 may include Section E including the words “transmission” and/or “10”. Further, the metadata may be tagged to show that the element number is “10” and the associated element name is “transmission”. Alternatively, Section E could include straight text, such as “transmission”, “transmission 10”, and/or “10”, to be indexed or further used in searching methods. Such metadata may be used in the search or index field to allow for identification of the drawing figure when a search term is input. For example, if the search term is “transmission”, Section E may be used to determine that “Figure 1” or “Figure 2”, of Document N100, is relevant to the search (e.g., for weighting using document sections to enhance relevancy ranking of the results) or display (e.g., showing the user the most relevant drawing in a results output).

Another generated metadata section, Section F, may include metadata for Section B. In an example, Section B may be assigned to the detailed description section of a patent document. Section F may include element names and element numbers, and their mapping. For example, Text T1 may be included as “transmission 10” and text T2 may include “bearing 20”. Moreover, the mapping may be included that maps “transmission” to “10” and “bearing” to “20”. Such mapping allows for the linking methods (e.g., as described above with respect to Text T1 in section B “transmission” with Text T1N “10” in section A). Section F may be utilized in a search method to provide enhanced relevancy, enhanced results display, and enhanced document display. For example, in determining relevancy, when a search term is “transmission”, Section F allows the search method to boost the relevancy for the term with respect to Document N100 for that term because the term is used as an element name in the document. This fact that the search term is an element may indicate enhanced relevancy because it is discussed in particularity for that particular document. Additionally, the information may be used enhance the results display because the mapping to a drawing figure allows for the most relevant drawing figure to be displayed in the result. An enhanced document display (e.g., when drilling down into the document from a results display) allows for linking of the search term with the document sections. This allows for the display to adapt to the user request, for example clicking on the term in the document display may show the user the relevant drawing or claim (e.g., from Sections A, C).

Another generated metadata section, Section G, may include metadata for the claims section of Document N100. Each claim term may be included for more particularized searching and with linking information to the figures in Section A. For example, where claim 1 includes the word “transmission”, it may be included in Section G as a claim term, and further linked to the specification sections in Section B that use the term, as well as the figures in Section A that relate to “transmission” (linking provided by the detailed description or by element numbers inserted into the claims).

Another generated metadata section, Section H, may include Document Type Classification information for Document N100. In this example, the Document Type may be determined to be a patent document. This may be embodied as a code to straight text to indicate the document type.

Another generated metadata section, Section I, may include Document Content Classification information for Document N100. In this example, the document class may be determined as being the “transmission” arts, and may be assigned a class/subclass (as determined b the United States Patent and Trademark Office). Moreover, each section of Document N100 may be classified as to content. For example, Section C includes patent claims that may be classified. In another example, the detailed description Section B may be classified. In another example, each drawing page and/or drawing figure may be classified in Section A. Such classification may be considered document sub-classification, which allows for more particularized indexing and searching.

It is also contemplated that the metadata may be stored as a file separate from Document N100, added to Document N100, or maintained in a disparate manner or in a database that relates the information to Document N100. Moreover, each section may include subsections. For example, Section A may include subsections for each drawing page or drawing figure, each having metadata section(s). In another example, Section C may include subsections, each subsection having metadata sections, for example, linking dependent claims to independent claims, claim terms or words with each claim, and each claim term to the figures and detailed description sections. Classification by document section and subsection allows for increased search relevancy.

When using the metadata for Document N100, an indexing method or search method may provide for enhanced relevancy determination. For example, where each drawing figure is classified (e.g., by using element names gleaned from the specification by element number) a search may allow for a single-figure relevancy determination rather than entire document relevancy determination. Using a search method providing for particularized searching, the relevancy of a document including all of the search terms in a single drawing may be more relevant than a document containing all of the search terms sporadically placed throughout the document (e.g., one search term in the background, one search term in the detailed description, and one search term in the claims).

In another example, FIG. 36 shows an analysis of Document N100 to determine the highly relevant text that may be used in indexing and searching. Metadata Section J may include, after document analysis, terms from Document N100 that are deemed highly relevant by the Document Type Rule. For example, in a patent document, Section J includes terms that are used elements in the drawings (e.g., from Section A), elements used in the specification (e.g., numbered elements or noun phrases), and elements used in the claims Section C. In this way, data storage for the index is reduced and simplified search methods may be employed. In another example, only linked terms may be included, for example terms that are linked through Links L1, L2, L3, L4 are included in Section J as being more relevant than the general document text.

Depending on the universe of documents to be searched, the analysis of the document may be performed at index time (e.g. prior to search) or at the search time (e.g., real-time or near real-time, based on the initially relevant documents).

In another example, FIG. 37 includes a general web page that may be sectionalized and analyzed by a general web page rule. The title for a section of the page may be determined as Title T1, and the next title T2 is identified. The image(s) and text between Title A and Title B may be assigned to a document section under Title A. The image(s) and text between below Title B may be assigned to a document section under Title B. Moreover, the text of the section may be identified as being associated to an image. In this example, Text Sections B and C are associated with Image A, and Text Sections D and E are associated with Image B. Metadata may then be associated with Document N200 to allow for indexing and searching of the image based on the associated text. Additional analysis may be provided by a Link to Image B (in Text Section E) that further provides information about Image B. For example, the text in the same sentence or surrounding Link to Image B may be further particularized as relevant to Image B, including the shown text of the link or metadata associated with the link in the source (e.g., in HTML or XML source).

When analyzing a web page, the sectionalization may include sectioning the web-site's index or links to other pages, as well as sectioning advertisement space. The “main frame” may be used as a section, and may be further sub-sectioned for analysis. By providing that the web-site's index or links are sectioned separately, a search for terms will have higher relevancy based on their presence in the main frame, rather than having search terms appearing in the index. Moreover, the advertisement area may not be indexed or searched because any keywords may be unrelated to the page.

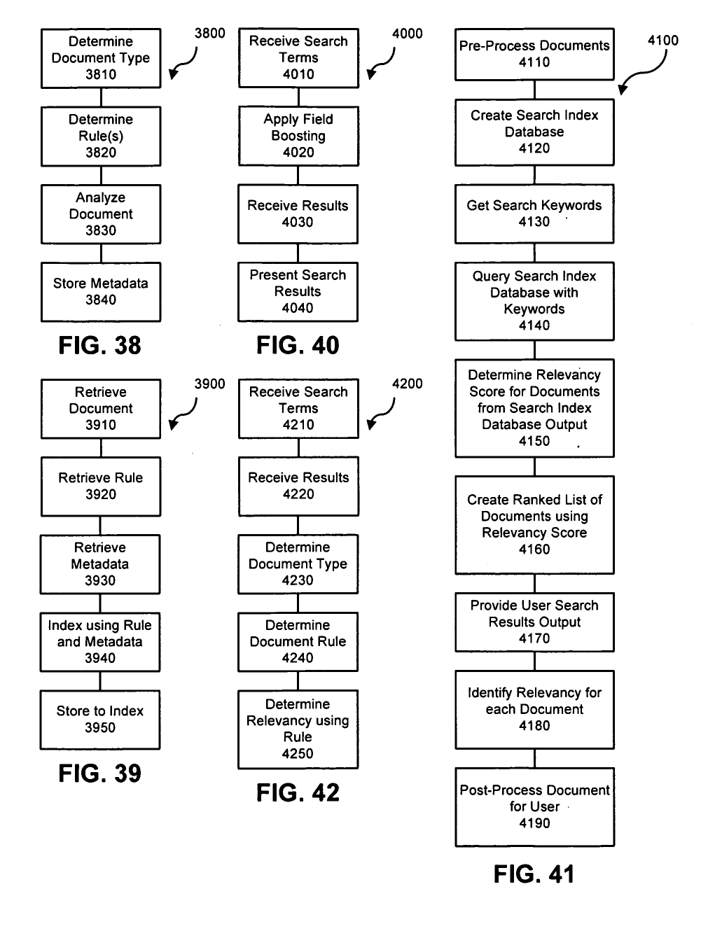

FIG. 38 is an example of a document analysis method. In general, a document may be analyzed by determining the document type, retrieving a rule to analyze the document, and storing information about the document to assist in indexing and/or searching.

In step 3810, the document may be retrieved and the document type ascertained. The document type may be determined from the document itself (e.g., by analyzing the document) or by metadata associated with the document. The document itself need not be retrieved to determine the document's type if there is data available describing the document, such as information stored on a server or database related to the document.

In step 3820, the rule may be determined for the document under analysis. The determination may be performed automatically or manually. Automatic rule determination may be done using a document classifier that outputs the document type. The rule can then be looked up from a data store. An example of a rule for a patent document includes determining the document sections (bibliographic data, background, brief description of drawings, detailed description, claims, and drawings). Such a rule may look for certain text phrases that indicate where the sections begin, or determining from a data source, where the sections are located. Analysis of the drawing pages and figures is requested, determination of the specification elements and claim elements, and linking information is requested between sections. An example of a rule for an SEC document includes determining what type of SEC document it is, for example a 10-K or an 8-K. In an example, a 10-K may be analyzed. The rule may provide for identification of a table of contents, certain parts, and certain items, each of which may be used for analysis. Further, there may be rules for analyzing revenue, costs, assets, liabilities, and equity. Rules may also provide for analyzing tables of financial information (such as relating numbers with columns and rows) and how to indicate what the data means. For example, a number in a financial table surrounded by parentheses “( )” indicates a loss or negative numerical value. An example of a rule for a book includes determining the book chapters.

In step 3830, the document is analyzed using the rules. For example, the document is sectionalized based on the rule information. A patent document may be sectionalized by background, summary, brief description of drawings, detailed description, claims, abstract, and images/figures.

In step 3840, metadata related to the document may be stored. The metadata may be stored with the document or may be stored separate from the document. The metadata includes, at least in part, information determined from the rule based analysis of step 3830. The metadata may further be stored in document sections provided for by the rule applying to the document. In an example, a patent document may include a document section that includes the element names from the detailed description. Each of the element names determined from the document analysis in 3830 may be stored in the section specified by the rule. Such a new section allows the indexer and/or searcher to apply weighting factors to the section's words that may assist in providing more relevant documents in a search.

FIG. 39 is an example of a document indexing method. In step 3910, the document may be retrieved and the document type ascertained. The document type may be determined from the document itself (e.g., by analyzing the document) or by metadata associated with the document. The document itself need not be retrieved to determine the document's type if there is data available describing the document, such as information stored on a server or database related to the document.

In step 3920, the rule may be determined and the rule retrieved for the document under analysis. The determination may be performed automatically or manually. Automatic rule determination may be done using a document classifier that outputs the document type. The rule can then be looked up from a data store. An example of a rule for a patent document includes determining the document sections (bibliographic data, background, brief description of drawings, detailed description, claims, and drawings). Such a rule may look for certain text phrases that indicate where the sections begin, or determining from a data source, where the sections are located. Analysis of the drawing pages and figures is requested, determination of the specification elements and claim elements, and linking information is requested between sections. An example of a rule for an SEC document includes determining what type of SEC document it is, for example a 10-K or an 8-K. In an example, a 10-K may be analyzed. The rule may provide for identification of a table of contents, certain parts, and certain items, each of which may be used for analysis. Further, there may be rules for analyzing revenue, costs, assets, liabilities, and equity. Rules may also provide for analyzing tables of financial information (such as relating numbers with columns and rows) and how to indicate what the data means. For example, a number in a financial table surrounded by parentheses “( )” indicates a loss or negative numerical value. An example of a rule for a book includes determining the book chapters.

In step 3930, the document's metadata may be retrieved. The metadata may be in the document itself or it may be contained, for example, on a server or database. The metadata may include information about the document, including the document's sections, special characteristics, etc. that may be used in indexing and/or searching. For example, a patent document's metadata may describe the sectionalization of the document (e.g., background, summary, brief description of drawings, detailed description, claims, abstract, and images/figures). The metadata may also include, for example, the information about generated sections, for example that include the numbered elements from the specification and/or drawing figures.

In step 3940, the document and metadata may be indexed (e.g., for later use with a search method). The flat document text may be indexed. In another example, the metadata may be indexed. In another example, the sectional information may be indexed, and the text and/or images located therein, to provide for enhanced relevancy determinations. For example, the specification sections may be indexed separately to fields so that field boosting may be applied for a tuned search. Moreover, the information about the numbered elements from the specification, drawings, and/or claims may be indexed in particular fields/sections so that boosting may be applied for enhanced relevancy determinations in a search.

In step 3950, the information is stored to an index for later use with a search method.

FIG. 40 is an example of a document search method 4000.

In step 4010, search terms are received. The search terms may be input by a user or generated by a system. Moreover, as discussed herein, the search may be tuned for a particular purpose (e.g., a novelty search or an infringement search).

In step 4020, field boosting may be applied for searching (see also FIG. 43). The field boosting may be applied to document sections to provide enhanced relevancy feedback of the documents searched.

In step 4030, results are received for the search. The results may be ranked by relevancy prior presentation to a user or to another system. In another example, the results may be processed after the search to further determine relevancy. Document types may be determined and rules applied to determine relevancy.

In step 4040, results are presented to the user or another system.

FIG. 41 is a method 4100 for indexing, searching, presenting results, and post processing documents in a search and review system (e.g., such as a search engine allowing the user to peruse the results to determine which result is interesting).

In step 4110, documents are pre-processed. A determination as to the document type and the rule to be applied to the pre-processing may be determined. The rules may then be applied to the document to provide sectionalization, generation of metadata, and addition of specialized sections/fields for indexing and/or searching.

In step 4120, the document may be indexed. The document sections may be indexed, as well as the metadata determined in pre-processing methods.

In step 4130, search terms may be received.

In step 4140, the index of step 4120 may be queried using the search terms and search results may be output.

In step 4150, the relevancy score for the search results may be determined. The relevancy may be determined based on field boosting, or analysis of the result document, based on rules. For example, the search terms found in drawings, or different sections may be used to increase or decrease relevancy.

In step 4160, the results may be ranked by relevancy.

In step 4170, the results may be presented to the user based on the ranked list of step 4160.

In step 4180, the relevant portions of the documents may be presented to the user. For example, the relevant portions may include the most relevant image/drawing, or the most relevant claim, based on the search terms.

In step 4190, the document may be post processed to provide the user with an enhanced document for further review. The enhanced document may include, for example, highlighting of the search terms in the document, and linking of terms with figures and/or claims. In another example, the linking of different sections of the document may provide the enhanced document with interactive navigation methods. These methods may provide for clicking on a claim term to take the document focus to the most relevant drawing with respect to a claim. In another example, the user may click on a claim term in the specification to take the document focus to the most relevant claim with respect to that term or the most relevant drawing.

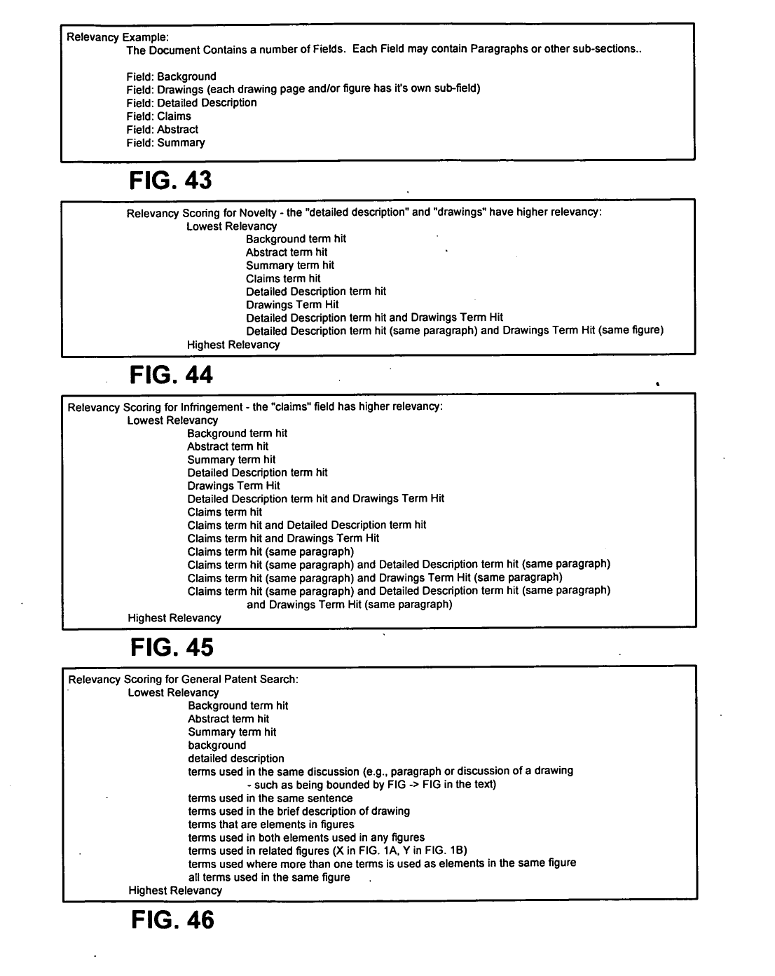

FIG. 42 is a method 4200 of searching a document based on document type.

In step 4210, search terms are received. The search terms may be provided by a user or other process (e.g., as discussed herein a portion of a document may be used to provide search terms).

In step 4220, a search may be run and results received. The search may be performed and a plurality of document types may be received as results. For example, patent documents, web pages, or other documents may be received as results.

In step 4230, the type of document in the results may be determined (see FIG. 33). The type of document may be included as metadata to the document or the document type may be determined by a document type analyzer (e.g., for a patent document, the presence of certain document sections (e.g., claims, detailed description, background, and drawings) indicates that it is a patent document).

In step 4240, the appropriate document rule is retrieved for each document (see FIG. 33). The document rules may be saves with the document itself, or the document rule may be retrieved, for example, from a database or server.

In step 4250, the relevancy of the results documents are determined using the rule appropriate for each document type. For example, patent document relevancy may be determined using the patent document rule, SEC documents may have SEC document rules applied, and general web pages may have general web page rules applied. For example, a patent document rule may include determining relevancy based on the presence of the search terms in a figure, the claims, being used as elements in the detailed description, etc.

Search. In general, document searching provides for a user input (e.g., keywords) that is used to determine relevancy for a set of documents. The documents are then provided as a ranked list of document references. In determining relevancy, many document properties may be analyzed to determine relevancy. In an example, keywords are provided as a user input to a set of documents for search. Relevancy score may then be determined based on the presence of the keyword, or analogous words.

Relevancy Score. Relevancy may be determined by a number of factors that include the keywords, keyword synonyms, context based synonyms, location of keywords in a document, frequency of keywords, and their location relative to each other.

In an example, a keyword search is performed on a set of documents that include, for example, patents and published patent applications. The relevancy of each document in the set may be determined by a combination of factors related to the location(s) of the keywords within each document, and the relative location of the keywords to each other within the document.

In general, the methods described herein may be used with an indexing and search system. A crawler may be used to navigate a network, internet, local or distributed file repository to locate and index files. A document classifier may be used prior to indexing or after searching to provide document structure information in an attempt to improve the relevancy of the search results. The document classifier may classify each document individually or groups of documents if their general nature is known (e.g., documents from the patent office may be deemed patent documents or documents from the SEC EDGAR repository may be deemed SEC documents). The determination of rules for analysis of the documents may be applied at any stage in the document indexing or searching process. The rules may be embedded within the document or stored elsewhere, e.g. in a database. The documents may be analyzed and indexed or searched using the rules provided. The rules may also provide information to analyze the document to create metadata or a meta-document that includes new information about the document including, but not limited to, sectionalization information, relationships of terms within the document and document sections, etc. An index may use the results of the analysis or the metadata to identify interesting portions of the document for later search. Alternatively, the search method may use metadata that is stored or may provide for real-time or near real-time analysis of the document to improve relevancy of the results.

FIGS. 43-45 are examples of determining relevancy for patent documents using term searching. FIG. 43 shows the fields used for search, where each field may be searched and weighted individually to determine relevancy. In general, the patent document may be portioned into different fields (e.g., see the determination and definition of sections for documents explained in detail above with respect to FIG. 35, among others). The fields may then be used to apply various weighting that will determine relevancy.

FIG. 44 is a relevancy ranking method where each field may have boosting applied to make the field more relevant than others. When performing a patent “novelty” search, the detailed description section and drawings sections have higher relevancy than, for example, the background section. It will be understood, however, that the example provided herein is not limited to such relevancy and this is merely one example. Thus, by applying field boosting to the detailed description section and the drawings section, the relevancy determination is aligned to the type of search. The lowest relevancy may be a search term hit in the background section. Alternatively, the highest relevancy may be a term hit in the detailed description and drawings section. Moreover, where the term hits are in the same figure, the inference is that they are described within the same apparatus feature rather than in different regions of the document, making the hit more relevant. In kind, where the term hits are in the same paragraph of the detailed description, the general inference is that they are described within the same specific discussion, rather than being described in disparate sections of the document. As shown, a number of other fields are shown as being ranked as more or less relevant. The example shown in FIG. 44 is an example of field boosting for a novelty search, and the user may desire to modify the field boosting for tuning relevancy to their particular application.

FIG. 45 is a relevancy ranking method for a patent “infringement” search. In this example, the claims section has a higher relevancy than the background. As an example, the highest relevancy is applied to search term hits that are in the claims section, and the detailed description section, and the drawings section.

FIG. 46 is a general relevancy ranking method for patent documents. As shown the least relevancy is provided by term hits in the background section of the document. The highest relevancy is provided by all of the search terms used in the same drawing figure. In an example, the user may search for terms X, Y, Z in patent documents. Relevancy may be based on keywords being in the same figures and in the same text discussion (e.g., same section, same paragraph). An example of a ranking of search results is provided. Rank 0 (best) may be when X, Y, Z are used in the same figure of a document. Rank 1 may be when X, Y, are used in same figure of a document, and Z is used in different figures of the document. Rank 2 may be when X, Y, Z are used in different figures of the document. Rank 3 may be when X, Y, Z are found in the text detailed description (but not used as elements in the figures). Rank 4 may be when X, Y, Z are found in the general text (e.g., anywhere in the text) of the document, but not used as elements in the figures. Rank 5 (worst) may be when X, Y are discussed in the text, and Z is found in the background section (but not used as elements in the figures). In this way, a generalized search of patent documents can be performed with high accuracy on the relevancy of the documents.

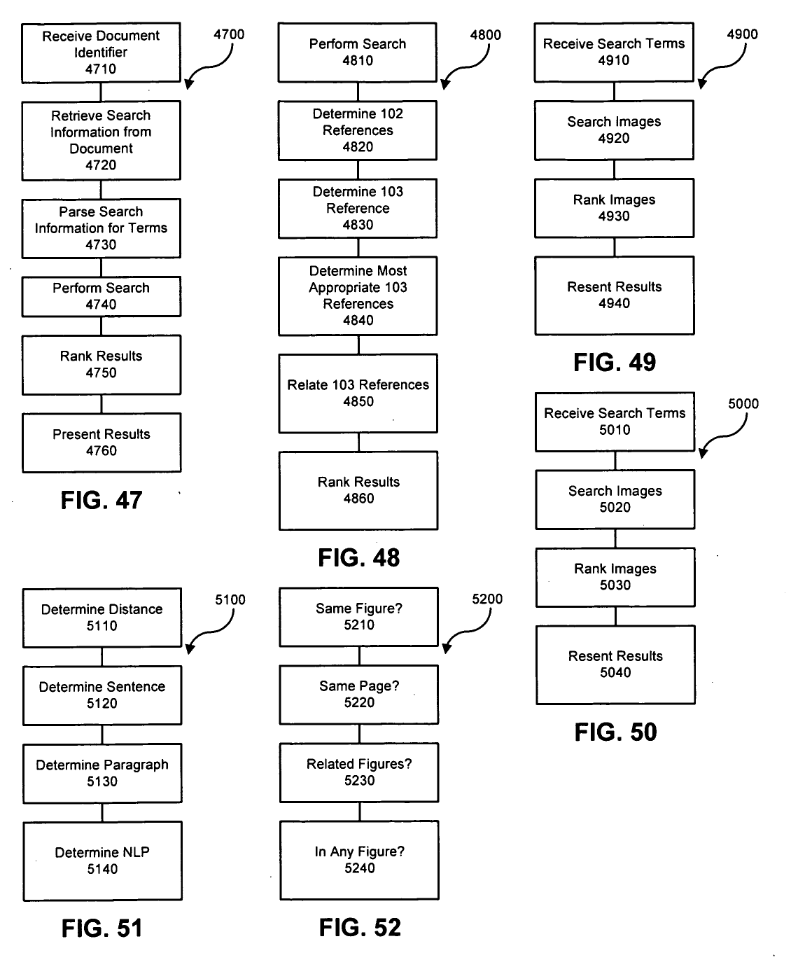

FIG. 47 is a method 4700 of performing a search based on a document identifier. For example, where a user wishes to invalidate a patent, they may identify the patent and the search method may use the claims of the patent as the search term source.

In step 4710, a document identifier is received. The document identifier may be, for example, a patent number. The document identifier may also include more information, such as a particular claim of the patent, or a drawing figure number. When used for an invalidity search, the existing patent or patent application may be used as the source of information for the search.

In step 4720, the claims of the patent identified in step 4710 are received. The claims may be separated by claim number, or the entire section may be received for use.

In step 4730, the claim text may be parsed to determine the relevant key words for use in a term search. For example, the NLP method (described herein) may be used to determine the noun phrases of the claim to extract claim elements. Moreover, the verbs may be used to determine additional claim terms. Alternatively, the claim terms may be used as-is without modification or culling of less important words. In another example, the claim preamble may not be used as search terms. In another example, the preamble may be used as search terms. Alternatively, the claim preamble may be used as search terms, but may be given a lower relevancy than the claim terms. Such a system allows for enhanced relevancy of the document that also includes the preamble terms as being more relevant than a document searched that does not include the preamble terms. In another example, the disclosure of the application may be used as search terms, and may be provided less term-weighting, to allow for a higher ranking of searched documents that include similar terms as the disclosure.

In step 4740, the search may be performed using the search terms as defined or extracted by step 4730. In an example, simple text searching may be used. In another example, the enhanced search method using field boosting may be applied (see FIG. 44), when performing a novelty/invalidity search.

In step 4750, the search results are output to the user. Where a result includes all terms searched, the method may indicate that the reference includes all terms. For example, when performing a novelty/invalidity search, such a document may be indicated as a “35 U.S.C. § 102” reference (discussed herein as a “102” reference). Alternatively, using the methods discussed herein, it is also possible to determine if all of the search terms are located within the same drawing page or the same figure. Such a search result may then be indicated as a strong “102” reference. In another example, where all of the search terms are located in a result in the same paragraph or discussion in the detailed description, such a result would also be considered a “102” reference.

The method 4700 may be iterated for each claim of the patent identified by patent number to provide search results (e.g., references) that closely matches the claims in patent identified for invalidation.

FIG. 48 is a method of creating combinations of search results related to search terms, where method 4800 replaces the steps 4740 and 4750 of FIG. 47. In general, the “102” references may be found, as well as potential “35 U.S.C. § 103” references (discussed herein as a “103” reference). The method then allows for determining and ranking the best references, even if all search terms were not found in a single reference.

In step 4810, the search is performed using search terms and results are provided.

In step 4820, the results are reviewed to determine the most relevant reference, for example, the “102” references, may be ranked higher than others.

In step 4830, the results are reviewed to determine which results do not contain all of the search terms. These references are then deemed to be potential “103” references.

In step 4840, the most appropriate “103” references are reviewed from the search results to determine their relevancy ranking. For example, “103” references that contain more of the search terms are considered more relevant than results with fewer search terms.

In step 4850, the “103” references are related to each other. The results are paired up to create a combination result. This provides that a combination of references contain all of the search terms. For example, where the search terms are “A B C D”, references are matched that, in combination, contain all of the source terms (or as many search terms as possible). For example, where result 1 contains A and B, and result 2 contains C and D, they may be related to each other (e.g., matched) as a combined result that includes each of the search terms. In another example, where result 3 contains A and C and D, the relation of result 1 and result 3 has higher relevancy than the combination of result 1 and result 2, due to more overlap between search terms. In general, the more overlap between the references, the improved relevancy of the combination. Moreover, a secondary method may be performed on the references to determine general overlap of the specifications to allow for combinations of references that are in the same art field. This may include determining the overlap of keywords, or the overlap of class/subclass (e.g., with respect to a patent document).

In step 4860, the results are ranked. In an example, the “102” references are determined to be more relevant than the “103” references and are then ranked with higher relevancy. The “103” reference combinations are then ranked by strength. For example, the “103” reference with all search terms appearing in the drawings may be ranked higher than “103” references with search terms appearing in the background section.

In general, method 4800 may be used to provide results that are a combination of the original search results. This may be used where a single result does not provide for all of the search terms being present. As explained herein, the method 4800 may be used for patent document searching. However, other searches may use similar methods to provide the necessary information. In an example, when researching a scientific goal, the goals terms may be input and a combination of results may provide the user with an appropriate combination to achieve the goal. In another example, when researching a topic, a search may be performed on two or more information goals. A single result may not include all information goals. However, a combination of results may provide as many information goals as possible.

Alternatively, a report can be built for “102” references. The location of the “102” citations may be provided by column/line number and figure number, as may be helpful when performing a novelty search. A “103” reference list and arguments may be constructed by listing the “103” references, the higher relevancy determined by the higher number of matching search terms. E.g., build arguments for reference A having as elements X, Y and reference B having elements Y, Z. When performing “103” reference searches, the output may be provided as a tree view. The user may then “rebalance” the tree or list based on the best reference found. For example, if the user believes that the third reference in the relevancy list is the “best starting point”, the user may click the reference for rebalancing. The method may then re-build the tree or list using the user defined reference as the primary reference and will find art more relevant to that field to build the “103” reference arguments that the primary reference does not include.

In determining the “103” reference arguments, NLP may be used to determine motivation to combine the references. Correlation of search terms, or other terms found in the primary and secondary references may be used to provide a motivation to combine them. For example, use of word (or idea) X in reference A and then use of word (or idea) X in reference B shows that there is a common technology, and a motivation to combine or an obvious to combine argument. Such an argumentation determination system may be used to not only locate the references, but rank them as a relevant combination. In another example, argument determination may be used in relation to a common keyword or term and the word X may be near the keyword in the references, providing an inference of relevance.

As an alternative to a ranked list of references, a report may be generated of the best references found. In an example, a novelty search may produce a novelty report as a result. The report may include a listing of references, including a listing of what terms were not found in each references, allowing the user to find “103” art based on those missing terms. Where the search terms are found in the reference, the most relevant figure to each term may be produced in the report to provide the user a simplified reading of the document. Moreover, the figures may have the element names labeled thereupon for easier reading. In an example, where three “102” references are found, the report may list the figures with labeled elements for first reference, the move on to the next references.

In an interactive report, the user may click on the keywords to move from figure to figure or from the text portion to the most from figure relating to that text. The user may also hit “next” buttons to scroll through the document to the portions that are relevant to the search terms, including the text and figures. Report generation may also include the most relevant drawing for each reference, elements labeled, search terms bolded, and a notation for each. E.g., a notation may include the sentences introducing the search term and/or the abstract for the reference. This may be used as a starting point for creating a client novelty report. For each relevant portion of the document, there may be citations in the report to the text location, figure, element, and column/line or paragraph (for pre-grant publication). The user may then copy these citations for a novelty report or opinion. Such notations may also be useful, for example, to patent examiners when performing a novelty search

FIG. 49 is a method of identifying the most relevant image related to search terms.

In step 4910, search terms are received.

In step 4920, a search is performed on images using the search terms. The search may include a general search of a plurality of documents. When searching a plurality of documents, the search terms may be applied to different fields/sections of the document, including fields/sections that provide information about the image. For example, when searching patent documents, the Section E of FIG. 35 may include information about the patent figures, including the related element names, that are searched using the search terms. Alternatively, the search may include a plurality of images of a single document. In a single patent document, the most relevant drawing or figure may be searched for.

In step 4930, the images are ranked. For example, in a patent document, the figure that includes the most search terms becomes most relevant. Additionally, information from the text related to the image (if such text exists) may be searched to provide additional relevancy information for ranking the images. For example, where the text of the document(s) includes a discussion linked to the image, the search terms may be applied to the discussion to determine whether the image is relevant, and/or whether the image is more relevant than other images in the search realm.

In step 4940, the image(s) are presented in a results output. When searching a plurality of documents for images, or images alone, the images may be presented to the user in a graphical list or array. When searching in a single document, the image may be presented as the most relevant image related to that document. In an example, when performing a patent search the results may be provided in a list format. Rather than providing a “front page” image, the results display may provide an image of the most relevant figure related to the search to assist the user in understanding each result.

Additionally, steps may be performed (as described herein) to generally identify the most relevant drawings to search term(s) (e.g. used for prior art search). The keywords/elements within the text may be correlated as being close to each other or relevant to each other by their position in the document and/or document sections. The text elements within the figures may also be related to the text elements within the text portion of the document (e.g., relating the element name from the specification to the element number in the drawings). The figures may then be ranked by relevancy to the search terms, the best matching figures/images being presented to the user before the less relevant figures/images. Such relevancy determinations may include matching the text associated with the figure to the search terms or keywords.

FIG. 50 is a method of relating images to certain portions of a text document. For example, when performing an invalidity analysis on a patent, a report may include a claim chart for each claim element. For each claim element, the figure of the invalidating reference (and/or the patent to be invalidated) may be determined and placed in the chart for user reference. In this way, an example of the method may identify the most relevant drawings per prior art claim (used for non-infringement search or an invalidity search).

In step 5010, a claim may be analyzed to determine the claim element to be used as the search term. When determined, the claim term is received as the search term, as well as the rest of the terms for the search.

In step 5020, the images of the invalidating reference are searched to provide the best match. The search term that relates to the particular claim element is given a higher relevancy boosting and the rest of the claim terms are not provided boosting (or less boosting). For example, where a portion of a claim includes “a transmission connected by a bearing”, and when searching for the term “bearing”, the search term “bearing” is provided higher boosting than “transmission”. By searching for both terms, however, the image that provides relevancy to both allows the user to view the searched term in relation to the other terms of the claim. This may be of higher user value than the term used alone in an image. Alternatively, the term “bearing” may be searched alone, and providing negative boosting to the other elements. Such a boosting method allows for providing an image that includes that term alone, which may provide more detail than a generalized image that includes all terms.

Where the invalidity analysis uses a single prior art reference, that single reference may be searched. Where the invalidity analysis uses multiple prior art references, the best matching reference to the search term may be used, or a plurality of references may be searched to determine the most relevant image.

In step 5030, the images are ranked. The images may be ranked using the boosting methods as discussed herein to determine which image is more relevant than others.

In step 5040, the results are presented to the user. If providing a list of references, the most relevant image may be presented. If providing a report on a claim for invalidation, each claim term may be separated and an image for each term provided which allows the user to more easily compare the claim to the prior art image.

FIG. 51 is a method of determining relevancy of documents (or sections of documents) based on the location of search terms within the text.

In step 5110, in general, the relevancy of a document or document section may be determined based on the distance between the search terms within the document. The distance may be determined by the linear distance within the document. Alternatively, the relevancy may be determined base on whether the search terms are included in the same document section or sub-section.

In step 5120, the relevancy may be determined by the keywords being in the same sentence. Sentence determination may be found by NLP, or other methods, as discussed herein.

In step 5130, the relevancy may be determined by the keywords being in the same paragraph.

In step 5140, the relevancy may be determined by using NLP methods that may provide for information about how the search terms are used in relation to each other. In one example, the search terms may be a modifier of the other (e.g., as an adjective to a noun).

FIG. 52 is a method of determining relevancy of images based on the location of search terms within the image and/or the document.

In step 5210, the relevancy may be determined by the search terms appearing on the same figure. Where in the same figure, the relationship of the search terms may be inferred from them being part of the same discussion or assembly.

In step 5220, the relevancy may be determined by the search terms appearing on the same page (e.g., the same drawing page of a patent document).

In step 5230, the relevancy may be determined by the search terms appearing on related figures. For example, where one search term is related to “FIG. 1A” and the second search term is related to “FIG. 1B”, an inference may be drawn that they are related because they are discussed in similar or related figures.

In step 5240, relevancy may be determined based on the search term being discussed with respect to any figure or image. For example, when the search term is used in a figure, an inference may be drawn that the term is more relevant in that document than the term appearing in another document but is not discussed in any figure. In this way, the search term/keyword discussed in any figure may show that the element is explicitly discussed in the disclosure, which leads to a determination that the search term is more important than a keyword that is only mentioned in passing in the disclosure of another document.

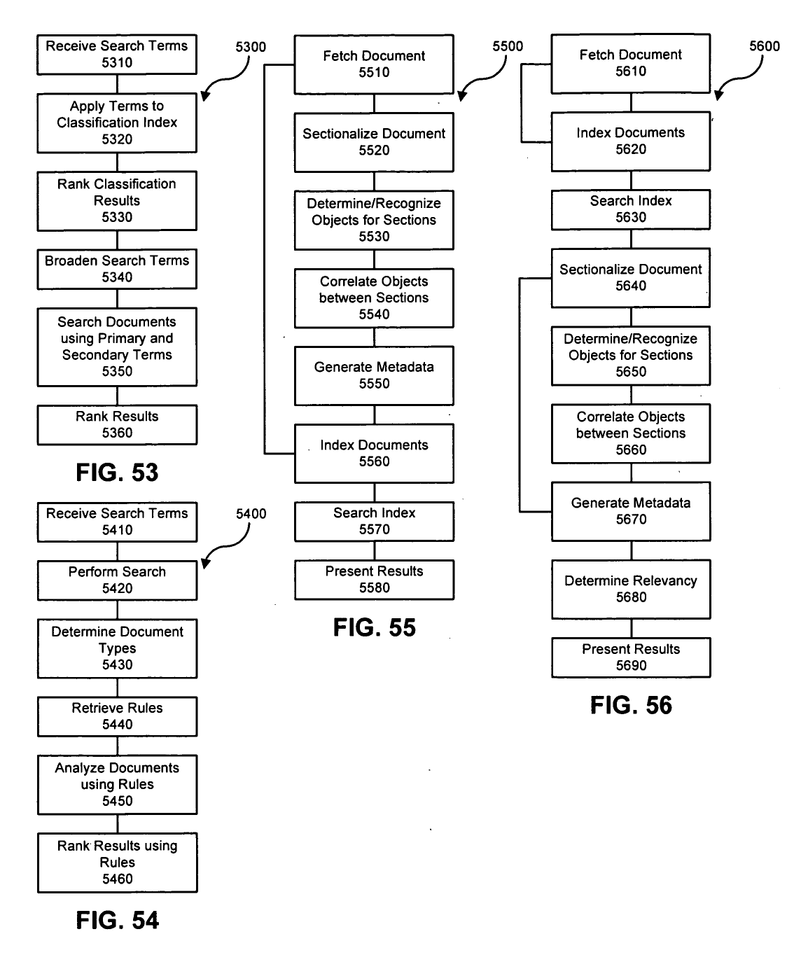

FIG. 53 is a search term broadening method 5300. In an example, the use of specific search terms (or keywords) may unnecessarily narrow the search results and/or provide results that miss what would otherwise be relevant documents in the results. To avoid undue narrowing of a keyword search, broadening of the terms may be applied to the search terms using thesauri. In another example, a context-based synonym for a keyword may be derived from a thesaurus, or a plurality of thesauri, selected using the search terms. The synonym(s) may then be applied to the each search term to broaden the search, at least to avoid undesired narrowing inherent in keyword searching. A plurality of thesauri may be generated from the indexed documents, based on the Document Group, Document Type, and Document Section.

In step 5310, search terms are received from a user or other process.

In step 5320, the search terms may be applied to a search index having classification information to determine the probable classes and/or subclasses that the search terms are relevant to.

In step 5330, the classification results are received and ranked. The particular classes and/or subclasses are determined by the relevancy of the search terms to the general art contained within the classes/subclasses.

In step 5340, a thesaurus for each class/subclass is applied to each search term to provide a list of broadened search terms. The original search terms may be indicated as such (e.g., primary terms), and the broadened search terms indicated as secondary terms.

In step 5350, the list of primary and secondary search terms are used to search the document index(es).

In step 5360, results are ranked according to primary and secondary terms. For example, the documents containing the primary terms are ranked above the documents containing the secondary terms. However, where documents contain some primary terms and some secondary terms, the results containing the most primary terms and secondary terms are ranked above documents containing primary terms but without secondary term. In this way, more documents likely to be relevant are produced in the results (and may be ranked more relevant) that otherwise would be excluded (or ranked lower) because the search terms were not present.

FIG. 54 is an example of a method 5400 of determining relevancy after search results are retrieved. Such a method may be used where storage of document sections and metadata may be excessively large to store in a pre-indexed fashion.

In step 5410, search terms are received.

In step 5420, a search is performed using the search terms of 5410.

In step 5430, the document types for each document provided as a result of the search are determined. The determination of document type may be based on the document itself or information related to the document. In another example, the document type may be determined at indexing and stored in the index or another database.

In step 5440, the rule associated with each document type is retrieved.

In step 5450, the search results documents are analyzed based on the rules associated with each document (e.g., by that document's type).

In step 5460, relevancy determination and ranking are determined based on the rules and analysis of the documents. As discussed herein the document may be analyzed for certain terms that may be more important than general words in the document (e.g., the numbered elements of a patent document may be of higher importance/relevancy than other words in the document), or the relevancy of the search terms appearing in certain document sections, including the drawings, may be used to determine the relevancy of the documents.

FIG. 55 is an example of a method 5500 for generally indexing and searching documents.

In step 5510, a document is fetched, for example using a crawler or robot.

In step 5520, a document is sectionalized. The document may be first typed and a rule retrieved or determined for how to sectionalize the document.

In step 5530, the objects for each section are determined and/or recognized.

In step 5540, the objects are correlated within sections and between sections within the document.

In step 5550, metadata may be generated for the document. The metadata may include information about the document itself, the objects determined in the document, and the linking within and between sections of the document.

In step 5560, the document is indexed. The indexing may include indexing the document and metadata, or the document alone. The metadata may be stored in a separate database for use when the index returns a search result for the determination of relevancy after or during the search. The method may repeat with step 5510 until all documents are indexed. Alternatively, the documents may be continuously indexed and the search method separated.

In step 5570, the index is searched to provide a ranked list of results by relevancy.

In step 5580, the results may be presented to the user or another process.

FIG. 56 is an alternative example, where indexing may be performed on the document text and document analysis and relevancy determination is performed after indexing.

In step 5610, a document is fetched, for example using a crawler or robot.

In step 5620, the document is indexed. The indexing may include indexing the document as a text document. The method may repeat with step 5610 until all documents are indexed. Alternatively, the documents may be continuously indexed and the search method separated.

In step 5630, the index is searched to provide a ranked list of results by relevancy.

In step 5640, a document is sectionalized. The document may be first typed and a rule retrieved or determined for how to sectionalize the document.

In step 5650, the objects for each section are determined and/or recognized.

In step 5660, the objects are correlated within sections and between sections within the document.

In step 5670, metadata may be generated for the document. The metadata may include information about the document itself, the objects determined in the document, and the linking within and between sections of the document. The process may then continue with the next document in the search result list at step 1340 until the documents are sufficiently searched (e.g., until the most relevant 1000 documents in the initial list—sorted by initial relevancy—are analyzed).

In step 5690, the relevancy of the documents may be determined using the rules and metadata generated through the document analysis.

In step 5680, the results may be presented to the user or another process.

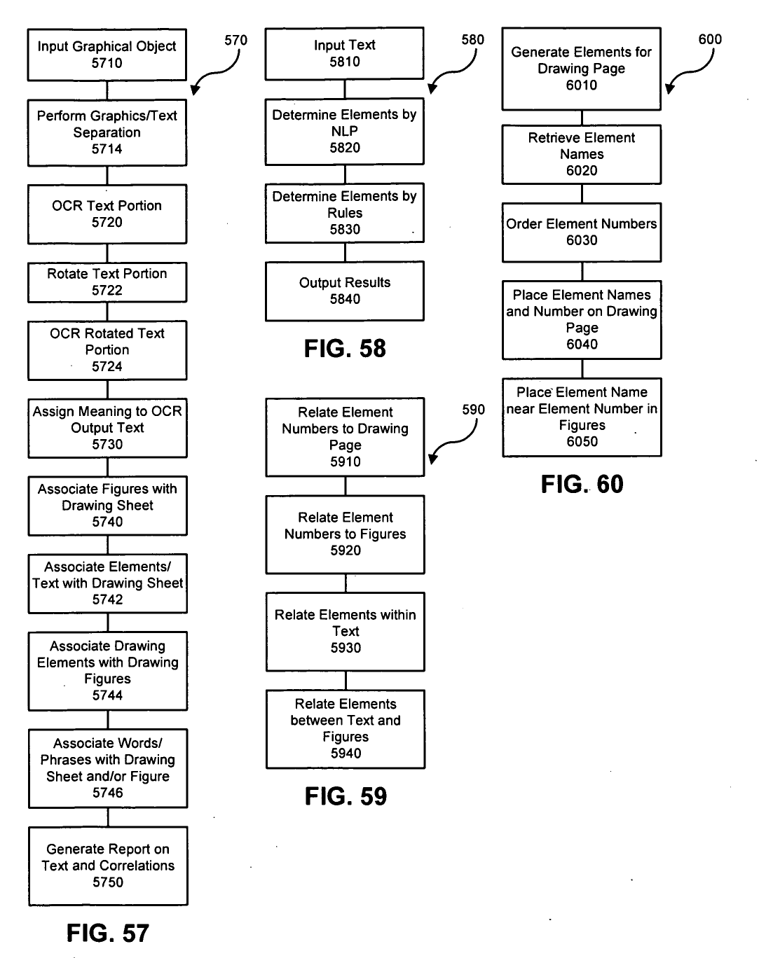

FIG. 57 is a method 570 for identifying text elements in graphical objects, which may include patent documents. For the analysis of documents, it may be helpful to identify numbers, words, and/or symbols (herein referred to as “element identifiers”) that are mixed with graphical elements and text portions of the document, sections, or related documents. However, existing search systems have difficulty with character recognition provided in mixed formats. One example of a method for identifying characters in mixed formats includes separating graphics and text portions and then applying OCR methods to the text portions. Moreover, in some circumstances, the text portion may be rotated to further assist the OCR algorithm when the text portion further includes horizontally, vertically, or angularly oriented text.

Method 570 is an example of identifying element numbers in the drawing portion of patent documents. Although this method described herein is primarily oriented to OCR methods for patent drawings, the teachings may also be applied to any number of documents having mixed formats. Other examples of mixed documents may include technical drawings (e.g., engineering CAD files), user manuals including figures, medical records (e.g., films), charts, graphics, graphs, timelines, etc. As an alternative to method 570, OCR algorithms may be robust and recognize the text portions of the mixed format documents, and the forgoing method may not be required in its entirety.

In step 5710, a mixed format graphical image or object is input. The graphical image may, for example, be in a TIFF format or other graphical format. In an example, a graphical image of a patent figure (e.g., FIG. 1) is input in a TIFF format that includes the graphical portion and includes the figure identifier (e.g., FIG. 1) as well as element numbers (e.g., 10, 20, 30) and lead-lines to the relevant portion of the figure that the element numbers identify.

In step 5714, graphics-text separation is performed on the mixed format graphical image. The output of the graphics-text separation includes a graphical portion, a text portion, and a miscellaneous portion, each being in a graphical format (e.g., TIFF).

In step 5720, OCR is performed on the text portion separated from step 5714. The OCR algorithm may now recognize the text and provide a plain-text output for further utilization. In some cases, special fonts may be recognized (e.g., such as some stylized fonts used for the word “FIGURE” or “FIG” that are non-standard). These non-standard fonts may be added to the OCR algorithms database of character recognition.

In step 5722, the text portion may be rotated 90 degrees to assist the OCR algorithm to determine the proper text contained therein. Such rotation is helpful when, for example, the orientation of the text is in landscape mode, or in some cases, figures may be shown on the same page as both portrait and landscape mode.

In step 5724, OCR is performed on the rotated text portion of step 5722. The rotation and OCR of steps 5722 and 5724 may be performed any number of times to a sufficient accuracy.

In step 5730, meaning may be assigned to the plain-text output from the OCR process. For example, at the top edge of a patent drawing sheet, the words “U.S. Patent”, the date, the sheet number (if more than one sheet exists), and the patent number appear. The existence of such information identifies the sheet as a patent drawing sheet. For a pre-grant publication, the words “Patent Application Publication”, the date, the sheet number (if more than one sheet exists), and the publication number appear. The existence of such information identifies the sheet as a patent pre-grant publication drawing sheet and which sheet (e.g., “Sheet 1 of 2” is identified as drawing sheet 1). Moreover, the words “FIG” or “FIGURE” may be recognized as identifying a figure on the drawings sheet. Additionally, the number following the words “FIG” or “FIGURE” is used to identify the particular figure (e.g., FIG. 1, FIGURE 1A, FIG. 1B, FIGURE C, relate to figures 1, 1A, 1B, C, respectively). Numbers, letters, symbols, or combinations thereof are identified as drawing elements (e.g., 10, 12, 30A, B, C1, D′, D″ are identified as drawing elements).

In step 5740, each of the figures may be identified with the particular drawing sheet. For example, where drawing sheet 1 of 2 contains figures 1 and 2, the figures 1 and 2 are associated with drawings sheet 1.

In step 5742, each of the drawing elements may be associated with the particular drawing sheet. For example, where drawings sheet 1 contains elements 10, 12, 20, and 22, each of elements 10, 12, 20, and 22 are associated with drawing sheet 1.

In step 5744, each of the drawing elements may be associated with each figure. Using a clustering or blobbing technique, each of the element numbers may be associated with the appropriate figure. See also FIG. 7A and FIG. 20.

In step 5746, complete words or phrases (if present) may be associated with the drawing sheet, and figure. For example, the words of a flow chart or electrical block diagram (e.g., “transmission line” or “multiplexer” or “step 10, identify elements”) may be associated with the sheet and figure.

In step 5750, a report may be generated that contains the plain text of each drawing sheet as well as certain correlations for sheet and figure, sheet and element number, figure and element number, and text and sheet, and text and figure. The report may be embodies as a data structure, file, or database entry, that correspond to the particular mixed format graphical image under analysis and may be used in further processes.

In an example, FIG. 35 explained above in detail, a formatted document is provided that includes identifying information, or metadata, for each text portion of a mixed-format graphical document. An example of such a formatted document may include an XML document, a PDF document that includes metadata, etc.

FIG. 58 is an example of a method 580 for extracting relevant elements and/or terms from a document. For example, a text document (e.g., a full-text patent document or an OCR of a text document) certain element identifiers may be determined and associated with words that indicate element names (e.g., “transmission 10” translates to element name “transmission” that is correlated with element identifier “10”). In other example, a text document may be generated from a text extraction method (e.g., as described in FIG. 57).

In step 5810, text is input for the determination of elements and/or terms. The input may be any input that may include a patent document, a web-page, or other documents.

In step 5820, elements are determined by Natural Language Processing (NLP). These elements may be identified from the general text of the document because they are noun phrases, for example. For example, an element of a patent document may be identified as a noun phrase, without the need for element number identification (as described below).

In step 5830, elements may be identified by their being an Element Number (e.g., an alpha/numeric) present after a word, or a noun phrase. For example, an element of a patent document may be identified as a word having an alpha/numeric immediately after the word (e.g., (“transmission 18”, “gear 19”, “pinion 20”).

FIG. 59 is a method 590 for relating text and/or terms within a document. In analyzing a document, it may be helpful to relate element identifiers, words, or other identifiers with different document portions. The document portions may include a title, text section, drawing sheet, figure, etc. The text section, in the context of a patent document, may include the title, background, summary, brief description of drawings, detailed description, claims, and abstract. For example, relation of elements may be between drawing pages and text portions, different text sections, drawing figures and text section, etc.

Using method 590, elements may be identified by numeric identifiers, such as text extracted from drawing figures as element numbers only (e.g., “18”, “19”, “20”) that may then be related to element names (“18” relates to “transmission”, “19” relates to “gear”, “20” relates to “pinion”).

In step 5910, element numbers are identified on a drawing page and related to that drawing page. For example, where a drawing page 1 includes FIGS. 1 and 2, and elements 10-50, element numbers 10-50 are related to drawing page 1. Additionally, the element names (determined from a mapping) may be associated with the drawing page. An output may be a mapping of element numbers to the figure page, or element numbers with element names mapped to the figure page. If text (other than element numbers) is present, the straight text may be associated to the drawing page.

In step 5920, element numbers are related to figures. For example, the figure number is determined by OCR or metadata. In an example, the element numbers close to the drawing figure are then associated with the drawing figure. Blobbing, as discussed herein, may be used to determine the element numbers by their x/y position and the position of the figure. Additionally, element lines (e.g., the lead lines) may be used to further associate or distinguish which element numbers relate to the figure. An output may be a mapping of element numbers and/or names to the figure number. If text (other than element numbers) is present, the straight text may be associated to the appropriate figure.

In step 5930, elements may be related within text. For example, in the detailed description, the elements that appear in the same paragraph may be mapped to each other. In another example, the elements used in the same sentence may be mapped to each other. In another example, the elements related to the same discussion (e.g., a section within the document) may be mapped to each other. In another example, the elements or words used in a claim may be mapped to each other. Additional mapping may include the mapping of the discussions of figures to the related text. For example, where a paragraph includes a reference to a figure number, that paragraph (and following paragraphs up to the next figure discussion) may be mapped to the figure number.

In another example, figures discussed together in the text may be related to each other. For example, where FIGS. 1-3 are discussed together in the text, the FIGS. 1-3 may be related to each other. In another example, elements may be related within the text portion itself. Where a document includes multiple sections, the text may be related therebetween. An example may be the mapping of claim terms to the abstract, summary and/or detailed description.

In step 5940, elements may be related between text and figures. For example, elements discussed in the text portions may be related to elements in the figures. In an example, where the text discussion includes elements “transmission 10” and “bearing 20”, FIG. 1 may be mapped to this discussion in that FIG. 1 includes elements “10” and “20”. Another example may include mapping claim terms to the specification and figures. For example, where a claim includes the claim term “transmission”, the mapping of “transmission” to element “10” allows the claim to figure mapping of figures that include element “10”. In another example, matching of text elements with drawing elements includes relating “18a, b, c” in text to “18a”, “18b” and “18c” the in drawings. Using these mappings discussed and/or the mappings of the figures and/or drawing pages, the elements may then be fully related to each other within the document. The mappings may then be used for analyzing the document, classifying, indexing, searching, and enhanced presentation of search results.

FIG. 60 is a method of listing element names and numbers on a drawing page of a patent. Such a listing may be helpful to the patent reader to quickly reference the element names when reviewing the drawing figures, and avoid lengthy lookup of the element name from the specification.

In step 6010, a list of element per drawing page is generated. The element numbers may be identified by the OCR of the drawings or metadata associated with the drawings or document.

In step 6020, element names are retrieved from the patent text analysis. The mapping of element name to element number (discussed herein) may be used to provide a list of element names for the drawing page.

In step 6030, drawing elements for a page are ordered by element number. The list of element numbers and element names are ordered by element number.

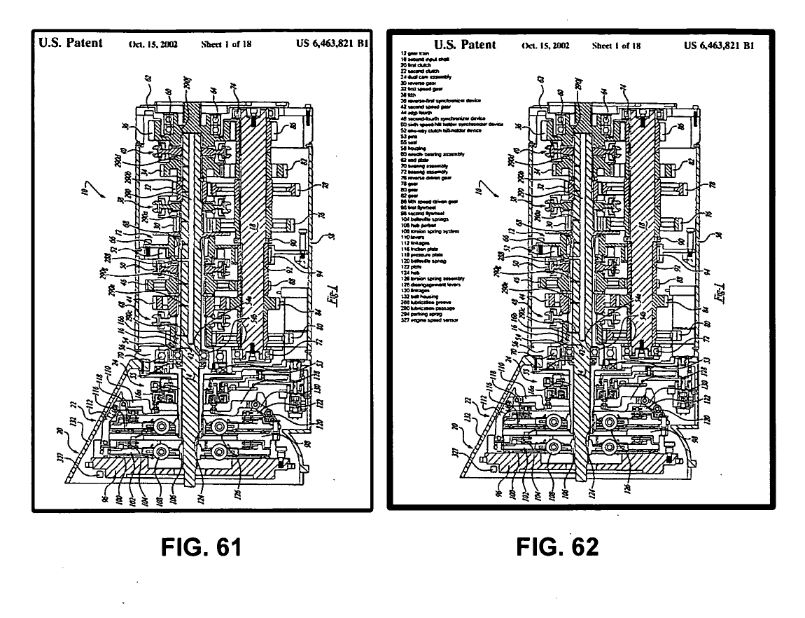

In step 6040, element numbers and element names are placed on the drawing page. The listing of element names/numbers for the drawing page may then be placed on the drawing page. In an example, areas of the drawing page having white space are used as the destination for the addition of element names/numbers to the drawing page. FIG. 61 is an example of a drawing page before markup, and FIG. 62 is an example of a drawing page after markup.

In step 6050, element names are placed next to element numbers in each figure on a drawing page. If desired, the element names may be located and placed next to the element number in or at the figure for easier lookup by the patent reader.

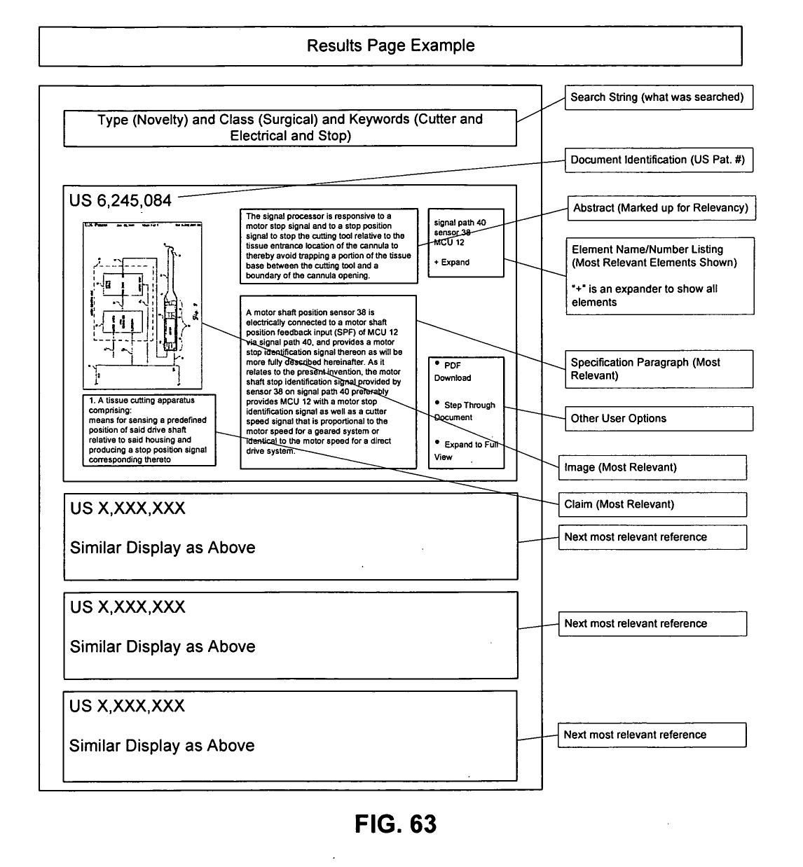

FIG. 63 is an example of a search results screen for review by a user. Each result may include the patent number, a drawing, a claim, an abstract, and detailed description section. The drawing may be selected as the most relevant drawing based on the search term (the most relevant drawing determination is described herein), rather than the front page image. The most relevant claim may also be displayed with respect to the search terms, rather than the first claim. The abstract may also be provided at the most relevant section. The specification section may also be provided that is the most relevant to the search terms. In each output, the search terms may be highlighted, including highlighting for the drawing elements (based on element name to element number mapping from the specification) to quickly allow the user to visualize the information from the drawing figure. Other information may also be provided allowing the user to expand the element numbers for the patent and navigate through the document.

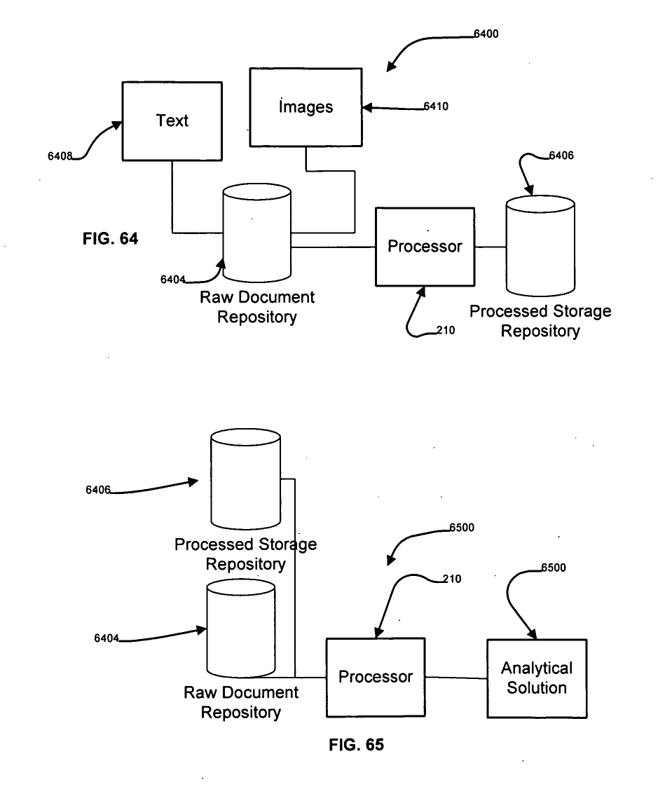

FIG. 64 is a system 6400 for processing documents. Processors 210 may be generally used to read, write and/or process information. In this example, processors 210 reads information from a raw document repository 6404 and may further process the information stored in raw document repository 6404 to produce a new organizational format for the same information or a new organizational format that contains additional information related to the documents. In an example processor 210 may read the raw documents make determinations, correlations, or other inferences about the documents in store that information in processed document repository 6406. Raw document repository 6404 may further include repositories of text 6408 and or repositories of images 6410. Moreover, processors 6402 may be connected over a network to multiple document repositories that may include, in any combination, Raw document repositories 6404, texts 6408, images 6410, and/or process storage 6406. The methods as discussed herein may be performed in whole or in part by system 6400. Moreover, system 6400 may also be combined with other systems as described herein to form a larger system that may be used for processing documents, searching documents, and or generating reports or information related to the documents.

FIG. 65 is a system 6500 for identifying embodiments. System 6500 may include a processor 210 that interfaces with raw document repository 6404, process storage repository 6406 and an analytical system 6502. Processor 210 may then access the information in repository 6404 and 6406 to provide information to analytical system 6502 to perform the embodiment analysis (as described herein). In general, analytical system 6502 may look into each document stored in repositories 6404 and 6406 to identify the embodiments contained therein. Moreover analytical system 6502 may also identify metadata associated with each embodiment including, but not exclusive to, a figure that describes an embodiments, the element names and numbers associated with that embodiment, sections from the text portion of the document the embodiments is associated with, different sections of the text portion of the document that are associated with the embodiment (e.g., a specific claim or claims, portions of the detailed description, these corresponding sentences in the brief description of the drawings, portions of the summary, abstract, or background). Moreover, if there is a relation of claim terms to the embodiments analytical system 6502 may also include the information about the PTO classification as describing the embodiment. Additional information such as the particular embodiment's relation to other figures, other text, and/or other embodiments may also be included as describing the particular embodiment so as to allow additional processing and/or additional inferencing that may occur in other processes, systems, or methods. Analytical system 6502, as one of skill in the art will understand, may include not only the system that provides for identification of embodiments, but may also include a combination of the different systems and methods described herein.

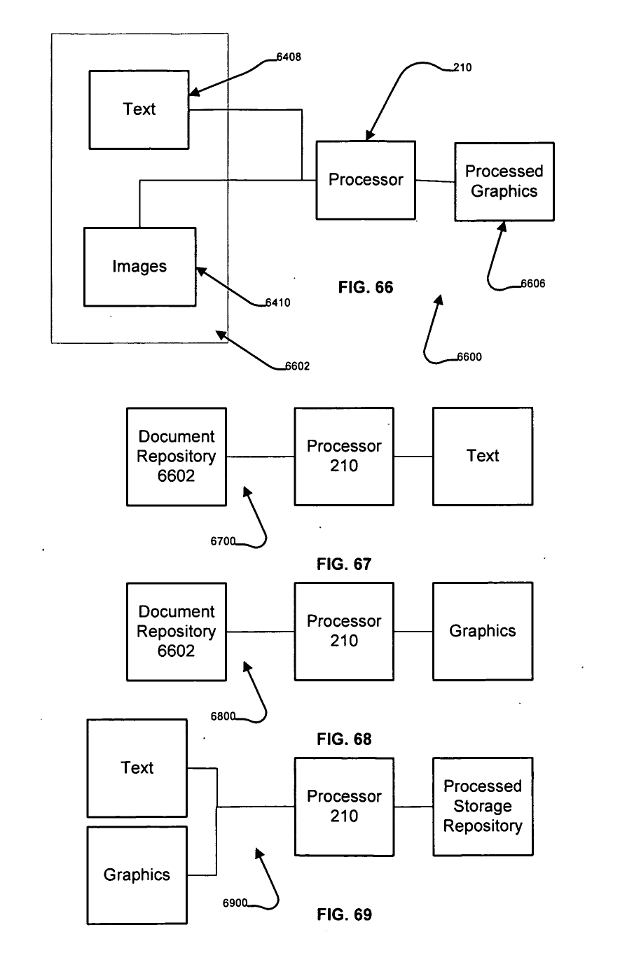

FIG. 66 is a system for processing documents. Processor 210 may take as inputs text repository 6408 and/or images repository 6410 (which may also be combined as document repositories 6602). Processor 210 may then apply any number or combination of the methods and systems described herein and then output processed text 6604 and were processed graphics 6606.

FIG. 67 is a system 6700 providing for processing of the text portions of a document. Processor 210 may receive as an input document repositories 6602, which may include text repository 6408 and/or images repository 6410, and apply processing methods and systems as described herein to obtain a process text repository 6604. System 6700 may be used for determining the information and/or metadata associated with the text portion of a document. In general, system 6700 may be utilized as a separate process from, for example a graphical analysis of the document, so that multiple documents may be more efficiently processed in batch. However, the text processing of a document may also include as an input graphical information or information derived from a graphical analysis to assist in the processing and/or to allow for determining information about the text portion.

FIG. 68 is a system 6800 providing for processing of the graphical portions of a document. Processor 210 may receive as an input document repositories 6602, which may include text repository 6408 and/or images repository 6410, and apply processing methods and systems as described herein to obtain processed graphics repository 6606. System 6800 may be used for determining the information and/or metadata associated with the graphical portion of a document. In general, system 6800 may be utilized as a separate process from, for example the text analysis of the document, so that multiple documents may be more efficiently processed in batch. However, the graphical processing of a document may also include as an input text information or information derived from a text analysis to assist in the processing and/or to allow for determining information about the graphic portion.

FIG. 69 is a system 6900 that combines text and graphics processing generally together. Processor 210 may take as an input text repository 6408 and graphics repository 6410 and apply systems and methods to process the document and store the information about the documents in processed repository 6406. In general, system 6900 may include a single processor 210 or multiple processors 210 that may be configured to allow parallel processing of the text and graphics portions and may also allow for initial processing of the text and graphics portions and then combining the information from these processes to further process the document. Moreover, processor 210 may also be used to process multiple documents simultaneously (e.g., using multi-threading, multitasking, virtualization, or other techniques for sharing the hardware and/or the storage/repository systems).

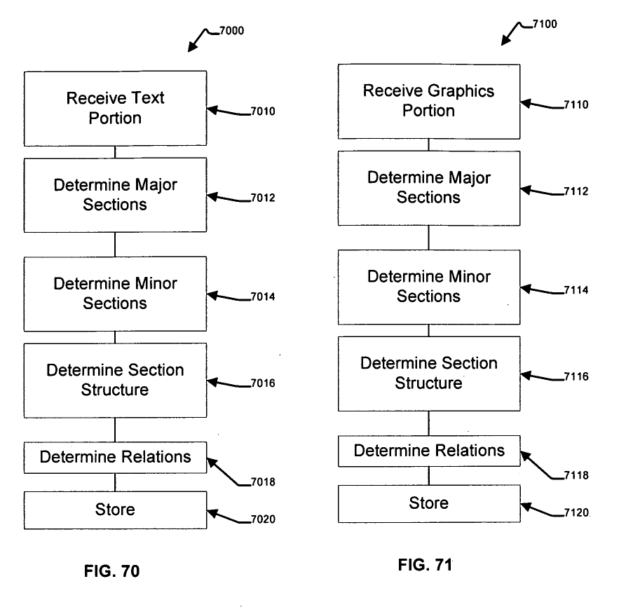

FIGS. 70-72 describe identification of embodiments within a document. The embodiments may be determined by analyzing the text portion of a document alone, the graphical portions of the document alone, metadata that may be associated with a document (that may describe the text, graphics, bibliographic data, etc.), or other information that describes the document.

FIG. 70 is a method 7000 for identifying an embodiment. In general method 7000 may be used to analyze a document to find one or many embodiments described therein. When using the text portion alone to analyze a document for embodiments, element names and numbers may be used to identify words or concepts that are of primary importance in the document by virtue of them being described in detail. Moreover, where element names have element numbers associated with them, the system and methods described herein may infer that they are also described in the graphical portion (e.g., the drawings). If relying solely on the text to identify embodiments, the relationship of the words to each other in sentences, and paragraphs, in some sections of the document, may be used to identify them as having importance relative to each other. Such a relationship allows the systems and methods to make a generalization that these words or element names are used together or in concert. Thus, in the simplest since these may be identified as an embodiment.

In more detail, embodiments may be found from the text by a higher-level approach. For example, when certain words are used in the same claim, they may be identified as an embodiment. By these words being present in the same claim then the inference may be that they are being used together or in concert. For example, if claim one were to include element A end element B than the elements A and B form an embodiments within the document. In another example if claim two (dependent from claim 1) includes elements C and D then a second embodiment in the document may include elements A., B, C and D. By virtue of the dependency of claim two to claim one, the elements discussed and claimed to also include the elements of claim one. In this way, embodiments may be identified in the claims simply by the words in the claims and by the nature of claim dependency. As one of ordinary skill in the art will appreciate, identifying embodiments from the claims may also be performed on multiple dependent claims. In addition, embodiments identified from the claims may also include embodiments that are specific to the claim preamble. Thus, a set of patent claims may yield multiple embodiments of various scopes beginning with the preamble (if meaningful information is contained therein), each independent claim, and each dependent claim.

In another example, using the text alone to identify embodiments, the abstract may be used to identify an embodiment where the embodiment is described simply by the words in the abstract. In another example, using the text alone to identify embodiments, the summary may be used to identify embodiments. The summary may include multiple paragraphs. Thus, each paragraph in the summary may be used to identify an embodiment where the embodiment is described by the words present in each paragraph.

In another example, using the text alone to identify embodiments, the brief description of the drawings may be used to identify embodiments. Each figure may be described in the brief description of the drawings in the words present to describe each figure may be used to identify an embodiments. In addition, the brief description of the drawings, may add additional information to the embodiments as metadata such as what type of embodiment is being described. If in the brief description of the drawings if a figure is described as a method, then the embodiment may include metadata that describes the embodiment as a method. Similarly, if the embodiment is described in the brief description of the drawings as a system, the embodiment may include metadata that describes the embodiment as a system.

In another example, using the text alone to identify embodiments, the detailed description may be used to identify embodiments. The detailed description may be broken down into sections such as sections that discuss different figures. This may be performed by identifying where figures are discussed in the detailed description. For example, where FIG. 1 is discussed in a paragraph than the words in that paragraph may be identified as an embodiment that relates to FIG. 1. Moreover, were the text continues in the detailed description that text may be associated with the embodiment that relates to FIG. 1 until another figure is discussed. This could be all of the text from the start of where FIG. 1 is introduced to the start of where FIG. 2 is introduced.

Now referring to FIG. 70, in step 7010 a text portion may be received. The text portion could come from a database or repository that maintains textual information about a document. As discussed herein the repositories and/or databases may be singular in nature or distributed over multiple systems and/or locations. Other systems and/or methods may be used prior to method 7000 to identify the particular documents of interest. This document of interest may be what is received in step 7010. The nature of the text portion received may be in many forms. Typical forms may include straight text, a structure that includes the text (e.g., XML), HTML, compressed data, or information that may be embedded, etc.

In step 7012, the text information received in step 7010 may be analyzed to determine the major sections. Depending on the source of information received, the analysis may be tuned or optimized for determining the major sections based on the document type. For example, the document may be a patent document from year 2001, which may have an optimized analysis system used that interprets the text that may conform to patent office standards at the time the text was published were submitted to the patent office. In another example, the analysis system may be optimized for older patent documents, such as documents submitted to the patent office were issued in 1910. In another example, the analysis system may be optimized for documents originating for from other places, territories, or offices (European, British, Japanese, etc.).

The major sections may include the front page information in the form of bibliographic data, background, brief description of the drawings, summary, detailed description, claims, abstract. These major sections once identified may have other analysis systems applied to them to further subdivided and identify sections therein.

In step 7014, minor sections may be determined within each major section. For example, in the claims section each claim may be identified. In the summary, each paragraph may be identified as a minor section. In the brief description of the drawings, each figure referred to may be identified as a minor section. As discussed above, the detailed description may be subdivided by text that appears related to particular figures. An example, a minor section in the detailed description may be identified as the text that starts with discussion of FIG. 1 through the start of the discussion of FIG. 2. In a very simple example, the minor section may be identified as the text between “FIG. 1” and “FIG. 2”. In some cases there may be overlap. If for example FIG. 1 and FIG. 2 are discussed in the same paragraph, adjacent minor sections may be defined as including that paragraph where both figures are discussed. Thus the determination of minor sections may not contain distinctly isolated sections.

In step 7016, the structure of the major sections may be determined. The structure of major sections could be considered an internal determination of the mapping of the minor sections contained therein. This may include, for example, the dependency structure of the claims. If, for example, claim one has claims two and three depending from it, the structure of the major section related to the claims may include the relation of claims two and three as being dependent from claim one. Thus, information or metadata related to the claims major section may include the description of claim one as being an independent claim and having claims two and three being good to dependent from it.

In the detailed description major section, each minor section related to the figures may be used to determine the structure. For example, where the discussion of FIG. 1 bleeds into the discussion of FIG. 2 (e.g. by an overlap of minor sections) then structurally the minor sections that are overlapping may be identified as relating to one another. Moreover, these minor sections may not only be identified as relating to their respective figures discussed therein, but they may also be identified as being related to each other.

In step 7018, the relations of each minor section within each major section may be determined. For example, where the minor section associated with claim one within the claims major section includes certain claim in terms or words, these words may be compared to words within minor sections of other major sections. Where a comparison yields a match or close match (e.g. similar words) then the minor section associated with claim one may then be related to these matching minor sections of other major sections. The relation may then be stored for later use. For example, where the minor section of the claims major section includes the term “widget”, and a minor section of the detailed description includes the term “widget”, then each of these minor sections may be associated or related with each other. Additionally, the major sections may be associated with each other.

In another example, where the minor section of the claims major section includes the term “widget”, and a minor section of the detailed description includes the term “widget”, and a minor section of the brief description of drawings includes the term “widget”, a minor section of the summary major section includes the word “widget”, the abstract section includes the word “widget”, and a minor in section of the background major section includes the word “widget”, then each of these major sections are related to one another, as well as each of the minor sections included therein are related to one another. The relations may be stored to describe how each of the major sections and minor sections include subject matter that is common to each other. These relations may be stored and metadata that described the document, metadata that describes each of the major sections or minor sections.

The method may proceed to determine relations for the major and minor sections based on the use of the same words or similar words described in the sections. The method may also proceed to determine relations for more specialized words such as the element names used in the specification that may also be used in the claims for example. The method may also separately described the relation of more specialized words, such as the element names and numbers, because presumably these elements are used in the drawings also. Moreover, elements from the specification or detailed description, may be identified in the claims as having special meanings as claim terms. Alternatively, each word (other than for example stop words such as “the”, “and”, “or”, etc.) from the claims may be considered to have special meaning and may be tagged as such in the relations or in the metadata stored.

Beyond the identification of elements, other words may be identified as having special meaning by use of natural language processing tools that may provide identification of noun phrases, verb phrases, or other syntactic identifiers and may be allowed to tag words and phrases as having importance in the document. The method may then relates these words within the minor sections and major sections and store the relations.

In step 7020, the information determined herein may be stored for further processing.

FIG. 71 is a method 7100 for identifying an embodiment. In general method 7100 may be used to analyze a document to find one or many embodiments described therein.

In step 7100, a graphics portion of a document is received. As discussed herein in detail, a graphics portion may be processed to extract element numbers, figure identifiers, and other text that may appear in the graphics portion. Moreover, they received graphics portion of the document may already be processed using an OCR system and provided to this method as a data structure, file, or other information such that the actual graphics may not need to be analyzed specifically, but rather, the information in the graphics portion may be analyzed.

In step 7112, the major sections of the graphics portion may be determined. For example, each page of the graphics portion may be identified as being a major or section.

In step 7114, the minor is sections of the document may be determined. For example, each figure may be identified. As discussed above, each page may be subdivided based on pixels present, and the output of an OCR method that may determine the element numbers and the figure number. Then a sectionalization or bobbing technique may be used to identify the graphics portion of a figure, the figure number, and the element numbers associated with that figure. Thus, using these techniques, each major or section of the graphics portion may be subdivided into minor sections, each minor section being related to a particular figure. Moreover, the element numbers, text, figure number, other information, may be stored as metadata relating to that figure and/or relating to that minor section.

In step 7116, the minor section structure may be determined. For example, where a method is described in the figure, certain method steps may be shown as boxes. These methods steps may include may be based on text or simply numbers identified in step. The boxes may also be connected to one another with lines. In determining the minor structure of a section, the words within or near a box may be identified with that box, and/or the connection between boxes may be identified.

In step 7118, the relations between the major sections and minor sections and a stack section structure may be determined. For example, where two figures include the same element number, these figures may be related with one another. Similarly, where two figures include the same text or similar text, these figures may be identified with one another.

In step 7120, the information determined herein may be stored for further processing.

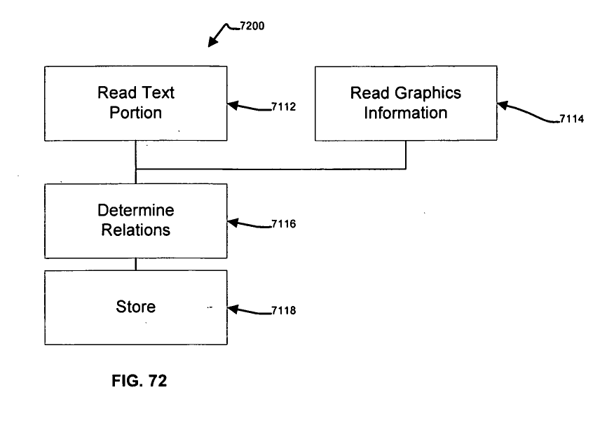

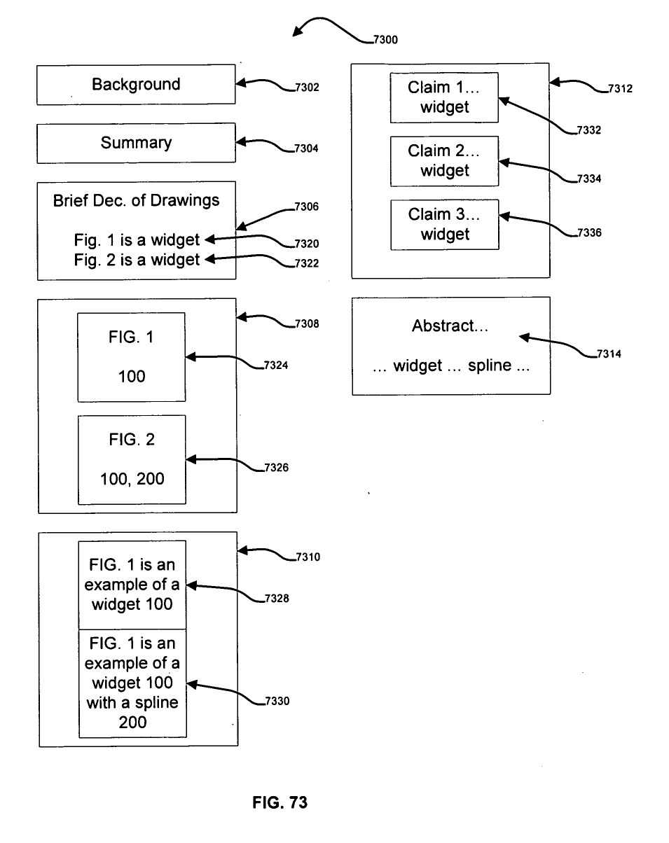

FIG. 72 is a method for determining relations any document based on both text information and graphics information. Here, relations between the sections within the text and graphics may be formed to any document level identify the embodiments contained in the document.

In step 7212, the text information may be read from a data store, database, memory. This text information may include the section information discussed above with respect to method 7000 and may also include other information such as the brought text, processed text (e.g., natural language processing information), synonym data for the text, the elements in the text, and information such as the classification of the document. In general, the text information read may include the basic document and all other information that has already been determined to be relevant to that document which may be stored for example as metadata about the document, or in a structure associated with the document.

In step 7214, the graphic information may be read from a data store, database, memory. This graphical information may include the base graphic portion of a document (e.g. the image), and metadata associated with the graphic portion that may be stored as text or in another form. In general, the graphic information may include information that describes the embodiments already found within the graphical portion as well as the element numbers found, the figures found, text that was found in the graphical portion, the major sections, the minor sections, and the relations between them.

In step 7216, the relations of the text information in the graphical information may be determined. For example, where FIG. 1 is identified in the graphics information as an embodiment it may be matched with FIG. 1 in the text information and may be determined as an embodiment of the document. As discussed above with respect to method 7000 and methods 7100, embodiments may be found in the text portion alone the graphics portion alone and may further be processed to determine the embodiments in the document as a whole.

In step 7218, the information about the embodiments identified in the document may be stored.

FIG. 73 is an example of relations within a patent document. The patent document may include major sections such as the background 7302, the summary 7304, the brief description of the drawings 7306, the graphical portion 7308 (e.g., the drawings), the detailed description 7310, the claims section 7312, and the abstract 7314. In more detail the brief description of the drawings section 7308 may also include minor sections 7320 and 7322. Similarly the graphical portion 7308 may also include minor sections 7324 and 7326. In this example, minor section 7324 may relate to FIG. 1 and minor section 7326 may relate to FIG. 2. Additionally minor section 7324 may also include element number 100 as being present within the minor section. This minor section 7326 may include element number 100 and element number 200. Detailed description section 7310 may include minor section 7328 that has FIG. 1 related to it and also includes element number 100 that has the element name widget associated with it. Minor section 7330 may have figure to related to it and may also include the word widget (that may or may not have element number 100 associated with it, but that association may be made simply by virtue of the work matching or being similar to a numbered elements), and may also include an element spline 200. In the claims major section 7312, minor sections 7332, 7334, 7336 may be included. In minor section 7332, claim one may be associated with it and also the claim term widget may be associated with it. Minor section 7332 may also be identified as an independent claim. Minor section 7334 may have claim to associated with it, which structurally is related to claim one because claim two is a dependant claim, depending from claim one. Minor section 7336 may be associated with claim three and may also structurally be related to minor section 7334 and 7332 through the dependency structure of the claims. In this example, claim one is an independent claim, claim two depend from claim one, and claim three depends from claim two. Thus, while each of sections 7332, 7334, 7336 are independent minor sections they are also related to one another such as is discussed above. With respect to minor section 7336 relating to claim three, a claim element may include the word “spline”. Abstract major section 7314 may or may not have subsections assigned therein depending on the organization of the abstract and depending on the rules regulating the abstract. For example in the United States the abstract may be a single paragraph and may not need minor sections to be determined therein. However, the system may determine minor sections if there are sentences within a single paragraph. Moreover, other jurisdictions may allow for multiple paragraphs in the abstract. In these cases it may be useful to determine the minor sections within the abstract. In the example provided here, the abstract contains the words widget and spline.

In determining the relations, as discussed above with respect to FIG. 72, each of these major sections and minor sections may be related to one another. For example based on the identification of the figures, minor section 7320 of major section 73 await may be related to minor section 7324, minor section 7328, minor section 7332, section 7314, etc. Indeed, the relation to one another may be based then many factors including metadata associated with each major section and minor section and relations already made, in addition to the existence of certain words such as widget or spline, the existence of element numbers (e.g. as found in the drawings), an embodiments that are identified within the text or graphical portions, and the information relating to each embodiment.

In determining the embodiments for the document as a whole such as is described with respect to FIG. 72, the example document shown in FIG. 73 may include an embodiment related to FIG. 1 that may include certain information such as the existence of the word “widget” as an element name that is associated with the element number 100. Both minor section 7328 includes an identifier for FIG. 1 as well as widget 100 which may be used to relate minor section 7328, minor section 7324 in the drawings that includes element number 100, minor section 7320, minor section 7332 that includes the claim term widget, and the abstract section 7314 and includes the word widget, each minor section and the corresponding major sections may not be associated with the embodiment. Moreover, other information from minor section may also be included as being identified with the embodiment. For example minor section 7328 may include a body of text which may be associated with the embodiment. More detailed information, such as the element names and element numbers may also be separately identified as associated with the embodiment. Each of these associations to the embodiment may be used for further analysis such as synonym analysis, classification analysis, searching of embodiments, and checking for consistency of the embodiments in a patent document.

When performing synonym analysis an embodiment, the words and/or elements associated with the embodiment may be used to develop a specialized set of synonyms for that embodiment. A set of synonyms based on the words and elements present in the embodiment may exclude synonyms that are not relevant to the technology, but may include synonyms that may be specialized to the technology.

When performing classification analysis embodiments, the element names and other words may be used to determine the proper classification for the embodiment, rather than relying on the classification of the overall documents. This may be useful and searching, for example, where a patent document may have an overall classification based on the claims, but that classification does not cover certain embodiments present in the patent document that may or may not relate to the claims specifically. Thus when performing classification searching, or simply searching and applying a classification based on the search terms, the classification of each embodiment within the patent document may be separately classified and thus, the search would not necessarily look to the classification of the patent document as a whole, but may look to the classification of the embodiments contained therein to add to a relevancy determination for the embodiment and/or the document.

When searching for embodiments, the association of the words and/or elements within the embodiment may be useful in determining relevancy. For example, where a first embodiment includes a first search term and a second embodiment includes a second search term, the relevancy of this document and the embodiments may be less than the relevancy of another document that includes the first search term and a second search term in the same embodiment. Thus, the accuracy of a search may be improved by searching for embodiments in addition to documents. The relevancy score of the search as associated with each embodiment and/or combined with the relevancy of each document may be used to determine the ranking of the search results, which provides the user with an ordered list. The search results in a traditional search are typically ordered by document. However alternative search results may be provided as ordered by embodiment rather than a document as a whole.

Additionally, the identification of embodiments in the document may be used to determine the consistency of the patent document itself. For example, where an embodiment includes the element name widget 100, consistency may be checked in the claims the detailed description in the figures. Inconsistencies in the use of element names and/or element numbers may be identified from the embodiments or in the document as a whole and may be reported to the user for correction, or may be corrected by the system itself automatically.

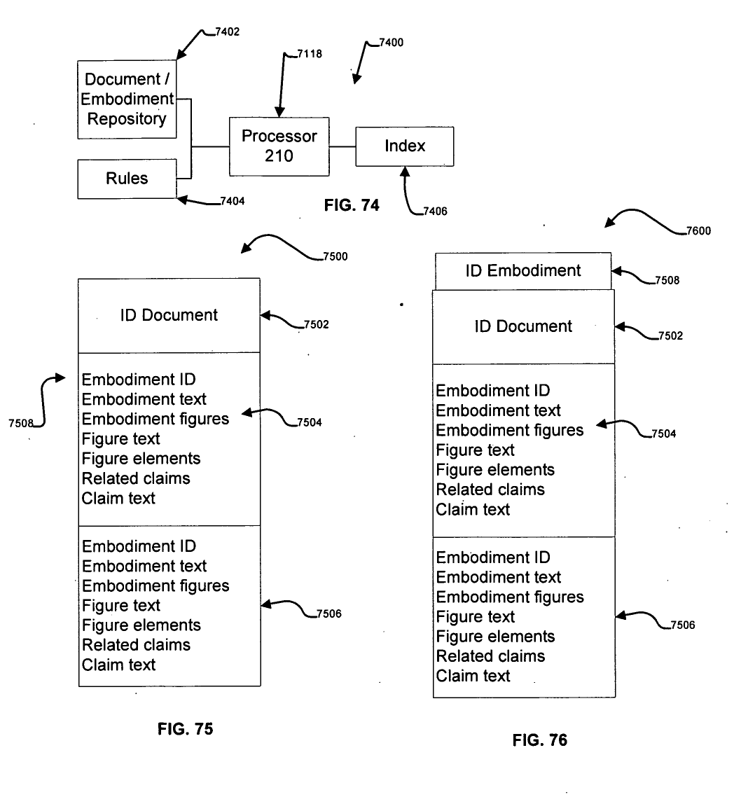

FIG. 74 is a system 7400 for indexing document. Processor 210 may interface with a document/embodiment repository 7402, a rules repository 7404, and an index 7406. Index 7406 may be embodied as a single index, or multiple indexes. Searching systems and methods, as described herein, may use index 7406 to search for documents and/or embodiments using terms that are provided by other systems and methods or terms provided by users. Additionally index 7406 may be embodied as various types of indexes as known to those skilled in the art. Index 7406 may contain records for the documents that are being indexed, and/or index 7406 may contain records for the embodiments that are being indexed. Moreover, index 7406 may include additional information and metadata related to the documents, and/or this additional information and metadata may also be indexed for later searching.

Document/embodiment repository 7402 may be a single repository or may include multiple repositories. As known to those skilled in the art, these repositories may be present at a single site, or they may be spread over multiple physical locations and connected by a network. The document/embodiment repository may include the actual documents themselves, where they may include records and information that described the documents including, but not exclusive to, metadata and/or structures that described the particular information contained within the document and/or information such as is found in the systems and methods described in the systems and methods described herein.

Rules repository 7404 may include records and/or information used to describe how to index the documents/embodiments. These rules may be tuned based on the document itself, and/or the document structure, and/or the embodiments described within the document (e.g., using classification information, whether an embodiment is a system and method or apparatus, etc.). The rules repository may determine not only how a document/embodiment is processed but also how a document/embodiment is indexed. For example, the processing of a document may have variations for method embodiments versus apparatus embodiments or chemical embodiments. Moreover, other information such as the date of publication of the document, the country a publication, and other information may be used to apply various rules. All of the information related to the document/embodiment may be used to determine how the document/embodiment is indexed. For example, if an embodiment is described as a method, the text related to each step in the method may be indexed independently. This may allow for advanced searching of methods that may determine relevancy based not on the overall text related to the embodiment, but distinguishing what particular text is associated with each step of the method.

FIG. 75 is an example of an index record 7500 for a document that includes embodiments. Index record 7500 may include a document identifier 7502 that may be used to reference the actual document of interest. Where the document includes multiple embodiments, as is shown here, index record 7500 may include separate sub records such as first embodiments sub record 7504 and second embodiment sub record 7506. Embodiment sub record 7504 may include an embodiment identifier 7508 that may be a unique number in the overall system or may be unique only to index record 7500. Embodiment identifier 7508 may be used to distinguish between embodiment sub records 7504 and 7506, or it may be used in the overall systems and methods to uniquely identify the embodiment contained within index record 7500. Embodiment sub record 7504 may also include information such as the indexed text from the specification that relates to the embodiment, which figures relate to the embodiment, the text from the figures, the elements used in the figures, each claim that relates to the embodiment, the text of the claims, etc. In general, index record 7500 may separate document identifier 7502 embodiments 7504, 7506, and the other information in separate fields. By fielding the information within index record 7500, later searching may be enhanced by allowing system and method to fields search unspecific information, or narrow the search to include certain embodiments, or exclude certain embodiments. For example, if the search system and method determines that the user is searching for an apparatus, embodiments that relate to methods may be either excluded, or may be suppressed and the relevancy score. By fielding the information within each index record, a search system and method is provided with a mechanism to apply simple filtering techniques to each index record 7500, and the embodiments described therein, to provide the user with the most relevant results and/or a ranking that provides the most relevant results to the user.

FIG. 76 is an example an index record 7600 for an embodiment. Depending upon the desired implementation, the indexing system may produce records such as index record 7600 that really relate to specific embodiments, and/or the indexing system may produce records such as index record 7500 that include multiple embodiments. One of skill in the art will appreciate that the indexing system can produce both types of in that correct index records 7500, 7600, and may further process these records to produce a single or multiple index these.

Index record 7600 may include an embodiment identifier 7508 that may be used to uniquely identify the embodiment as being indexed. Index record 7600 may also include a document identifier 7502 that will allow other systems and methods to identify which document the embodiment was produced from. Similar to index record 7500, index record 7600 may include embodiment information 7504 such as is described above in detail.

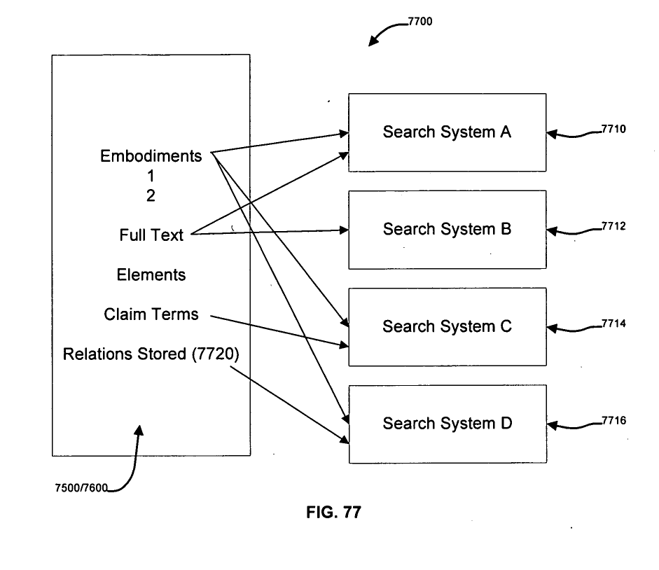

FIG. 77 is an example of different types of search systems 7710, 7712, 7714, 7716 that may be used to access an index record 7500/7600. In general the search systems as discussed herein may be used on a collection of index records or may be used on a single index record. For example when generally searching a set of documents, a set of index records may be used to determine the most relevant results for the search. However, if analyzing a single document, a single index record may be used for example to determine the most relevant figures were embodiments disclosed in the document that was used to create the index record.

In an example a search system A 7710 may be tuned for a novelty search or invalidity search and may be primarily interested in the embodiments of the index records. Search system 7710 may use different fields of the index record to narrow the search of the index record to the embodiments. For example search system 7710 may search a collection of index records but only look for keyword matches in the embodiment's fields of these index records. This may allow the search to provide results to the user that are highly relevant to the novelty or invalidity search because the results produced are based on the combination of the keywords appearing in the embodiments rather than the keywords appearing randomly within the document. Such field-based searches may allow the search system to reduce noise in the search and yield results that are based fundamentally on the type of information that is searcher is looking for.

A search system B 7712 may be a search system that looks at the full text of the document to find keyword matches. Moreover search system 7712 may also look to the relations and metadata stored for the entire document to either boost or suppress certain aspects of the full text to provide more relevant results.

A search system C 7714 may be tuned for an infringement search. Thus, search system 7714 may focus on the claim terms alone, or may focus on the claim terms in combination with the embodiments. To provide more relevant results for an infringement search, the typically infringing art may be found in the claims but also may be found in the claimed embodiments. Thus, by merging the inputs of the claim terms with the embodiments from the document, the infringement search may produce more relevant results to the user.

A search system D 7716 may be a simple search for embodiments, such as may be used for a novelty or invalidity search, and may include both the embodiments described for each document indexed and may also include the relations and metadata stored 7720 for that document. Because the relations stored 7720 may include information that describes the document, the search may be improved by adding this information to either boost or suppress matching documents from the basic search.

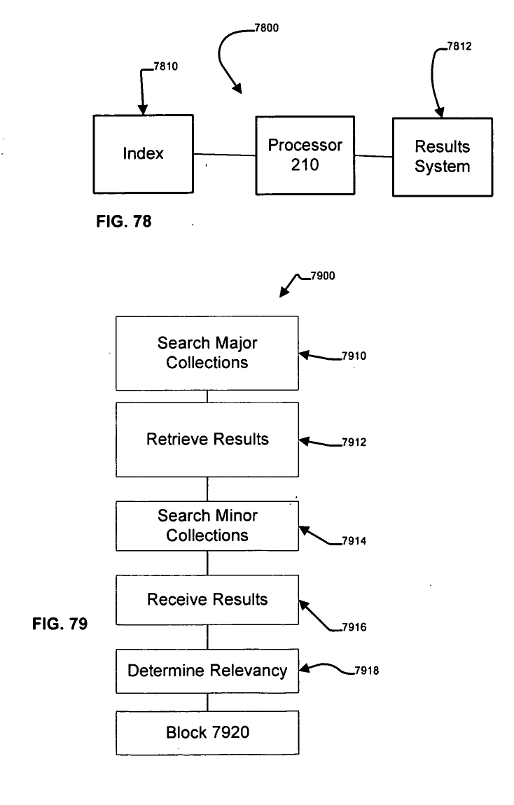

FIG. 78 is a system 7800 for searching documents. The system may include an index 7810 that interfaces with processor 210 that performs the search. Processor 210 may also interface with a result system 7812 that may provide formatting for storage, report generation, or presentation to a user. In general, search system 7800 may use the index is described herein which may contain indexed information about each document to be searched as well as embodiment information and metadata (e.g. element names, claim terms, and all other information as described herein).

FIG. 79 is a method 7900 for searching a collection of documents. In general, the search may include a search of the entire document collection initially (or a subset of the entire document collection if so desired) and then the results of the major collection may be further searched to determine the relevancy of the first result. In this way, a subset of the documents a larger set may be identified for further search, reducing overhead of the system depending upon how in-depth the search system may desire to go.

In step 7910 a search system may receive inputs from a user or other method or system as the input to the search, such as keywords. However, other information may be used such as a classification identifier. The search system may then search the major collection (i.e. the entire collection, or a subset of the collection). The search system then identifies which documents or embodiments contained the keywords, or in the case or a classification is used, which documents are embodiments are associated with the classification used for search.

In step 7912, the search system may receive the results of the search for further processing.

In step 7914, the search system may use the search results received from the major search to perform further searching on in more depth, e.g., a search of the minor collection. For example, where keywords are used as inputs to the search, certain documents or embodiments may not be considered as a search result where the keywords appear in disparate embodiments, and thus may be deemed irrelevant to the search. The search of the minor collection may be useful, for example where a generalized search method or system is used to identify a large set of documents relating to the search terms, but where a specialized search method or system is used to further identify a subset of documents for further analysis. Such a multitier search system and method may provide for more efficient indexing, data storage, speed, or other factors, while at the same time allowing for more in-depth analysis of the subset that may require more resources or different indexes.

In step 7916 the search system may receive the results of the minor collection search. In a typical application the minor search results are a subset of the major search results received in step 7912.

In step 7918, the minor search results may be analyzed to determine their relevancy to the user's initial search inputs. For example, if the user inputs three keywords, documents/embodiments that include the three keywords in a single embodiment may be an increase relevancy, whereas documents/embodiments that do not include all of the keywords or where the keywords are not used together (e.g., where the keywords are not found in an embodiment together) may be reduced and relevancy. As described herein, multiple factors may be used to determine the relevancy of the documents/embodiments. These may include the use of the terms in the figures, these of the terms in the claims, the use of the terms together with one another and figures or embodiments, the use of the terms together with one another in a particular claim, or claim set, may be used to determine relevancy depending on the type of search the user is performing.

In step 7920, a subset of documents and their relevancy score may be provided to the results system for report generation, display to the user, or storage. Moreover, if collection analysis is performed (e.g. determining proprietary classifications on the documents an embodiments), these searches may be performed on the collection and the results may be analyzed and stored for internal use in a search system an indexing system to provide metadata.

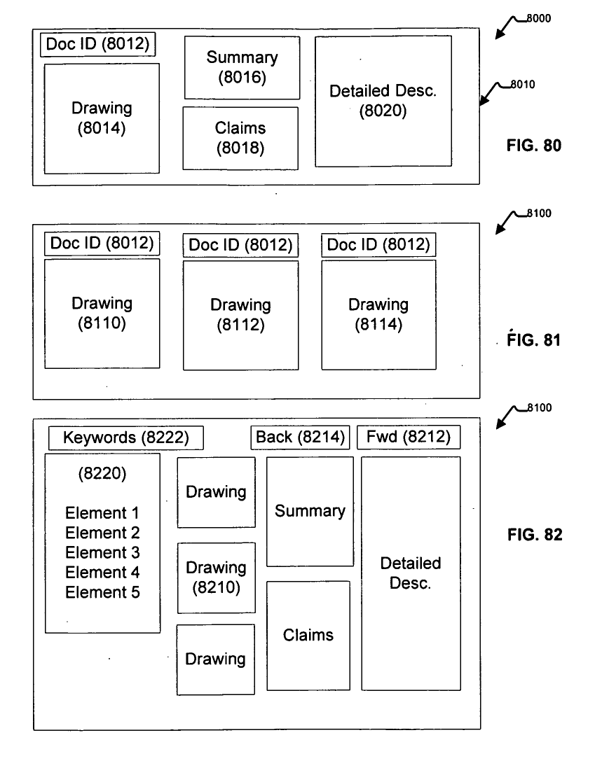

FIG. 80 is an example output 8000 of a result system output that provides a list of ranked documents based on the user's search input. For example a first result 8010 includes a document ID 8012 in most relevant drawing a thousand 14 the text portion of the summary a thousand 16 is most relevant the text portion of the claims 8018 is most relevant in the text portion of the detailed description 8020 is most relevant. The ranking to identify document 8010 as being most relevant may depend on how the relevancy is determined, but in an example, results 8010 may include the most relevant embodiment. The most relevant embodiment may include the user search input terms as being associated with a particular embodiment in the document, such as the search terms being associated with a particular figure in the document.

The most relevant drawing 8014 may be identified by the particular embodiment that matched the search terms, and has the most relevance to the search terms. For example the most relevant drawing 8014 may include all of the search terms being used as element names associated with the element numbers in a figure. The most relevant text portion of the summary 8016 may be determined by the proximity of the search terms to each other within the summary text. Where, for example, the search terms appear in the same paragraph of the summary, then that paragraph may be identified as the most relevant text portion of the summary. Alternatively, the characters-based distance of the search terms within the summary may be used to identify the most relevant portion of the text. The farther away the terms are from each other in the text, the less gravity is applied to that term. The closer the terms are to one another, the higher the gravity of the terms are to each other, and the highest gravity text portion may be identified as the most relevant text portion and provided for the user to view immediately. Similarly, the most relevant text portion of the claims 8018 may be identified in this way. Alternatively, the structure of the claims may be used to determine the most relevant claim. For example, where to search terms are found in an independent claim, and a third search term is found in a deep in the claim, the date and a claim may be identified as the most relevant claim. Alternatively, the independent claim may be identified as the most relevant depending on the style of results the system uses, or the user prefers. The most relevant portion of the detailed description 8020 may be identified in similar methods as described above, or may also include a weighting factor based on the most relevant drawing its or 14 is then identified. For example, the text gravity may be determined to find the most relevant text portion and the text associated with the most relevant drawing 8014 may also be added into the gravity calculation. Indeed, the metadata associated with the document/embodiments may be used to further analyze the document to find the most relevant portions. Many combinations of using the text, the drawings, the embodiments, the figures, the element names, the claim terms, etc. may be used to determine which portions of the document are most relevant.

By providing the most relevant information immediately to the user, the efficiency of the presentation of results is increased. Moreover, the user may be able to identify whether or not the results is relevant to their search or not. This allows the user not only to be provided with the most relevant results at the top of the list, but also allows the user to quickly identify whether or not a result is useful or not.

FIG. 81 is an example of a visual search result 8100. In this example, the most relevant drawings are produced in a title view for the user to evaluate. Near the drawing, the document identifier (e.g. such as the patent number or publication number) may also be provided so that the user knows what document the image is provided from. In certain searches, the user may not be as interested in the detailed text of the document, but may be interested in the embodiments/figures in the document. In such a way, the visual search result 8100 allows the user to view multiple search results based on images. Of course, a variation of the visual search result and a standard such result may also be used. In this example the most relevant search results is provided as the most relevant figure of a document 8110. The next most relevant FIG. 8112 may be provided next, and then the next most relevant FIG. 8114 may be provided. The number of figures provided in the search results may vary and may be organized in a different manner. For example a search result may provide 20 most relevant figures in a single view, organized by the most relevant drawing in the upper left, and moving right the relevant to see is reduced, and moving down the relevancy is further reduced.

To determine the relevancy/ranking of the documents/embodiments provided in visual search result 8100, a relevancy determination may be used as described herein that includes the document, embodiments, element names, claims, and other metadata. However, depending upon how the search is configured, the user may be provided with results that are based on the embodiments identified and ranked in the search, or simply the figures. By using only the figures in the search, significant noise may be removed and the most relevant figures are provided to the user based on a matching of search terms within the figures. Alternatively, synonyms may be applied to the keywords input to provide a broad range of keywords for the initial search. However, because figure searching or embodiment searching may assign higher relevancy to those figures or embodiments that use the search terms together, while the larger set of documents may be larger when synonyms are applied, the relevant results may be ranked in a manner that provides the most relevant results including synonyms to the user. Even though synonyms may provide a larger set of results, the ranking system allows filtering of the results based on relevancy. In this way, applying synonyms may be used to include documents/figures/embodiments that would otherwise have been overlooked in the initial search, but are now searched and ranked according to the combination of the terms and synonyms use therein.

It will be understood that in the visual search result 8100, it is not only the figure which is searched, but any of the search and ranking techniques discussed herein may be used to determine the relevancy of the documents. For simplicity, the most relevant figure may be provided to the user to provide a visual result.

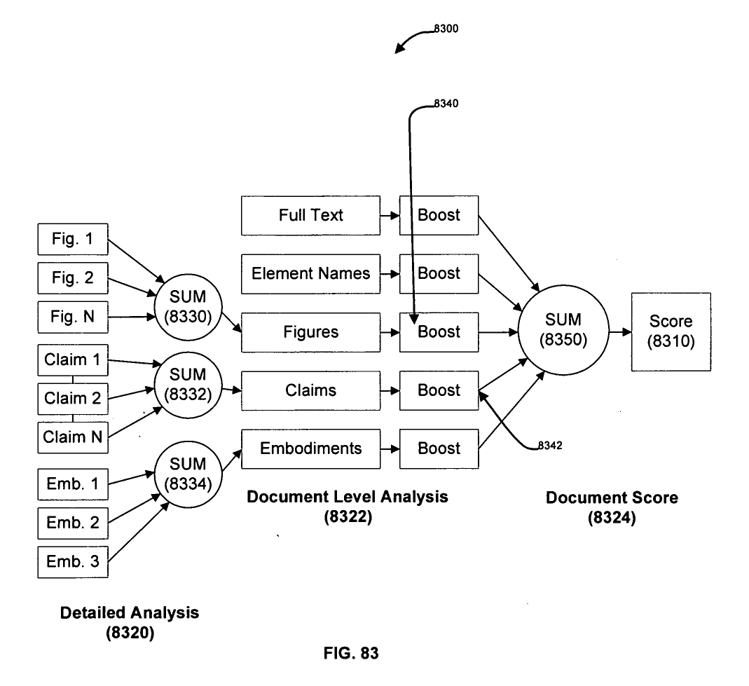

FIG. 82 is an example of a single document search. A single document search as described herein as a detailed you, may be used to search within a document to provide immediately relevant information to the user. For example a large patent document may include many drawings many embodiments and a large portion of text. To navigate the patent document the user may input keywords that they are interested in, and the view may change to provide the user with the most relevant drawing 8210 as being identified with a red border for example, in the most relevant text portions of the summary claims and detailed description scrolling interview. In this way, the user can input keywords and immediately if you the most relevant portions of the document immediately rather than having to navigate through the document manually looking back and forth to understand why a section is relevant or not.

Other features may include and next button 8212 that will shift the drawings and text to show the next relevant portions in the document. For example in some circumstances there is not one single instance of the most relevant drawing, or text portions. There may be multiple instances of relevant information. By allowing the user to navigate through the document using the next button 8212 and a back button 8214, the user may vary easily navigate the document to understand the content.

Additionally, the element names and numbers may be provided in a list 8220 for user selection or de-selection. When selecting an element, the user may click a checkbox. The view may then scroll to the most relevant drawing and text portions based on the addition of the element into the relevancy calculation. The selection of elements 8220 may be in combination with the keywords 8222 or used alone.

FIG. 83 is an example of a scoring system 8300 for a particular document based on search terms or other information. The output a scoring system 8300 is a score 8310 that provides a numerical indication as to the documents relevancy to the search terms. In general, scoring system 8300 may include a detailed analysis section 8320, a document level analysis section 8322 in the document scoring section 8324. In detailed analysis section 8320, the particular information related to the document may generate a numerical score. For example, in the figures each figure may be analyzed for a match to the search terms yielding a score. In the claims of the document, each claim either individually or in a claim set may be analyzed for a match to the search terms yielding a score. Additionally, each embodiment identified in the document may be analyzed for a match to the search terms yielding a score. The scores from the detailed analysis section 8320 may then be summed and provided to the document level analysis 8322. For example each of the scores in a figure analysis may be summed 8330 two yield a single score for the figures. Similarly each of the scores for each claim a claim set may be summed 8332 to provide a single score for the claims. The embodiments may also be summed to provide a single score for the embodiments.

Document level analysis 8322 may provide for a scoring of each document section and applying boosts to the document sections to adjust the scores depending on the search type desired. For example, where a novelty or invalidity search is being performed the figures may be boosted 8340, and the claims boost 8342 may be reduced. In this way, the scores for each document section can be adjusted for the search type. Generally, when performing a novelty search, the figures or embodiments may be boosted higher than for example the claims. Alternatively, the claims boost may be eliminated or set to zero so as to remove a score from for the claims from entering into the document score 8310. When performing an infringement search, the claims boost 8340 may be higher than the figures boost 8342. However, the infringement search may also include a boost for the embodiments that may also combine the claims and figures scores.

Document score section 8324 may be used to provide single document score 8310 that indicates an overall score/relevancy for the document with respect to the search terms. Each of the document level analysis scores from section 8322, including any boosting or nullification, is summed 83502 to root produced document score 8310. The search systems and methods as described herein may use score 8310 to rank the document relative to other document scores in an ordered list and provide this to a display system which then formats and provides a results to the user, or in a report, or is otherwise saved for future reference. As one of skill in the art will appreciate, each of the scores 8310 for the documents searched may be normalized prior to ranking.

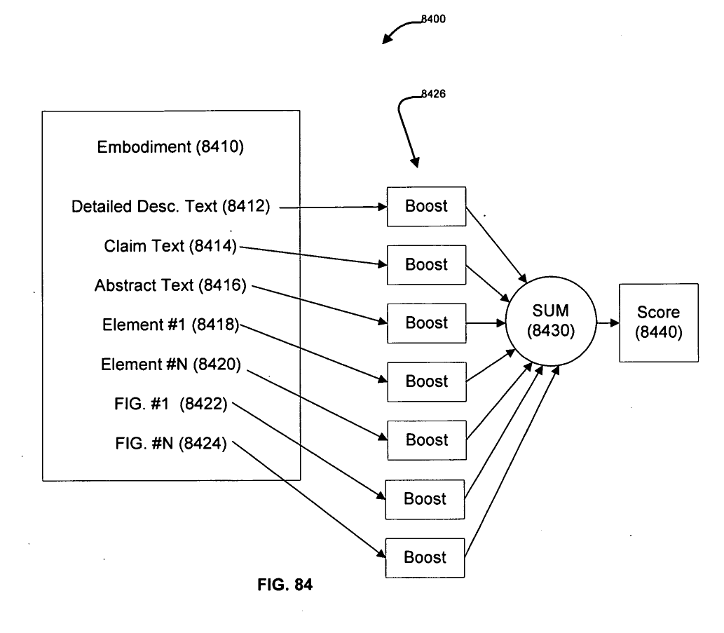

FIG. 84 is a system 8400 for scoring embodiments. In an example an embodiment 8410 contains the embodiment information that may include the detailed description text 8412, claim text 8414, abstract text 8416, the first element listed 8418 through the last element listed 8420, the first figure identified 8422 through the last figure identified 8424. Boosts a four to six may be applied individually to each of the information from embodiment 8410. In general, matches of the information from embodiment 8410 each provide a score to the boosts 8426. The boosts 8426 then in turn may modify the each of the embodiment results either increasing the score or decreasing the score. Each of the boosted scores may be summed 8430 to produce an overall embodiment score 8440. One of skill in the art will recognize that the embodiment scoring system 8400 may be used separately to score embodiments in a search, or embodiment scoring a 400 may be used while also performing document scoring 8300.

As discussed above with respect to FIGS. 83 and 84, the scoring methods may be used to provide an overall score used for ranking search results. However, each of the scoring methods may also be used to provide intermediate information that can be used to adjust the score or to refine the output to the user. For example, in document scoring FIG. 83 shows that each of the FIG. 8330 may have an individual score associated with them. This may be useful when providing results to the user by allowing the system to identify which of the figures has the highest score with respect to the search terms. The highest score then identifies the most relevant figure to the search, and that most relevant figure may be shown initially to the user in the results display. Similarly in FIG. 84, the embodiment scoring system 8400 also has intermediate results for the figures that may be used in a similar manner to identify the most relevant figure.

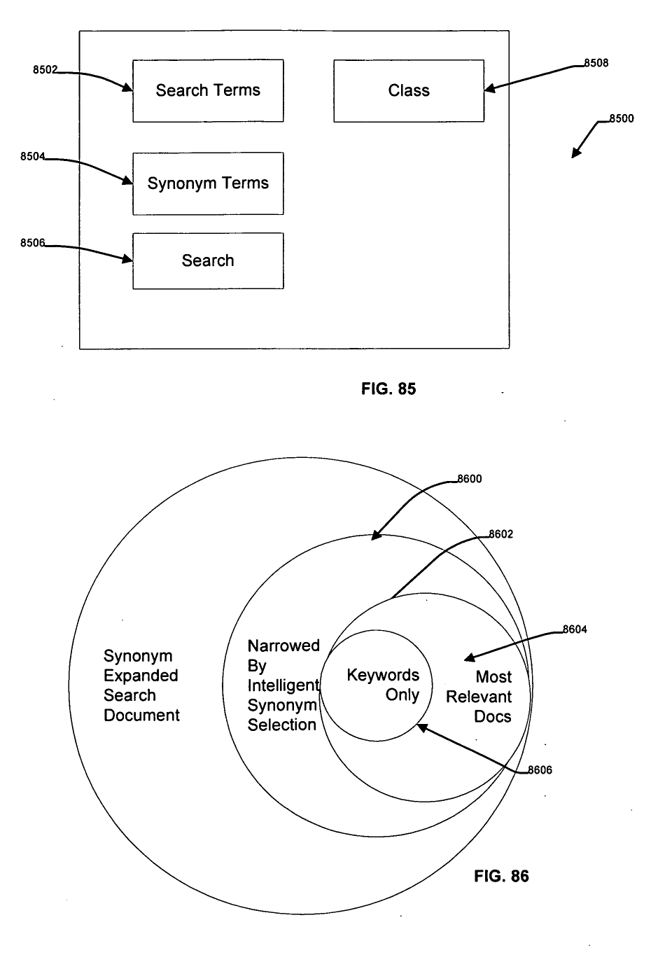

FIG. 85 is an example of a search system 8500 that provides for typical keyword searching and also synonym searching. If search system 8500 includes a user text search term lacks 8502 that may be used to input required search terms. A synonym search term input box 8504 may also be included where when the user inputs a term, the synonyms for the term may be determined from a repository of synonyms and added to the list of search terms that will ultimately search the document/embodiment depositories. A search button 8506 may be included to initiate the search when the user desires. An additional classification selection system 8508 may be provided to allow for targeted synonym use. For example, if the user desires to select a particular set of classes or subclasses related to the search, the system may automatically narrow the synonyms generated from synonym search term input 8504 for to those classes or subclasses. It is important to note, that classification system 8508 may not restrict the search are the results to those particular classes or subclass is selected, but rather, selectively adds or removes potential synonyms that may be generated from the terms input and synonym box 8504. Alternatively, classification system 8508 may also restrict the results to those particular selected classes are subclasses. Using search system 8500 user may allow for intelligent synonym selection based on the art that he or she desires.

When search system 8500 is utilized, the addition of synonyms for particular search terms may initially broaden the total number of results provided. However, using the systems and methods for search as described herein, for example where embodiments are searched, the results are ranked in a way such that the user may not be overwhelmed with a large number of documents, but rather, may be provided with the most relevant documents and/or embodiments related to their search. In this way, the problem of synonym expansion of the search terms may be used in a manner that provides for better results rather than simply more results.

FIG. 86 illustrates a synonym expanded search that includes intelligent narrowing an intelligent relevancy methods and systems applied. A synonym expanded search document set 8600 represents a set of documents out of the searched collection that are responsive to not only the keywords but also includes the documents responsive to the synonym expanded list of search terms. A subset 8602 may represent an intelligent narrowing of the synonyms based on classes or subclasses selected by the user, or classes or subclasses determined to be relevant based on the keywords entered by the user. In such a way, the overall set of documents responsive is reduced because not all of the synonyms are expanded in their entirety. The synonyms are expanded intelligently based on the art being searched. A set of most relevant documents 8604 represents a further subset that may be identified by the use of the keywords and synonyms and embodiments and/or figures. For comparison, a set of documents responsive to the keywords only 8606 may have an intersection with most relevant documents 8604. However, the keywords only set 8606 is a smaller set than the most relevant documents 8604 found by expanding the search terms with synonyms. In general, the expansion of search terms with synonyms allows the user to find a broader set of relevant documents and/or embodiments, but also provides that many documents and/or embodiments may not be missed by simple keyword only searches.

As discussed above, the search terms themselves may be used initially to provide a fully expanded pool of synonyms. However the terms themselves may also be used to restrict a larger pool of synonyms based on, for example classifications the may be related to the search terms. In an example, if to search terms are used in the search terms are “transmission” and “gear”, the transmission term could be expanded in the automotive sense to include powertrains but could also be expanded to include biological sciences (e.g., transmission of disease). However, intelligent use of synonyms may be determined by the search terms themselves such that inclusion of the search term gear would restrict out synonyms related to the biological sciences. Moreover, these systems and methods for searching discussed herein may also provide better ranking of the search results such that more relevant results are provided at the top of the list and less relevant results are provided at the bottom of the list.

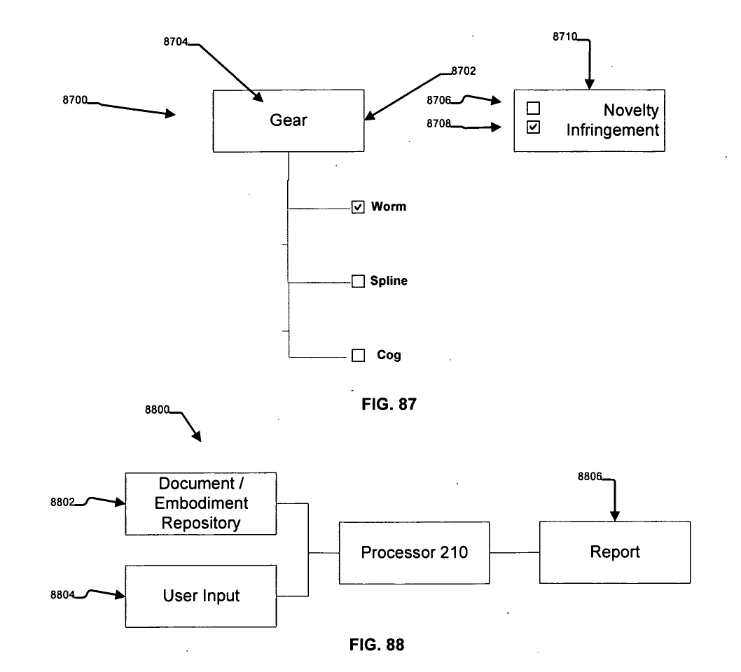

FIG. 87 is an example of a search term suggestion system 8700. A search term input box 8702 may be provided for the user to input a search term 8704. In this example search term 8704 is the word “gear”. The synonyms for the word dear may be provided as an expansion tree including the words form, spline, cog, to name only a few. The user may then by way of checkboxes. The system may also provide a type of search input 8610 that allows the user to select the type of search, such as a novelty 8706 or infringement 8708. If for example novelty 8706 is selected, the synonyms provided for search term 8704 may be limited to the synonyms that appear as element names in the embodiments and/or documents. Alternatively, if infringement 8708 is selected, synonyms provided may be limited to the words that appear in the claims. However, a selection of infringement 8708 may also be configured to expand the claim terms with synonyms that are derived from the specification of each document they appear in.

In general, the use of synonyms may provide for automatic expansion an automatic narrowing but is typically used to provide a larger set of documents responsive to the user search. Also as discussed herein, the search methods and systems apply various techniques to yield rankings and scores for the most relevant documents and/or embodiments. Thus, a combination of synonym expansion and also ranking and scoring may provide the best overall solution to provide the user with results responsive to their search.

FIG. 88 is an example of a report generation system 8800. Processor 210 may be used to perform methods to generate reports. Processor to 10 may interact with a document/embodiment repository 8802 and user inputs 8804, perform methods, and generate a report 8806.

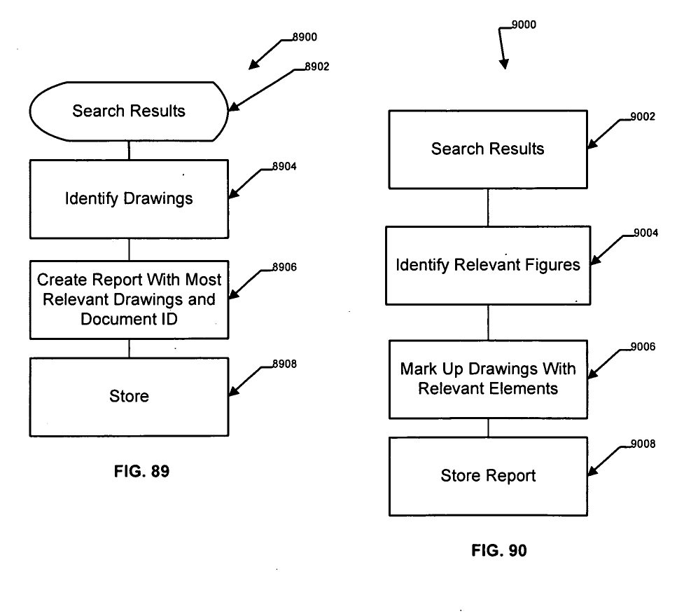

FIG. 89 is an example of a report method 8900. Report method 8900 may generally be used to provide the user with a report based on a search.

In step 8902, search results are provided. The search results may be from other systems and methods as described herein, and may include a plurality of results that are also ranked.

In step 8904, the most relevant drawing for each result may be identified. As discussed herein, the most relevant drawing may be determined based on the search performed, and/or may already be identified from the search (e.g., as discussed above when the document/embodiments scoring is determined).

In step 8906, a report may be generated for the user. The report may include a variety of information including, but not exclusive to, the most relevant drawing, the most relevant text portions, and/or the document ID (e.g., the publication number).

In step 8908, the report may be stored in memory or in nonvolatile memory or may be transmitted to the user.

FIG. 90 is an example of report generation that provides document markup for each search result.

In step 9002, the search results may be provided. The search results may be from other systems and methods as described herein, and may include a plurality of results that are also ranked.

In step 9004, the figures relevant to the search may be identified. These may include the most relevant figures, but may also include any other figures that have relevancy to the search. For example, the most relevant figure may be identified as the figure having all or most of the search terms present by virtue of the element names related to the element numbers and figure. However, other figures may also be relevant. These figures may not include all of the element names that correspond to search terms, but they may include some of the search terms. Alternatively, the figures may include synonyms for the search terms.

In step 9006, these figures/drawings may be marked up. The markup may include placing the element names and numbers on the drawing page. The markup may also include providing the search terms and/or synonyms that were used in the search. The markup may include adding to the drawings all of the element names and numbers associated with the figure, or it may include placing the relevant element names and numbers on a drawing page (e.g. less than the full set of element names and numbers associated with the figure). Depending upon a system configuration and/or the user's desired output format, the figure/drawing markup could have a full set of element names and numbers for the entire document, or it may include the element names and numbers associated the figure, or it may include the element names and numbers in the figure that are relevant to the search.

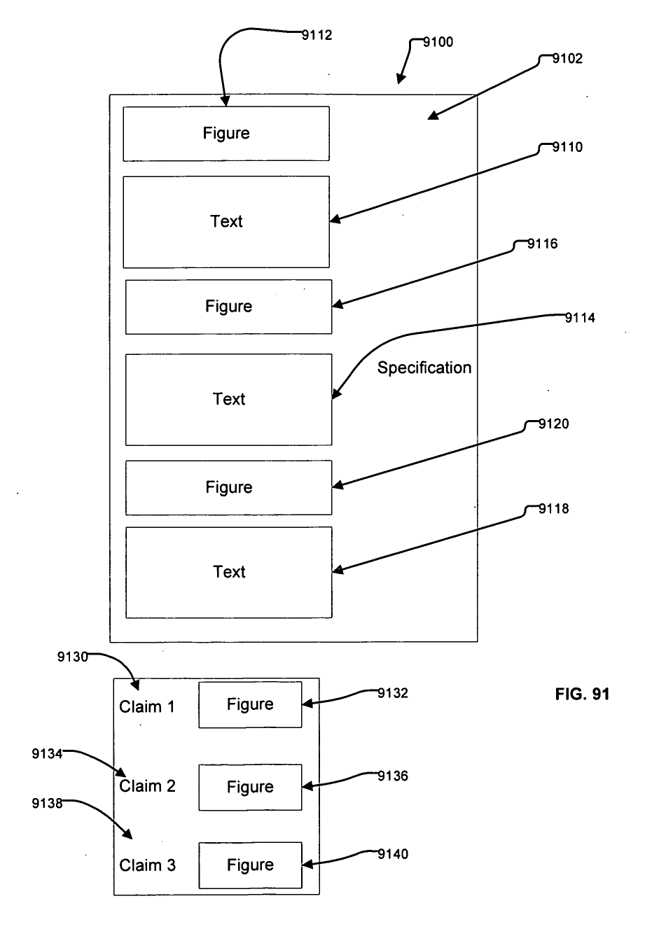

FIG. 91 is an example report 9100 that may include reformatting the original document for easier reading by the user. In an example, a specification section 9102 may include the portions of the original text of the original document and also include the relevant figures interstitially placed in the text. In this way, when the user views the reformatted patent document, they may read the text and immediately looked at the most relevant figure to that text without having to flip pages to find the figure. Moreover, the user does not need to determine which figure is most relevant to that text. The system will determine the most relevant figure for the text section and insert that figure into the report.

In an example, a first text portion 9110 is included. The text portions discussed herein may not be rearranged from the original document, but they may have the figures placed interstitially for easier reading of the document as a whole. The system may determine from the text portion 9110 that a particular figure is most relevant. That FIG. 9112 may then be inserted prior to the text section in the report document. Similarly a second text portion 9114 may be analyzed to determine the most relevant FIG. 9116 which may then be inserted prior to the text. Similarly a text portion 9118 may be analyzed to determine the most relevant FIG. 9120 that is then inserted before the text. In this way, the text of the document may be enhanced by inserting the figures for easier reading by the user.

Similarly, the claims section of the document may include the text of each claim and also the most relevant figure to that claim inserted into the document. This may be on a claim by claim basis, or it may be on a claim sets basis. As shown, each of the claims 9130, 9134, 9138, include the relevant FIGS. 9132, 9136, 9140, respectively, inserted into the document and within easy view when reading the claims. This may assist the user in understanding the claims as they relate to the embodiments disclosed in the document.

As discussed herein, where embodiments have been identified in a document, the analysis of the text section may have already been performed prior to the desire to have a report. In this instance, the metadata and information related to the document that identifies the embodiments therein may be used to insert the figures into the text without formally analyzing the text in the report generation system and/or method.

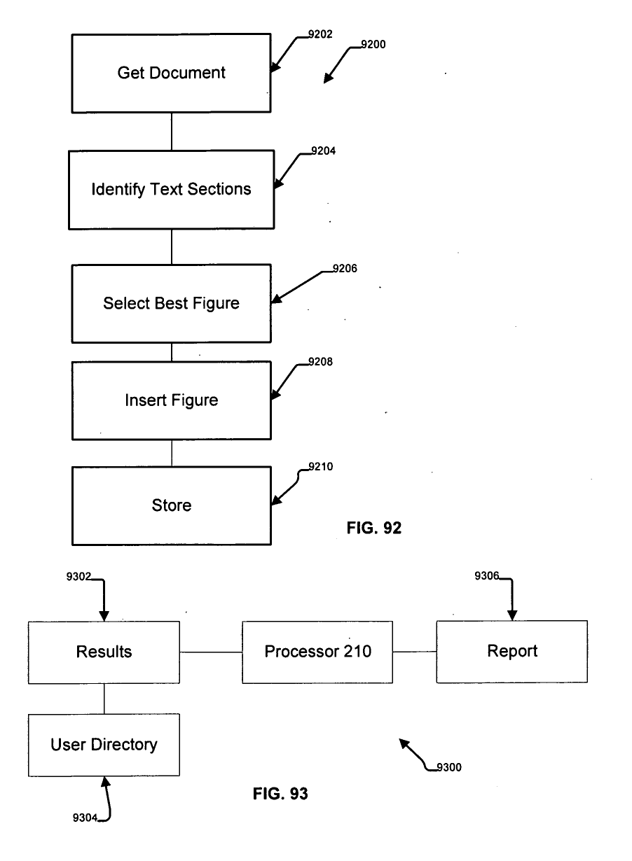

FIG. 92 is a method 9200 for generating a report.

In step 9202, the document may be retrieved from a repository. This document may include text information, image information, and/or metadata that may identify the element names and element numbers, the embodiments, the claim terms, the claim mapping to figures, and other information as discussed herein relating to the document structure and information about the document.

In step 9204, the portions of the document text may be identified. This identification may subdivide the document into portions where a figure may be inserted prior to or after the portion. For example, in the text, where a certain figure is introduced, this text portion may be identified as a portion where that particular figure introduced may be interstitially placed prior to or after that section. Similarly, each claim may be identified as having a figure associated with it, and that figure may be inserted prior to or after that claim.

In step 9206, each text portion identified in step 9204 may be used to identify the most relevant figure for insertion. In most relevant figure may be identified by a variety of methods as discussed herein. As an example, the text portion may be reviewed to determine the numbered elements found therein. The numbered elements for that text section may then be compared with the element numbers from the figures, and the best matching figure may then be selected for insertion prior to or after that text block.

In step 9208, the figure identified for each text black may be inserted interstitially in the text at the appropriate location (e.g., before or after each text block). The figure may be scaled down to a thumbnail size if desired, it may be scaled down to a medium-size, where it may be left as a full-size figure. The figure may also include element name and number markups to allow for easier reading by the user.

In step 9210, the report may be stored and/or transmitted to the user.

FIG. 93 is an example of a report generator system 9300 that may include user direction to identify the contents of the report. In this example, the resort results may be provided to the user for viewing in the user may then they would like to have in the report, and/or which figures from each result they would like to have in the report. The user may also select (e.g. from a configuration menu) how the report should be structured, for example as a more visual based report, a more standard text based report, or a blended report that may include figures and/or text.

A set of results 9302 may be provided (e.g. from a user search). As the user reviews results 9302, they may identify by selecting certain results or certain images within each result (e.g. by selecting a checkbox). Given the results and the user selection 9304, processor to 10 may then apply methods to create a report 9306. User selection 9304 may include double clicking on images, selecting checkboxes, hovering over images, selection of the type of report (e.g. visual, text, blended, etc.).

Report 9306 may be provided in many forms such as a PDF file, an HTML output, a word document, or other form. Moreover, as discussed herein, the reports may be interactive. An interactive report may include the ability to input search terms and/or select elements, and the report would then modify the viewable region such that the most relevant portions are shown.

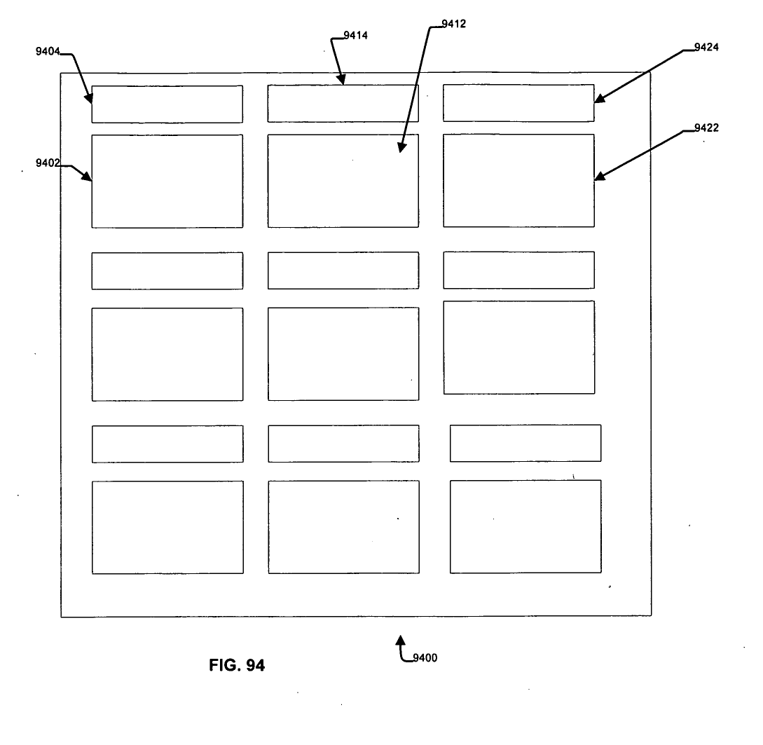

FIG. 94 is an example of a visual report 9400 that includes a plurality of embodiments shown in a report. Report 9400 may include a set of documents presented visually, or it may include a set of embodiments presented visually. When a set of documents is presented visually, the report may include only a single image 9402 from a particular document along with a document identifier (e.g., the publication number). The report would then include a plurality of document images most relevant to the search, or as directed by the user 9304, the report provides the user with a convenient copy of the results. Also, the report provides a user with not only the entire document to review, or a list of documents to review, but provides an immediate sense through the images shown in the report of what each result represents. By providing visual reporting, the user may be provided with a more useful report than simply a list of patent numbers, titles, and/or abstracts.

When the report is set up to provide embodiments, the report may include multiple embodiments from the same document based on relevancy. In this example we may assume that image 9402 from document 9404 is the most relevant image. Also, the image 9402 may be considered an embodiment found in the search. The second result image 9412 may provide pre-provided from a second document 9414. Again, image 9412 may be an embodiment from document 9414. The third embodiment's image 9422 may be another embodiment from document 9404, which may be less relevant than embodiment 9402 from the same document 9404.

As shown, visual report 9400 may include a very simple implementation of a report that includes the visual figure as well as a document identifier. These figures may be document based (e.g. where only one image from a particular document may be included in the report) or they may be embodiment based (e.g., where multiple embodiments from the documents may be included in the results, but the order of the embodiments may be based on overall relevancy).

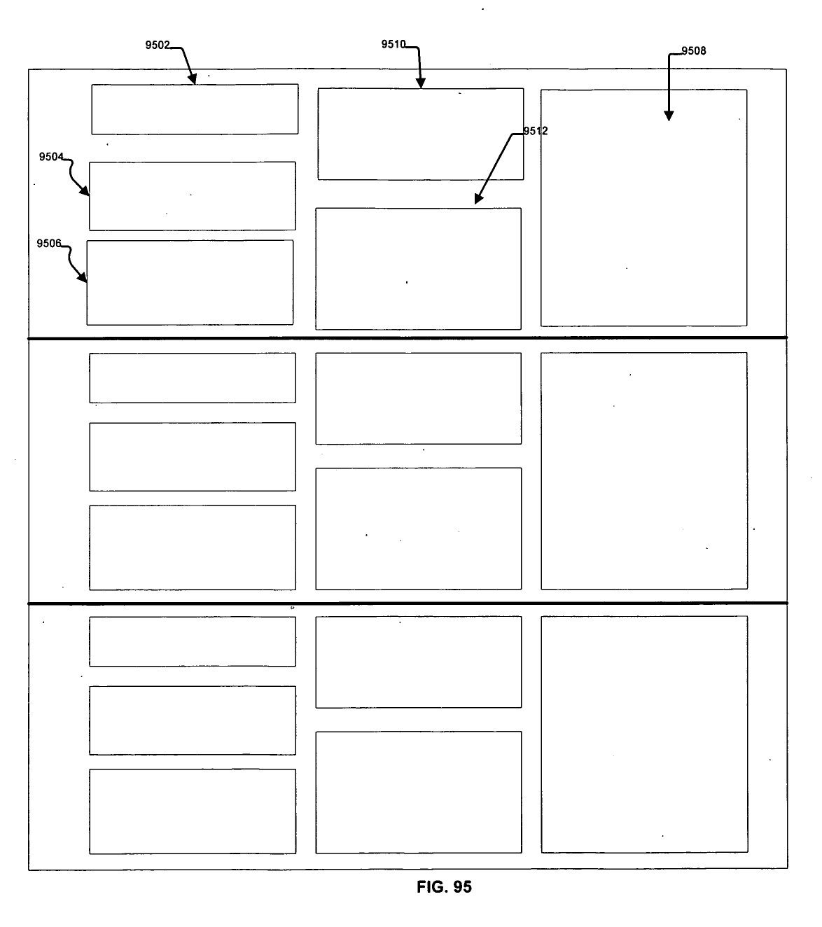

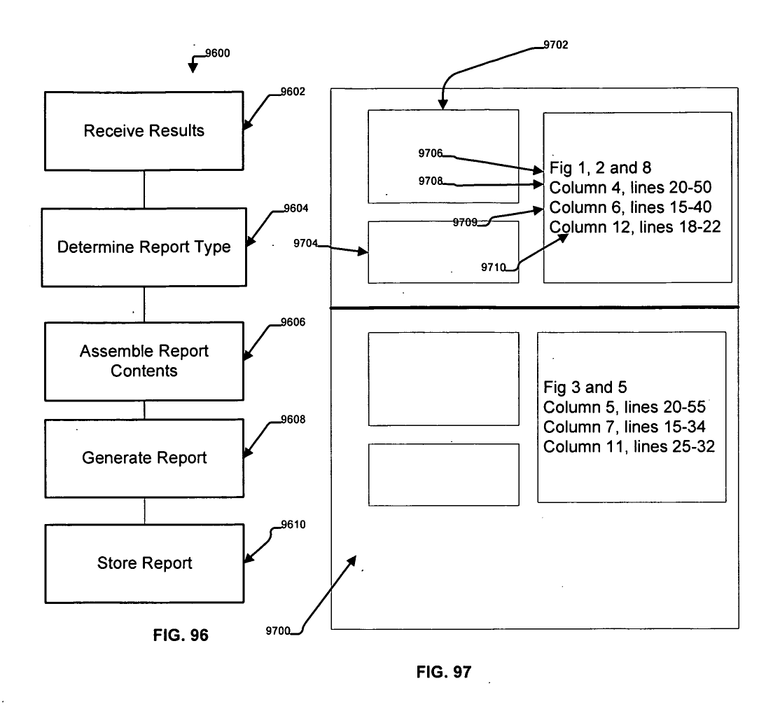

FIG. 95 is an example of a blended report 9500 that may include images as well as text. Here, for example, report 9500 may include a plurality of documents included therein, each having visual elements as well as text elements. For example each document in the report may have a document ID 9502, a relevant FIG. 9504 (and may also include additional FIG. 9506), relevant portions of text such as the relevant summary text 9510 relevant claims text 9512 and the relevant detailed description text 9514.

FIG. 96 is an example of a method 9600 for generating a report. Method 9600 may be used generally to generate reports, where the output format may vary, the step of creating the report may include formatting to achieve the desired report result.

In step 9602, the results are received. These results may be from a search initiated by a user, or from other systems or methods described herein.

In step 9604, the report type may be determined. Report cites may be determined by the current settings of the system being used, or they may be determined by the user when requesting a report. The user may for example click a button to generate a visual report, or different button to generate a standard report or blended report.

In step 9606, the report contents may be assembled. The report contents in a visual search may include the images most relevant to the search in the document ID (e.g., as shown in FIG. 94). Alternatively, the report contents may include not only relevant images or figures and the document ID, but they may also include relevant text portions (e.g., as shown in FIG. 95).

In step 9608, a report may be generated. This may include assembling all of the contents into a single file or structure. The file or structure may then be converted to a particular format, e.g., a word document, a PDF document, or an interactive document.

In step 9610, the report may be stored or may be transmitted to the user.

FIG. 97 is an example of a report 9700 based on search results. The report may include text information, visual information, and/or citations to relevant portions of the documents referenced in the search results. In general, the report may include citations to the relevant figures and also the relevant text as referenced by column and line number to the patent publication.

For example, as shown, report 9700 includes a document ID 9702 that identifies the publication. Also included may be the most relevant FIG. 9704. In text, citations to the relevant FIG. 9706 may be included, as well as citations to the relevant sections of the text portions of the document 9708, 9709, 9710. By providing such a report the user may be able to reference the important parts of the document after having completed the search. This is useful in many ways including sharing the results with others, and allowing them to quickly review the references by looking at the relevant portions identified by the report.

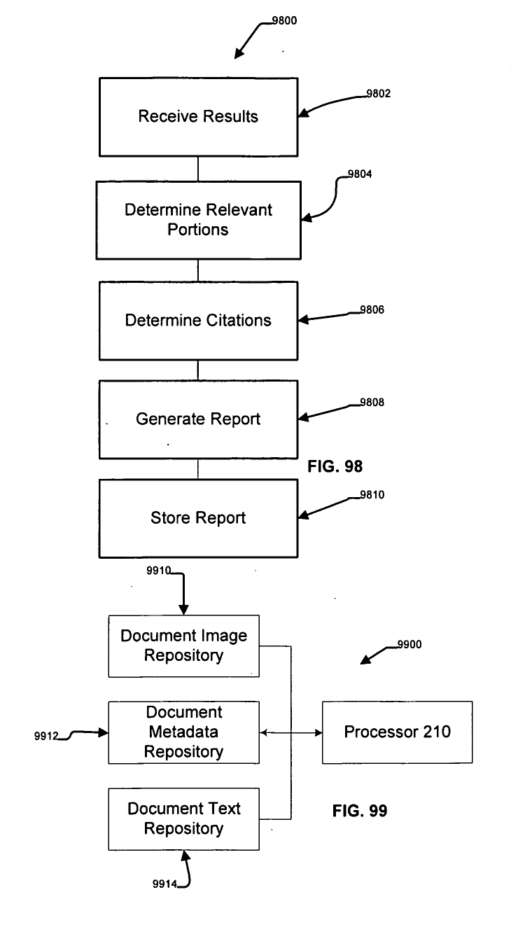

FIG. 98 is an example of a method for generating a report 9800 including citations.

In step 9802, a set of search results may be received. The search results may be provided as an output to the user search, or an output provided by other methods and systems as described herein.

In step 9804, the relevant portions of each result may be identified. As described herein, relevant portions of the document may include the figure numbers, the text portions of the document that may or may not used embodiment information for the document.

In step 9806, these citations for each relevant portion may be determined. These citations may include the figure number for the relevant figures identified. The citations may also include the column and line number derived from the patent publication and relating to the relevant text portions of the document. The column and line number may be determined by matching the text determined to be relevant with an OCR of the original document. The column and line number may also be determined by referencing metadata for the document that includes the column and line number for the text portion of the document. These may be determined, for example, during the OCR process of the original document or they may be determined using metadata or other information known about the document.

In step 9808, the report may be generated that may include a document identifier 9702, the most relevant FIG. 9704, and each citation 9706, 9708, 9709, 9710.

In step 9810, the report may be stored or transmitted to the user.

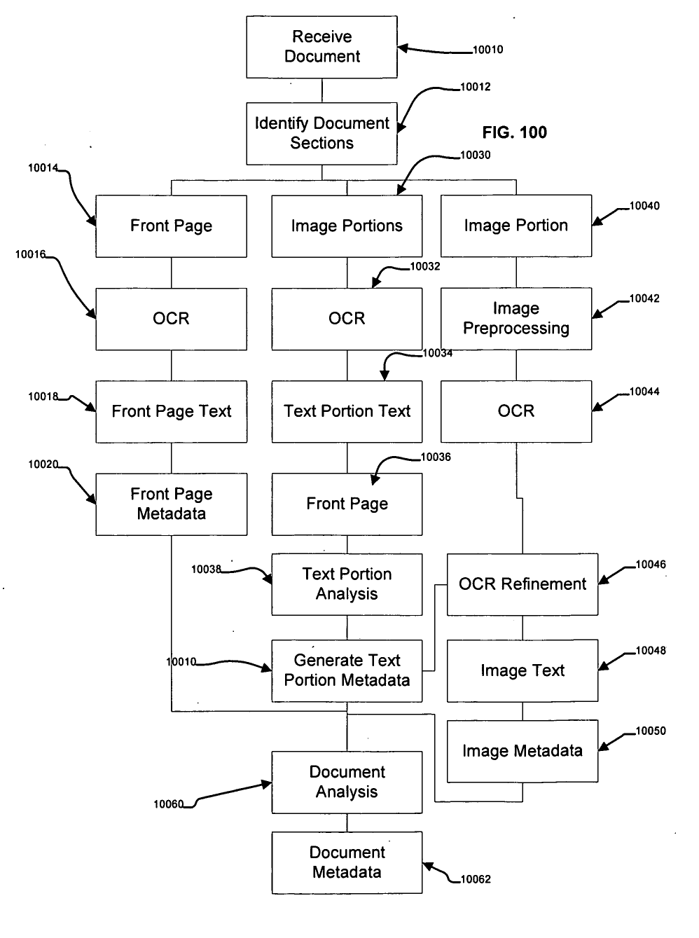

FIG. 99 is a system 9900 for performing OCR on a document. System 9900 may use processor to 10 to interface with a document image repository 9910, a document metadata repository 9912 and/or a document text repository 9914. In general, system 9900 may process text portions of a document that may be stored an image form, mixed graphical and text portions of the document stored as an image, and may use the documents metadata to enhance the quality of the OCR on a document. Examples of quality improvement for the OCR may include using metadata about the document such as the element names and numbers that may be determined from an OCR of the text portion of the document or processing of a separate repository containing the text of the document. The element names and numbers may be useful in improving the OCR on the next graphical and text portions of the document (e.g. the drawings) by allowing the OCR to have a custom dictionary of the element numbers that should be found in the drawings. Moreover, where analysis has been for performed on the text portions of the document the element numbers may already be associated with particular figures, for example when performing embodiment analysis on the text. Alternatively, finding element numbers in the text portion of the document may also include information about the distances of the numbers from each other. The distances in the text of each of element numbers may provide the OCR with information that certain element numbers may be found in the same page, in the same figure, or near each other. While the OCR may be able to determine most of the element numbers, the graphical information on the drawing pages may interfere with certain OCR systems such that element numbers may not be found immediately. The improvements of integrating document metadata and document text information to the OCR process allows for a refined OCR system that can better identify the element numbers in the figures. Moreover, where an element numbers are found, the sections of the graphical portion of the document may be removed from further analysis by the OCR system. In this way, as element numbers are identified in the drawings, noise may be removed from the system. Additionally, adjacent bits then exceed a certain size may be excluded from the OCR method and system. In this way, large objects may be selectively removed in an attempt to allow the OCR system to proceed with processing without becoming confused with the drawing portions of the document.

FIG. 100 is a method for performing OCR on a document. As described below, certain portions of a document may be analyzed in different manners. The OCR method may receive images for a document, may identify the sections of the document, and may process each section of the document differently, also allowing for feedback a certain document sections into the analysis of other document sections. Once the OCR process has completed, a full document analysis may be performed.

In step 10010, the document images may be received. Such images may be provided in a variety of forms including, bitmaps, compressed formats, or proprietary formats.

In step 10012, the document sections may be identified. For example, when analyzing the United States patent document, the front-page identification may be determined by the presence of a barcode on the top edge of the page. Moreover, other information such as the bibliographic data may be used to identify the image has a front page image. When performing such document section identification of documents, the page number, the date of the publication, the jurisdiction of the publication, may be used in conjunction with rules that establish the general format of the document sections, to determine what section the page belongs to.

When determining a document image as a drawing page, information such as the top edge of the page may include the words US patent the date the sheet number in the patent number. Alternatively, a highly simplified method for determining whether or not an image of the page may be masked and the number of bits present may determine whether or not this is a drawing page. For example, in the text portion of a document there is typically only the patent number shown. When on a drawing page the words US patent, the date, the sheet, and the patent number may be shown. Thus, a distinction of the number of bits present in the image as black may be used to eight distinguish between a drawing page and a text portion page. Additionally, assuming that the document images are provided in an ordered manner, the first page of the document may be presumed as the front page of the patent. Similarly, where an additional page or pages is inserted between the front-page in the drawing pages, the top edge of each image may determine that the image is indeed an extra page having citations to patent documents or noun patent literature.

In step 10014, the front-page may be loaded.

In step 10016, an OCR method may be applied to the front page, resulting in an OCR output. The OCR system applied may be an off the shelf OCR system or a custom OCR system that may have knowledge of the page layout for the document being OCR. For example, where the document is a US patent document, the date of the patent document may be used to determine the page layout and at page layout may be provided to the OCR system. Similarly, page layouts for expected formats of the patent documents may be determined based on jurisdiction and date of the patent document.

In step 10018, the front-page text may be identified and stored. Alternatively, the front-page text may be checked against other information related to the document to verify the consistency of the information stored about the document.

In step 10020, front-page metadata may be generated. As front-page metadata may include identification of the patent number, checking that with the barcode, the date of the patent, the first named inventor, the inventors listed in the inventor section, the assignee information, any patent term extension notice, the application number, the filing date, classification information, and priority information. Moreover, the text of the abstract may be stored. Additionally, the image portion related to the front-page drawing may be stored for future reference. Metadata may also be stored that includes references cited in a patent document, and whether or not they have been cited by the examiner. Such metadata may be useful for example, it performing an invalidity search that ultimately it is desired to file a reexamination.

In step 10030, the text portion images of the document may be provided.

In step 10032, an OCR method may be applied to the text portions of the document. Using the jurisdiction and date of the document, the expected page layout may be provided to the OCR system to improve accuracy, and to allow for determining the proper citation format, and extracting the citation information, such as calm number and line numbering. Alternatively, where the text portion includes paragraph numbering, such paragraph numbering may be identified for citation.

In step 10034, the text portion may be identified and stored.

In step 10036, an analysis may be performed on the text portion that identifies certain subsections of the text portion such as the background section, the summary, brief description of drawings, the detailed description, and the claims section. Moreover, further analysis may be used to identify sections within a document that may be useful, depending on the jurisdiction and date of the document. Just as with the OCR system using page layout information that may did be determined by the jurisdiction in the date of the document, the text analysis may also include rules that may be determined by the jurisdiction and date of the document.

In step 10038, metadata for the text portion of the document may be generated and stored. For example, the text portion may be analyzed to determine the element numbers and element names use therein. Moreover, relevant sections of the text portion that relate to the element numbers and element names may be identified. Additionally, as described herein other information may be determined such as whether or not a claim is an independent claim, reading and a claim, and the dependency structure therein. The claim terms may also be determined and related to the text portion and may also be related to the element names and element numbers. In general, the text portion analysis and generation of metadata may include all of the systems and methods as described herein apply to the text portion.

In step 10040, the image portion of the document may be provided. This may be typically the drawing pages of the document.

In step 10042, preprocessing of the images may be performed. Examples of pre-processing may be to remove the top edge of the image (e.g., having the publication number etc.) or other image portions, depending upon the format of the images. Another example of a pre-processing step may include applying a text/graphics separation process (as described above with respect to step 2130 of FIG. 21). The preprocessing of images may include removal of the graphical portion and subsequent OCR of the remaining text portions, including the element numbers and other text that may be on the drawing pages. Additionally, the preprocessing of the images may also include methods to determine the figures on the page.

In step 10044, an OCR method may be applied to the image portion of the document. The OCR may be applied to the full unprocessed image, or it may be applied to the results of a pre-processed image portion, to improve accuracy.

In step 10046, an optional OCR refinement method may be used to improve the OCR results. For example, the OCR method may use metadata generated from the text portion, such as the element numbers that may be expected in the drawing pages as a custom dictionary to improve OCR accuracy. Alternatively, where the figures are identified by the OCR method, metadata from the text portion of the document may identify not only in a custom dictionary, but may define a set of element numbers that are expected to be in that figure. Additionally, other OCR refinements may include applying higher scrutiny or broader sets of OCR font sizes or OCR fonts to improve accuracy where nonstandard fonts or noise may be included in the image. An example of customized fonts that may be included in drawing pages may include highly stylized fonts for the word “FIGURE” or FIG”. Additionally, the fonts may be determined a stem the jurisdiction and date of the document. Where very old patent documents are being analyzed, handwritten element numbers may be expected.

In step 10048, the image text is determined. This may include the existence and location of the figure numbers as well as the element numbers in the image.

In step 10050, image metadata may be generated based on the figure number and each element number that may be on the page. At a first level the page may be analyzed for the existence of figure numbers and element numbers. And a second level, the image may be analyzed to determine the embodiments on the page. For example, where a drawing page includes to figures, these figures may be analyzed and the element numbers associated with is images may be stored as metadata.

In step 10060, document analysis may be performed. This document analysis may include relating front-page information/metadata with text portion information/metadata, drawing/image information/metadata, and/or embodiment information/metadata. Moreover, document analysis may include, as described herein, relating each of the text sections with each other, with the element names and numbers, with the embodiments determined, and with the drawing pages, to name a few.

In step 10062 document metadata may be generated. As metadata may include the full set of information determined in and from the OCR processes, as well as all of the metadata generated, as well as the higher-level document analysis metadata. For example, the identification and description of the embodiments may be stored as metadata for the document. Even though embodiment information may be determined as metadata for the images, for the text, separately, a high-level document analysis may generate new embodiment metadata that may or may not include embodiment information determined separately in the text or the images.

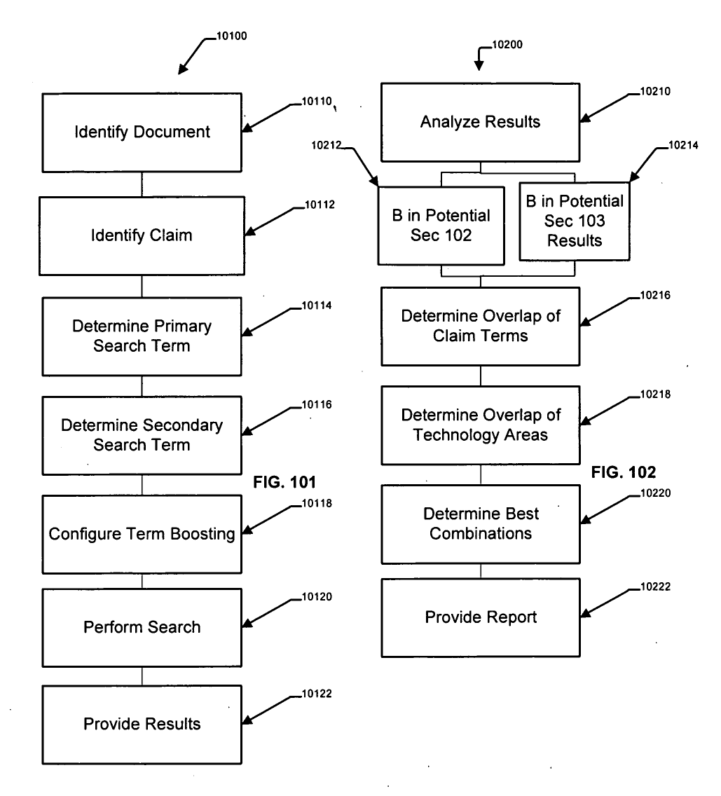

FIG. 101 is an example of an invalidation search method 10100. An invalidation search may look to the claim to invalidate to provide the search terms, it may also look to the embodiment that the claim is related to within the document to determine additional search terms that may provide more relevant results. The claim terms in general may be boosted to provide a higher relevancy score for those documents/embodiments that contain the claim terms, and the additional search terms may have a lower boosting that provide for documents/embodiments returned from the search as having a similar subject matter.

In step 10110, a document may be identified by the user. Alternatively, the document may be identified by a system or method.

In step 10112, the claim of interest for invalidation may be identified. This may be the identification of an independent claim, or even a claim, or a set of claims.

In step 10114, the primary search terms may be identified. The primary search terms may be the claim terms found in the claim identified in step 10112. Alternatively, the primary search terms may also include the element names that the claim terms relate to from the specification of the document. Where the claim identified in step 10112 is a dependent claim, the primary search terms may include the claim terms from that specific dependent claim, and it may also include the claim terms from the independent claim, and any intervening claims.

In step 10116, secondary search terms may be determined. The secondary search terms may include, for example, element names and/or text that are related to the embodiment that the claim relates to. Secondary search terms may also include generally the element names found in the specification of the document. Secondary search terms may also include generally the text associated with the claim that may be found in the specification and related to the embodiment that the claim relates to.

In step 10118, the search term boosting may be configured. There may be postings for the primary search terms and different postings for the secondary search terms. These listings may be adjusted so as to provide for the most relevant documents/embodiments in returned to the user in a search results. For example, the primary search terms may have a boosting of ten. Whereas the secondary search terms for other element names related to the claimed embodiment may have a boosting of four. Thus, the resulting search results will provide the results based on relevancy where the primary terms have a significantly higher boosting than the secondary terms.

Additionally, the secondary terms may have varying degrees a boosting depending on the type of the terms used for searching. Following the prior example, the secondary search for terms for the other element names related to the claimed embodiment may have a boosting of four. The secondary search terms related to the specification text associated with the embodiment the claim is assigned to may have a boosting of two. Moreover, other secondary search terms that may include background information and/or terms that are generally found in documents that have similar classification for the claim may have a boosting of one. By providing varying boosting based on the nature of the search terms used, the primary search terms have the highest impact on the relevancy score. However, the addition of a secondary search terms, and their boosting, also provide for focusing in on and providing slightly higher scores for those documents that are similar to the document/claimed embodiment that is trying to be invalidated.

In step 10120, a search is performed given the primary search terms in the secondary search terms, and their respective boosting. As discussed herein, invalidation searching may be readily applied not only to documents, but to embodiments within the documents. For example, the invalidation search may provide better results to the user when an embodiment search is performed rather than a document search. This is because the embodiment search allows for identification of the embodiments having the search terms, rather than the entire document having search terms. Similarly, a simple figure-based search using the element names associated with the element numbers in each figure may be performed.

In step 10122, the results are provided to the user, where the ranking is determined by the documents responsive to the search terms, and the boosting applied.

FIG. 102 is an example of an invalidation argument generation method 10200. Such an argument generator may be used to search the prior art and determined for example the 102 art (as discussed herein 35 U.S.C. § 102 art may be called “102 art”) available, and the best combination of prior art to form 103 arguments. In general, the method may look for the existence of each of the claim terms found in a single embodiment to provide 102 art. Alternatively, the method may look at art that may not contain all of the claim terms, but contain some of the claim terms, and are readily combinable based on commonalities in the documents or embodiments.

In step 10210, a general search results may be analyzed. For example, the results provided by step 10122 from method 10100 may be used as a starting point for analysis.

In step 10212, the potential 102 results may determined as potential 102 results where the documents/embodiments contain all of the search terms related to the claim terms.

In step 10214, the potential 103 results may be determined where the documents/embodiments contain some of the search terms, but not all of the search terms.

In step 10216, the potential 102 art and potential 103 art (as discussed herein 35 U.S.C. § 103 art may be called “103 art”) may be analyzed to determine their overlap to the claim terms and their overlap to the document for invalidation.

In step 10218, the potential 102 art and potential 103 art may be analyzed to determine the overlap of the technology areas of the embodiments/documents found in the potential invalidating art with the technology area of the document for invalidation, and/or be technology area of the claim of interest for invalidation.

In step 10220, the method may determine the best combinations of potential 102 art and potential 103 art. These combinations may be determined are ranked based on the amount of overlap or the strength of overlap of not only the claim terms of the technology areas, and other factors, such as the general overlap of element names found in each document.

In step 10222, a report may be provided that includes a list of potential 102 art, and a list of the combinations of the potential 103 art. This report may be organized in a manner such that the best art is provided first and the lesser art is provided last. Similarly, the best combinations may be provided first in the lesser combinations may be provided last.

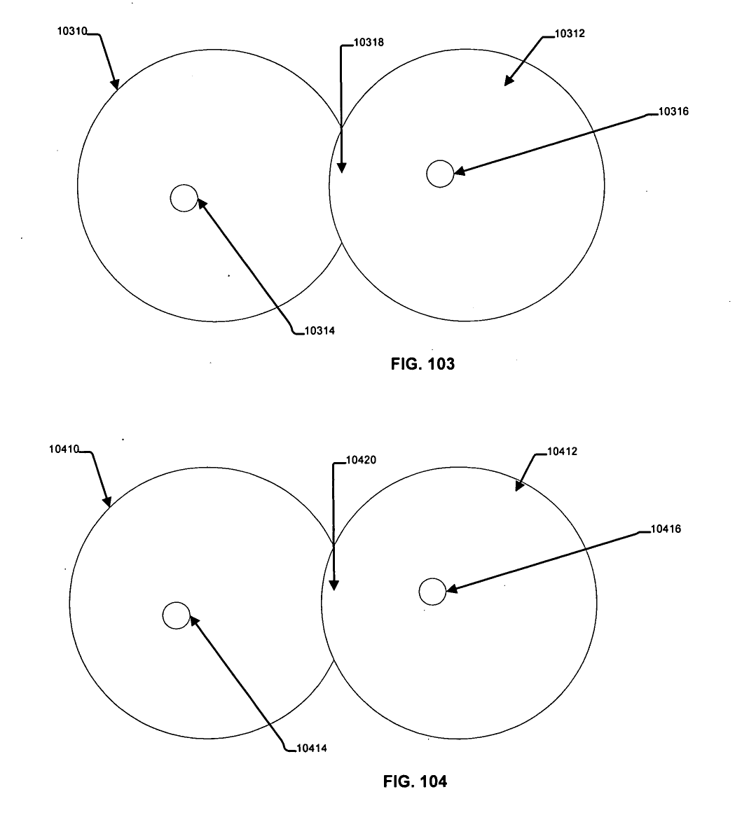

FIG. 103 is an example of a weak combination of 103 art. A first embodiment 10310 from a first document is combined with a second embodiment 10312 from a second document. The claim terms 10314 and 10316 are found outside the intersection 10318 of first embodiment 10310 and second embodiment 10312. However, overlap 10318 of the embodiments is relatively small. Thus, this potential combination of prior art may only be weakly tied to one another, or weakly relevant to a persuasive argument for combination. In another example, a stronger argument may be provided when at least one of the claim terms appear in overlap 10318. As discussed herein, the overlap may be determined based on similar or the same element names as found in each of the documents, the same or similar elements found within embodiments of the documents, and/or similar or the same words appearing in the general text of the document. Overlap may also include similar or otherwise linked classifications of the documents.

FIG. 104 is an example of a stronger combination of 103 art. Here, a first embodiment 10410 is combined with a second embodiment 10412. Both claim terms 10314 and 10316 are found outside the intersection 10420 of first embodiment 10410 and second embodiment 10412. Moreover, the overlap 10420 of first embodiment 10410 and second embodiment 10412 is more significant than the overlap 10318 shown in FIG. 103. Thus, the combination shown in FIG. 104 may be more persuasive when arguing for the combination then the combination shown in FIG. 103. Generally, where the overlap of the technologies of the documents/embodiments being combined is significant or more significant than another combination of prior art, the combination with the greater technology overlap may generally be considered to be stronger combination for invalidation. This is at least because there are stronger arguments for the combination because of the significant technology overlap. In another example, a stronger argument may be provided when at least one of the claim terms appear in overlap 10420.

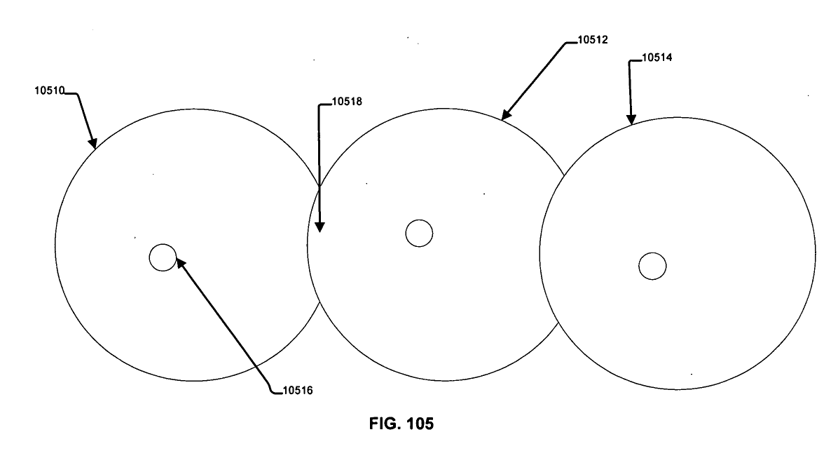

FIG. 105 is an example showing a combination of three pieces of prior to invalidate two claim terms. A first piece of prior art 10510 overlaps 10520 a second piece of prior art 10512. First claim term 10314 is included in overlap 10520. A third piece of prior art 10514 overlaps 10522 second piece of prior art 10512. However, a second claim term 10316 is included only and a third piece of prior art 10514. The prior art is combinable at least because each piece of prior art overlaps another piece of prior art. The greater the overlap, the more persuasive the argument is for the combination.

Referring now to FIG. 106, an algorithm for a search system according to an embodiment of the present invention is shown and described. In FIG. 1, a process is employed by server/processor 210 in accordance with the flow chart illustrate therein. In step 10610, the user selects from classifications or conducts a keyword search. In an embodiment, classifications represent organizations of documents according to particular types. In one example, each classification represents US Patent Office or a foreign patent office classification of a particular set of patent documents related to a particular technology type, such as transmissions for example in the USPTO Manual of Classifications. It will be understood that other types of classifications are contemplated by the embodiment. For example, the classifications may represent certain types of medical records or SEC documents.

With continued reference to FIG. 106, the user selects the desired classification by selecting a checkbox or other indicator provided by the graphic user interface associated with display for user 220 in step 10610. For example, an index for the USPTO (United States Patent and Trademark Office) Manual of Classifications may be displayed on display for user 220 from which the user checks or otherwise selects from among a series of buttons or other means displayed on display for user 220 that are associated with and allow selection of each classification. In one example, as shown in FIG. 140, the user selects a classification, such as Classification 337, by selecting a selection box 2220. Upon selection of the selection box 2220, server/processor 210 conducts a search through a database of patents or other documents stored on or otherwise interfacing with server/processor 210 for those documents that fall within the selected classifications. Server/processor 210 returns results to the display portion that represent those patent documents that fall within the selected classifications in the form of a results view as will be discussed.

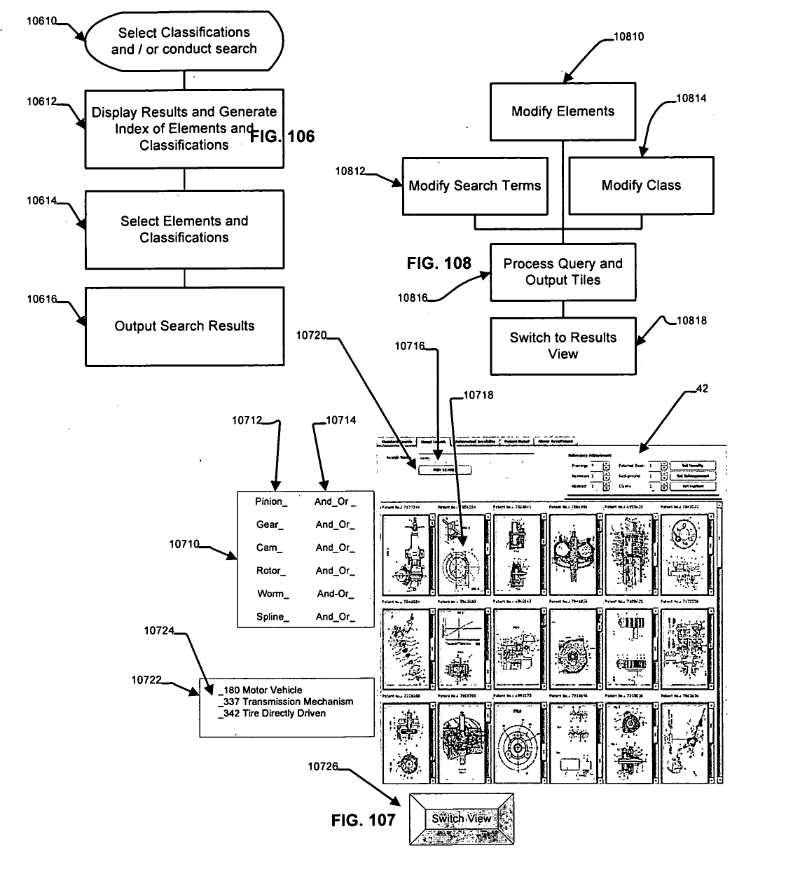

In another embodiment, a keyword search is conducted by entering the desired key words in, for example, search screen 10716 of FIG. 107. Search button 10720 is then selected to execute a search based on the search terms entered therein. In response to selection of the search button 10720, server/processor 210 conducts a search through its database of patents or patent information or a database in communication thereto to identify and return search results that meet the search query.

The patents, in one example, are indexed in accordance with the elements, words and numbers found therein as well as certain characteristics related thereto. The patents or patent applications are indexed according to the elements, numbers and words located in the specification, claims (which claim), abstract, brief description of the drawings, detailed description, summary, abstract, and the drawings (including which figure). The elements, in one example, are noun phrases found in each of the patents or patent applications being searched. In another example, the elements are noun phrases found adjacent to element numbers. In one example, element numbers may be identified as those single or multiple digit numbers adjacent a noun phrase. This information may be obtained through lexical parsing of each of the patent documents and storage of the information as metadata associated with each patent document. Accordingly, metadata may be stored for each word or element related to this information. Other examples may be found in the Related Patent Applications.

In another example, the drawings associated with the text portion of the patents may be indexed according to figure location, figure numbers and element numbers in each of the figures. This information may be stored as metadata associated with each of the individual figures or figure pages. All of this information may be read in through an Optical Character Recognition program and the underlying data may be obtained through a lexical parsing algorithm as will be generally understood by one skilled in the art or as described in the Related Patent Applications.

In general, and as described in the Related Patent Applications, the element numbers found in the drawing (e.g., through OCR, metadata associated with the drawings, and/or text related to the drawings) may be related to the names, or element words, found in the specification. The element numbers may also be related to, for example, the claim terms that match the element names associated with the numbers, or claim terms that are similar to the associated element names from the specification.

The relation may be on a figure-by-figure basis, or the relations may be on a drawing-page basis. When relating based on the figures, each figure may have its own set of metadata associated with it. The metadata for each figure may then be used to determine the metadata (e.g., element numbers) for each drawing page. Alternatively, when relating the element numbers on a drawing-page basis, each element number and the associated name from the spec and/or claims may be associated with the drawing page. Although the figure-by-figure relation may provide more precision for various search methods, the drawing-page relation may be advantageous depending on the implementation of the search method.

Each of the relations, e.g., figure-by-figure or drawing-page based relations may be used in the search algorithm to determine relevancy. For example, when a user is searching for a particular combination of terms, the figure-by-figure analysis may lead to rankings based on each figure of all of the set of documents searched. Alternatively, when a user is searching for a particular combination of terms, drawing-page based analysis may lead to rankings based on each drawing page of all of the set of documents searched. In determining relevancy, boosting may be used on a figure-by-figure bases or a drawing-page basis.

In step 10612, the results from the aforementioned search as well as an index of classifications and elements are provided by the server/processor 210 to the display for user 220. The elements are those that are found in the patents returned from the classification or keyword search. Be understood, however, that search results contemplated by the present application also include the formats as described in the Related Patent Applications with or without an element listing.

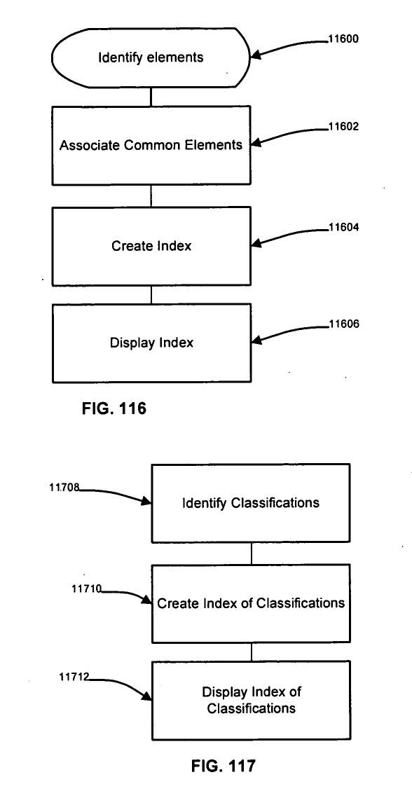

FIG. 116 illustrates one example of an algorithm employed by server/processor 210 for identifying and displaying a listing of elements associated with all of the patents returned from the search conducted in FIG. 1 or any other portion of this or the Related Patent Applications. In FIG. 116, the algorithm begins with step 11600 where the elements found in each of the patents or patent applications are identified.

The elements may be identified through the means discussed in the Related Patent Applications incorporated herein by reference or other means. In one example, the elements are identified through identifying noun phrases or other word schemes either accompanied with element numbers or independent therefrom. Thus, in one example, each noun phrase adjacent an element number is considered by server/processor 210 as an element and accordingly tagged as such by any known means as for example updating or providing metadata that identifies the word or words as such. The patents or patent applications may be pre-processed or simultaneously processed by server/processor 210 to identify each set of words that is an element and to provide metadata identifying the element as such.

In step 11602, each of the elements are associated with the other elements having the same word identifiers or noun phrases. For example, if one patent contains the element “connector 12” and another patent contains the element “connector 13”, each of those elements are linked or indexed by a common word such as connector by server/processor 210 as will be described. In one example, the metadata of each associated element may be modified to link the elements and their locations into a searchable format. In another example, variance from the element name is permitted by the server/processor 210 such that slight variations of element names, such as “connector” and “connectors” is considered as the same element name for indexing purposes. In step 11604, the elements identified are indexed against the element name by server/processor 210 without the corresponding element numbers such that each element name is indexed against all of the patents in which such element are found. Therefore, in one example, patent A contains the element “connector 12” and patent B contains the element “connector 13.” An index term “connector” is provided by server/processor 210 on display for user 220 which is indexed against the occurrences of “connector 12” and “connector 13” in patent A and patent B respectively to allow subsequent searching or processing by server/processor 210 as will be discussed.

In step 11606, an index is displayed on display for user 220 listing each element index term for the patents. For example, the term “connector” would be listed and indexed against patent A and patent B. Likewise, all element names are listed for the patents found from the search conducted in step 10610. Thus, in one example, display for user 220 provides a listing of the elements found in the patents returned in response to the search conducted in step 10610.

In FIG. 117, an algorithm for identifying and indexing the classifications employed by a collection of patents or other documents is shown and described. In step 11708, each of the patents stored on the database of server/processor 210 or accessible by server/processor 210 are indexed by the classification in which such patents fall. Thus for example, if patent A falls within class 1 and patent B falls within class 2, those patents are searchable by searching for the respective class numbers 1 and/or 2. The indexing may be accomplished by providing each patent document with accompanying metadata that identifies the respective classification number or name for that patent or patent application. In one example, the text in each patent document in the database is recognized through an optical character recognition program and data representing the classification is identified from the cover page of the patent. For example, the specific location or other defining feature that uniquely identifies the classification may be searched and the corresponding classification may be read in. In one example, the patent is reviewed for the terms “U.S. Class” and the subsequent number is identified by the server/processor 210 as the classification and stored with the metadata for that patent.

In step 11708, the patents are searched for the desired classification in response to selection of that class in step 10610. In step 11710, an index of the classifications found in the patents that fall within the desired classification is created by server/processor 210 In step 11712, that index of classifications is displayed on display for user 220.

It will further be understood that the display by display for user 220 may be any display including a hard print-out copy or remote storage on a DVD or flash drive. It will also be understood that the terms patent and patent application are used interchangeably herein and that reference to a patent application herein may also include an issued US or other country patent or any other document such as SEC documents or medical records.

Referring to FIG. 107, one example of a results display and index is shown and described. In FIG. 107, display for user 220 provides a results display in response to the above reference process or any other process described in this or the Related Patent Applications. In FIG. 107, tiles 10718 represent the patents returned from the search conducted in step 10610. Each of the tiles 10718 represents an individual patent returned in response to the search.

In one embodiment, each of the tiles 10718 displays the figure in that patent that is most relevant to the search conducted in step 10610 with header information including patent number, issue date and other pertinent information. The tile is also labeled with the element words associated with any of the element numbers on that displayed figure.

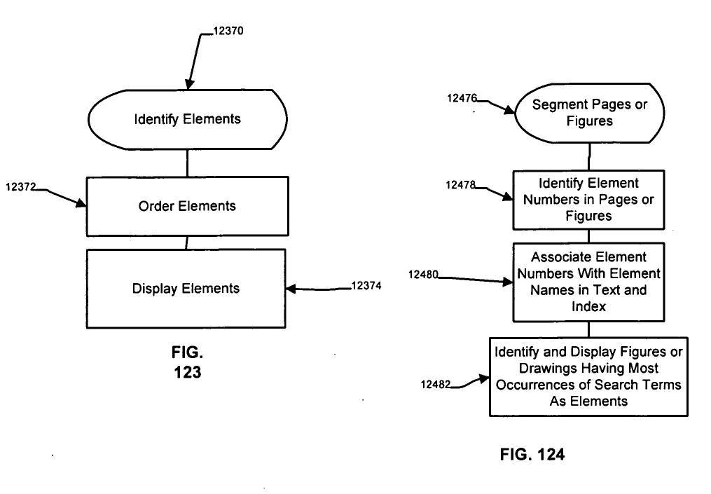

In one example, as shown in FIG. 124, a process for identifying and displaying the most relevant figure or drawing in a patent shown and described respect to FIG. 124. In FIG. 124, the process begins with step 12476 where each figure or figure page of a patent application is segmented by server/processor 210 such as, for example, by providing a bounding box or metadata relating to that particular figure or figure page that identifies that figure or figure page as independent from the others.

In step 12478, the element numbers in each figure or page are recognized by a process such as an optical character recognition process and data representing those element numbers are stored as metadata for that figure or figure page.

In step 12480, the element numbers for each figure are matched to the element names in the text by commonly associating the element numbers a text with respect to the element numbers in the metadata associated with each figure or figure page. The metadata for each figure or figure page is updated to include the element names and is indexed or searching by the element names and occurrences of the elements.

In step 12482, server/processor 210 conducts a search the metadata associated with each of the figures or figure pages to match the search terms with the element names. Server/processor 210 identifies figures or figure pages having the most occurrences of the search terms that match the elements. Server/processor 210 then updates the metadata for that figure to identify it as the most relevant figure for the search and/or provides the identified figure to the display for user 220 as the most relevant figure or drawing.

It will be understood that other processing methods may be employed to identify the most relevant drawing and that described herein is merely an example. Also, in one example, server/processor 210 labels the figure or figure page with the element names from that stored in the metadata.

As shown in FIG. 107, an element listing 10710 is provided that includes each element found in the patents represented by the tiles 10718. In one example, one entry for each element is provided such that if an element, such as “pinion 42” in one patent and “pinion 54” in another patent is identified, element listing 10710 includes the entry “pinion” that refers to both of the previously mentioned elements. As such, in one example, the elements of all of the patents uncovered through the search are displayed in the element listing 10710. The elements in element listing 10710 further may be organized or grouped by server/processor 210 according to technology area or other categorization, alphabetical order, or frequency of occurrence.

For example, referring to FIG. 123, the elements to be organized are identified in step 12370 by server/processor 210. Such elements may simply be the elements identified with respect to FIG. 116 or individually selected by a user or the server/processor 210. In step 12372, the elements are organized. In one example, the elements are grouped according to frequency of occurrence. Here, the elements are reviewed by server/processor 210 to determine the highest number of occurrences of each element among all of the patents represented by tiles provided in step 10616 of FIG. 106. For example, if the element “pinion” is found within the patents 50 times, and the element “gear” is found 40 times, the element “pinion” may be listed first from top to bottom in element listing 10710 by server/processor 210 if the user desires the element listing 10710 to be listed in accordance with frequency of occurrence. In another example, the element listing is organized in accordance with the element boosting conducted through boosting mechanism 42. Thus, the relevancy equation conduced by server/processor 210 with respect to the most relevant patents is also run against the patents for each of the elements and the highest ranked element is listed first in the element listing 10710.

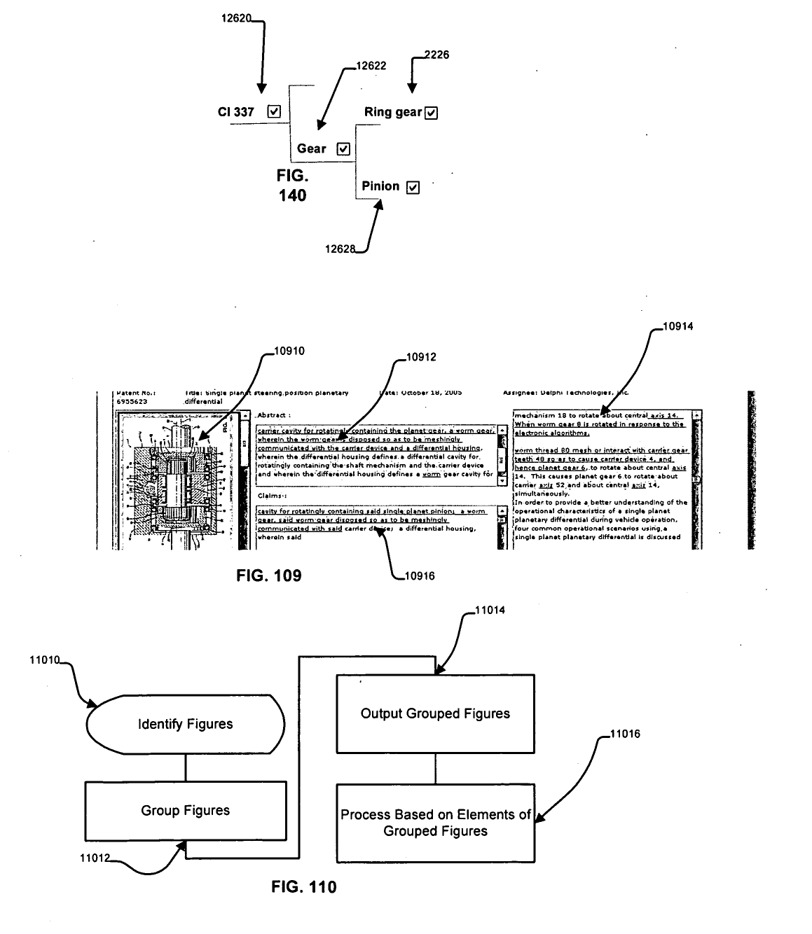

In another example, the elements are classified by server/processor 210 in categories. For example, the element “pinion” may fall under the general element “gear” and may be positioned in for example an expanding tree diagram. In this way, similar words such as “pinion” and “ring gear” and “gear” may be placed together or in an organized structure to allow the user to see all the terms used in a particular selected classification. With respect to FIG. 140, elements returned in response to the search conducted in step 10610 are shown displayed in a tree format on display for user 220. In one example, elements returned from the search conducted in step 10610 includes elements “gear”, “ring gear” and “pinion”. In the example, “pinion” and “ring gear” are subsets of the more general element “gear” and therefore position in the tree as pinion 12628 and ring gear 12626 as a subset of gear 12622. Selection boxes are provided for selection such that further searching, as will be discussed with respect to FIG. 109, may be conducted. For example, selection box 12626 is provided for the element “gear” and may be selected to include both ring gear 12626 and pinion 12628 in a further search. Or, just the selection box 2228 for the element pinion or selection box 2226 for the element ring gear may be selected if those are the only elements desired by the user for further searching. Accordingly, in one example, all similar elements to the term gear that are available in the field of search are provided such that the user can select among all such elements to refine the search. One skilled in the art will realize that the above is just an example and that other terms and similar terms may be used or organized.

In yet another example, selection box 2220 for classification 337 is a superset that includes pinion 2228, ring gear 2226 and gear 2222. Selection of the selection box for classification 337 conducts a search, as will be discussed, for all the elements found within the classification 337. As such, the user is provided with all elements found in each patent falling under classification 337. Thus for example, if the user were to select class 337 in step 10610, then display for user 220 would displayed the selection box 12620 for classification 337 and all elements in all patents that fall within classification. By this way, the user is able to select the classification and see all the elements be found within their classification. In one example, the tree view shown in FIG. 140 is expandable and contractible such that the user can display the lower or only the higher levels of the tree.

In step 10614, the user is able to update and modify or refine the search conducted in step 10610. In step 10614, the user selects desired elements from element listing 10710, or the tree view in FIG. 140, by checking on the selection box associated with a desired element. As described previously, each of the elements listed in element listing 10710 or the tree view of FIG. 140 are indexed against the patents returned from the initial search conducted in step 10610 and represented by the tiles 10718. It will be understood that element listing 10710 is understood to include the tree view of FIG. 140 or any other suitable means for displaying the elements found from the search conducted in step 10610.

And/or selector boxes 10714 are provided to allow the user to search for desired elements in either as an “and” search or an “or” search. In response to selecting the desired selection boxes and executing the updated search, the server/processor 210 refines the search results represented by the tiles 10718 to include only those elements that include the selected elements in either an “and” configuration where all the elements must be found or an “or” configuration where any of the elements must be found. For example, if the user desires to search for patents containing the terms “pinion” and “gear” from element listing 10710, the user would select the checkboxes for elements “pinion” and “gear” and select the “and” checkbox in the and/or selector 10714. Likewise, if the user was interested in the terms “pinion” or “gear”, the user would select the checkboxes for elements “pinion” and “gear” and select the “or” checkbox in the and/or selector 10714.

In response to the above described selection, server/processor 210 searches the metadata associated with each of the patents represented by the tiles 10718 for the patents that include the additional search terms and updates the search results such that the tiles 10718 provided in the search results of FIG. 108 include only those patents that satisfy the search criteria such as, in the above example, the terms “pinion” and “gear” or “pinion” or “gear.”

Class selector 10722 is provided to allow the user to update the search based on classifications. In one example, the user may select from the classifications listed in class selector 10722 to further modify the search based on the classifications listed in class selector 10722. The classifications listed in class selector 10722 include the classifications in which each of the patents represented by the tiles 10718 fall within. It should be noted that the classifications listed in class selector 10722 may include standard US Patent and Trademark Office classifications either in the general search field or the specific classes that were searched to obtain the patents found by the examiner. The classifications may also include foreign or other classification systems besides the specific ones used to conduct the initial search. Therefore, if the user is interested in particular classifications, the user can select from the desired check boxes associated with the desired class from class selector 10722.

In response to the desired selection conducted in step 10614, server/processor 210 conducts a search through all of the patents represented by tiles 10718 that satisfy the desired search. It will be understood that such a search may be conducted with the relevancy parameters as described in the prior applications incorporated herein by reference.

In step 10616, server/processor 210 provides a display for user 220 with the specific tiles that satisfy the search parameters discussed above. In one example, the tiles 10718 displayed are those that satisfy selection of us that they classifications or elements selected in connection with the above referenced figures.

Referring to FIG. 108, an example for adding, changing or modifying the search conducted with respect to FIG. 106 is shown and described. In the example depicted in FIG. 108, the process begins with any one of or all steps 10810, 10812 and 10814. For example, in step 10810, the user may select the desired elements from element listing 10710 displayed on display for user 220. In step 10812, the user may enter search terms or queries in search screen 10716 to further modify the search results. Or, in step 10814, the desired class listing may be modified through selection of the desired classifications in class selector 10722. In step 10816 and in response to this selection, server/processor 210 conducts a search through the patents represented by the tiles 10718, provided in response to the most recent search, that meet the election query and displays the patents in the form of those tiles 10718 on the display for user 220. In step 10816, after the search query is processed, server/processor 210 outputs the tiles to display for user 220 that represents the search results. Such results may be provided in accordance with that described in the Related Patent Applications or in the present application.

In one embodiment, in the process described with respect to FIG. 108 is repeated until a desired number of search results is returned. For example, if the user desires to review no more than 100 tiles or feels that the number of tiles is sufficient for review, then the process described with respect to FIG. 108 is conducted until only 100 tiles remain. Thereafter, the switch view button 10726, displayed on display for user 220, may be selected to switch the search results from tiles 10718 into a more detailed set of search results as described in Related Patent Applications and, in one example, from that shown in FIG. 107 to that shown in FIG. 109. In FIG. 109, a search results view is provided that includes the most relevant drawing 10910, most relevant portion of the specification 10912, most relevant portion of the claims 10916 and the most relevant portion of the detailed description 10914.

Referring now to FIG. 110, another embodiment of the present invention is shown and described. In FIG. 110, an algorithm is provided for identifying embodiments or grouping figures in a patent application or other document. In one example, the patent or patent application or other document comprises a number of different figures or embodiments. Regarding embodiment, each embodiment represents a variation in the invention described in the patent or patent application. One skilled in the art will readily recognize and understand the term “embodiment” as used herein. However, it will be understood that the present embodiments may be used in accordance with other documents that are divided among different categories or inventions.

Accordingly, in one example, the algorithm begins in step 11010 where specific figures are displayed on display for user 220. Each of the figures includes element numbers identifying a number of different elements in the figure. The elements themselves are particular features or components in the drawings that are identified by element numbers in the drawings and described by element names in the text. In one example, the text portion accompanies the figures and provides the names of the elements adjacent the element numbers that are used in the drawings to refer to the actual elements. As such, in one example, the server/processor 210 identifies the element names by linking the element numbers in the drawings to the element names in the text portion through the element numbers positioned adjacent to the element names in the text.

The element names and element numbers text portion are indexed by a metadata that represents the element name, element number and its location in the text. Similarly, the element numbers in the drawings are indexed by metadata that provides location of the element number and figure number in the drawing, the actual element numbers and figure numbers and/or page number. Accordingly, server/processor 210 may conduct a search through the metadata associated with each of the figures and text portion to associate the names in the text portion to the elements in the drawings through the element numbers.

Desired figures or figure pages determined by a user to fall within a particular embodiment are then selected by a user or the server/processor 210. For example, or the user believes FIGS. 106 and 107 to fall within the same embodiment, the user can select those figures. Or, as will be described with respect to upcoming embodiments, the user can simply select a number of different figures for any purpose, such as if the user is interested in those figures. In one example, each of the figures is accompanied by a selection box or other selection means that allows a user to identify or select that particular figure or figure page. The selection box is linked to the metadata associated with the selected figure. Thus, in one example, the metadata associated with the selection box selected includes a specific figure numbers and element numbers associated with that figure. In another example, the metadata for each of the figures also includes the element names associated with the element numbers in the text portion. In step 11012, server/processor 210 tags the selected figures as being associated together for further processing as will be described. This may be accomplished through any known means such as updating of the metadata for each of the figures or storing data relating to the figures in the same storage location or file. For example, a user may select FIGS. 106, 107 and 108 among ten different figures and the server/processor 210 responds in step 11012 by tagging all of the selected figures as being associated. In one example, the tagged figures are associated by the server/processor 210 as the same embodiment.

In step 11014, the embodiments or selected figures are output for further processing, storage or use. For example, such further processing may include FIG. 110 where a search is conducted based on the selected figures or embodiments. The grouped figures may be stored or categorized for later processing or use.

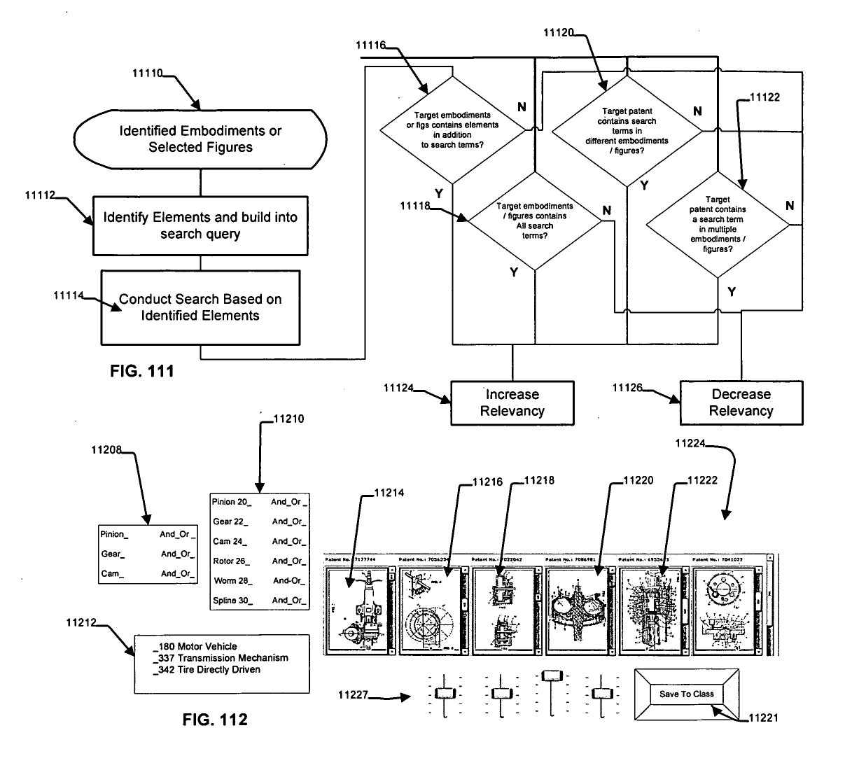

Referring now to FIG. 111, a process for conducting a search based on embodiments or selected figures, generated in FIG. 110 for example, is shown and described. In FIG. 111, the process begins at step 11110 where identified embodiments or selected figures are input or received by server/processor 210. The process begins at step 11110 were either the grouped figures are input to the server/processor 210. In step 11112, the elements that are associated with the figures of the embodiment or selected figure are identified. More specifically, the element names associated with each figure are placed into a search query format by processing portion.

In step 11114, a search is conducted through the database of server/processor 210 or a database for which server/processor 210 as access. The search that is conducted is based on the element names associated with the selected figures or embodiment. The conducted search may review each patent in the database in accordance with the Related Patent Applications or any of the search strategies employed as discussed in the present application. As mentioned previously, each of the patents stored in the database associated with server/processor 210 are indexed according to the elements found within the patent as well as the elements that are found in both the specification and the drawings. Accordingly, search conducted in step 11114 is performed by comparing the elements in each of the patents with the search terms to determine whether or not a match exists therebetween. In one example, each of the elements is reviewed to determine whether or not any of the search terms are the same as or a subset of the element. For example, if the element is “connecting rod” and to the search term is “rod”, then in one example, a match between the search term and that patent is found.

In one example, the search results provided in response to the search are ranked in accordance with relevancy based on steps 11116, 11118, 11120, and 11122 of FIG. 111. A “yes” determination from any of these steps results in increased relevancy while a “no” response results in a decrease in relevancy for the search results.

In step 11116, the searched or target patents are reviewed for whether they contain embodiments or figures having elements in addition to the search terms or a subset of the search terms. For example, the target patents may be dissected according to embodiments as described with respect to FIG. 110. Therefore, if the search terms are A, B and C, and the target embodiment or any figure contains elements A, B and D, then in such an example, there is one element in addition to the search terms. The more elements in addition to any of the search terms, the lower the relevancy of that patent.

In step 11118, relevancy determination of the target patents is determined based on whether the search terms are located in the same figures or embodiments in the target patents. For example, the embodiments or figures of the target patents are reviewed to determine whether or not all of the search terms fall within a single one of either the figures or embodiments of the target patents. As more of the search terms are not found in any one of the target figures or embodiments, relevancy decreases. The more that the search terms are found in the same embodiment or figure, the higher the relevancy of the patent to the search. In one example, a first target patent contains search terms A, B and C as elements in one figure. Server/processor 210 considers this first patent more relevant than a second patent having search terms A and B as elements in a figure.

In step 11120, the server/processor 210 determines whether or not the entire search string is distributed among multiple figures or within a few figures. For example, the search terms are A, B, C and D. For a first target patent, A and B are found in a first figure or embodiment while C and D are found in a second figure or embodiment, and for a second target patent, all the search terms are found in the same figure, the second patent will be deemed to be more relevant than the first patent. As such, the more distributed the search terms are among different figures or embodiments, the less relevant that target patent will be deemed to be to the search. Likewise, the more the search terms are found in the named embodiment or figure, the more relevant that patent will be deemed to the search. It will be noted that the use of search terms as elements as used herein also can include the use of search terms as subsets of elements.

In step 11122, the target patents are reviewed to determine whether or not any of the search terms are used as elements in multiple figures or embodiments. For example, if a search term is located in a number of different figures, then this result will be deemed more relevant than a patent where a search term is located in only one figure. As such, target patents are more relevant with respect to the number of different figures in which a search term may be found.

In one example, the figures may be normalized based on the number of figures in the target patent. For example, where a first patent has a search term in five figures and has a total of 10 figures, this would result in a two to one ratio. Where a patent has a search term occurrence in two figures of a four figure patent, the ratio would again be two to one. In this example, through normalization, the first patent would be deemed to have the same relevance as the second patent for the particular search. One skilled in the art will recognize other normalizations schemes that may apply hereto.

In addition to the determinations described above, server/processor 210 looks to synonyms of the search terms and reviews the target patents to determine whether the exact search term or such synonyms are found therein. If synonyms are found, the relevancy of the target patent is lower than if the exact search term is found.

Also, relevancy determination may be made based on the boosting algorithms described in this application or any of the Related Patent Applications. For example, the target patents may be reviewed to determine where in the specification, claims, drawings, abstract, summary or title search terms are used, and relevancy may be applied to the target patents based on this usage. It will also be understood that usage may be normalized according to the number of words in a particular text portion. For example, a search term occurring twice in a four hundred word text portion of a target patent may be given the same relevancy as a search term occurring four times in eight hundred word text portion.

The relevancy determination may also include grammatical usage such as whether the search terms are being used as a noun phrase or a verb phrase in the target patents. For example, where a search term is used in the target patents primarily as a noun phrase, such a patent may be provided with a higher relevancy by server/processor 210 and a patent that primarily uses the search terms as verbs or verb phrases. Relevancy of the search terms may also be based on proximity of the search terms to each other. for example, where the search terms are located close together in a target patent, this patent may be deemed to be more relevant than a patent in which the search terms are distributed in a broader fashion. It will also be understood that the relevancy ranking applied to this embodiment may be applicable to any other embodiment including that described with respect to FIG. 106.

In response to the above described process conducted by server/processor 210, server/processor 210 will tag or identify the patent as more or less relevant in steps 11124 or 11126.

Referring now to FIG. 112, an embodiment for the results of the search conducted in FIG. 111 a show and described. In FIG. 112, a series of tiles 11214-11224 are shown depicting individual patents returned from the search conducted in FIG. 111. In one example, the figures are organized in accordance with relevant such that relevancy increases towards the left of the figure and decreases towards the right of the figure. Therefore, the patent represented by tile 11214 is more relevant than the patent represented tile 11224.

An element listing 11210 is provided on display for user 220 that includes all the elements found in any of the patents represented by tiles 11214-11224. As such, selection of the element and the and/or selection box in the element listing 11210 causes the server/processor 210 to adjust or change the search results represented by tiles 11214-11224 based on the occurrence of the selected element as described in previous embodiments. Similarly, a search term listing 11208 is provided that includes all of the search terms used in connection with the search conducted in step 11114 for a FIG. 111. Accordingly, selection of selection boxes in the search term listing 11208 causes server processor 210 to adjust the search results represented by the tiles 11214-11224 provided in FIG. 112. It will be understood that the tiles displayed that represent the patents may also be changed to represent the most relevant drawing to the selected elements from element listing 11210 and/or search terms from search term listing 11208. Additionally, a class selector 11212 is provided that encompasses all the classifications included in the patents represented by tiles 11214-11224. Accordingly, selection of individual classifications from the class selector 11212 may also cause the server/processor 210 to adjust the search results in accordance with previously described embodiment.

In FIG. 112, adjustments, in one example in the form of sliders 11227, are provided to truncate the overall results displayed on display for user 220 in the form of tiles 11214-11224. In one example, each of the sliders 11227 represents a different step 11116, 11118, 11120, or 11122. Specifically, adjustment of any one of the sliders truncates the results based on that step. For example, increase of one of the sliders 11227 relating to step 11116 truncates a result after a certain number of elements is found in a figure beyond the search terms. Moving the slider 11227 waiting to this step increases or decreases the allowable number of elements in addition to the search terms found in the figures of the target patent. For example, the search terms are A and B, and one target patent includes a relevant figure that has elements A, B, C and D and a second target patent includes elements A, B, C, D and E, the slider may be positioned such that the first patent is returned in the search results while the second patent is not. Or, the slider may be adjusted such that both patents are in the search results. One skilled in the art will readily recognize the application of the sliders 11227 to the other steps of FIG. 6.

Referring now to FIG. 112 and FIG. 119, the search results shown in FIG. 112 through tiles to 11214-11224 may be saved to into or as a classification. In FIG. 112, save to class button 11221 is selected to save the patents represented by tiles 11214-11224 a classification. One example for accomplishing this task is identified in FIG. 119 where an algorithm executed by server/processor 210, executed in response to selection of save to class button 11221, begins with step 11942 where the user selects patents to be saved into a classification. In step 11944, a desired classification in which to save the desired patents is specified. This classification may be An Existing US Patent and Trademark Office Classification or a user created classification. In step 11946, the user saves the patents represented by tiles 11214-11224 to the selected classification.

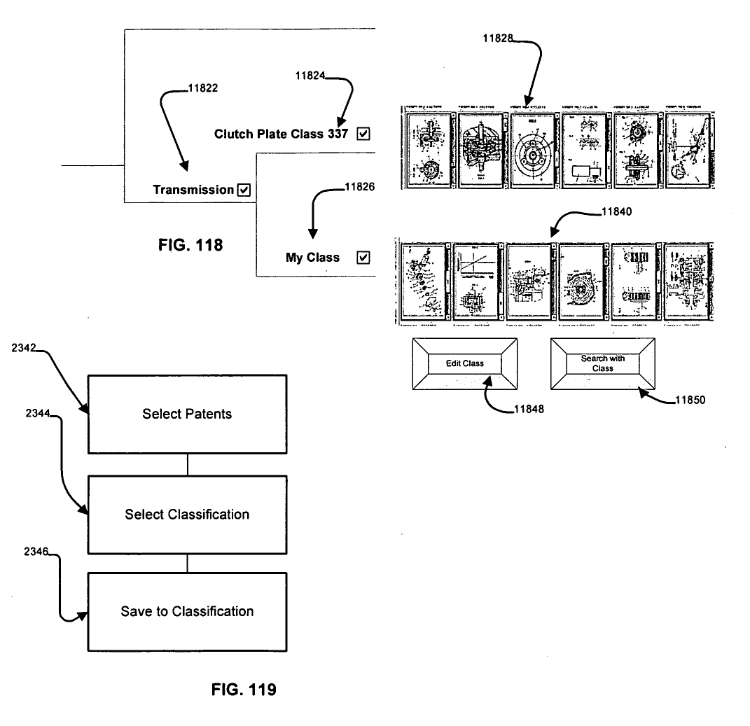

With reference to FIG. 118, various classifications for which any selected patents, embodiments or search results from a process identified in FIG. 106 or other places in this or the Related Patent Applications may be saved. In FIG. 118, a number of different classifications are shown in a tree view and displayed by display for user 220. For example, a user created class, my class 11826, is provided with a series of tiles 11840. USPTO clutch plate class 11824 is another classification provided that includes tiles 11828. Classifications 11824 and 11826 are shown in subsets of transmission class 111822.

With continued reference to FIG. 118, a user is able to either edit the patents in a classification by selecting the desired class and the edit the class button 11848 or in a search based on the desired classification by selecting the classification and the search with class button 11850. If the classification is edited as described above, users able to view tiles representing each patent in the classification and removing patents by selecting the desired tile and deleting.

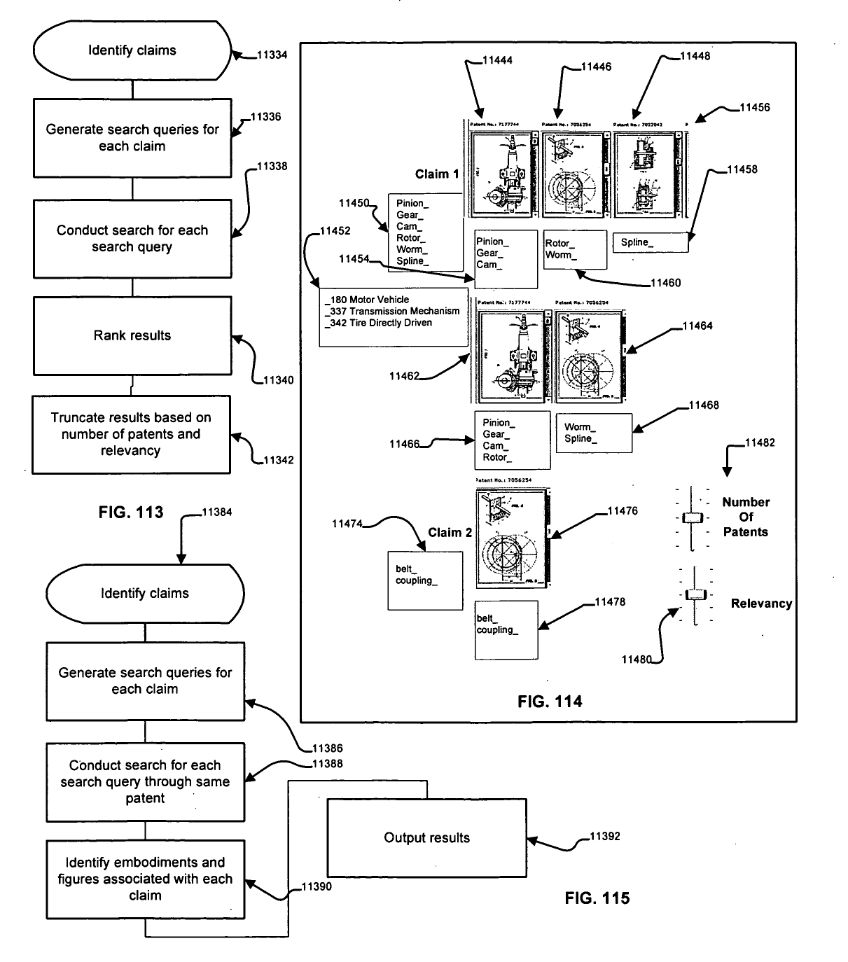

Referring now to FIG. 113, another embodiment of the present invention is shown and described. In FIG. 113, server/processor 210 conducts a search based on claims in a patents or patent application. The process begins in step 11334 where specific claims for searching are identified. In step 11334, either a user can manually select specific claims or server/processor 210 can identify claims through means as discussed in the Related Patent Applications.

In step 11336, search queries are generated based on the selected claims. In one example, the noun phrases for the selected claims are identified and formulated into a search query. Thus for example, a search query for a particular claim would include all of the noun phrases in that claim.

In step 11338, a search is conducted based on the search query created in step 11336. The search is conducted through the listing of patents or patent applications stored in the database of server/processor 210. Such a search may be accomplished through any of the relevancy determination algorithms described in this application or any of the Related Patent Applications.

In step 11340, search results are provided that represent the patents identified with respect to the search conducted in step 11338. The search results may be displayed in accordance with any means discussed in this application or the Related Patent Applications.

In step 11342, the search results are truncated based on a number of patents desired in the relevancy of those patents to the search query.

In one example, as shown in FIG. 114, the search results are broken out according to claim number. In FIG. 114, the results for claim 1 are shown to include tile 11444, 11446, and 11448. Likewise, claim 2, the search results are shown to include tile 2170. In one example, the search terms and based on claim one are shown as search term listing 11450. Each tile from left to right, in one example, comprises the figures that provide all of the elements in search term listing 11450. For example, tiles 11444 and 11446 are from the same patent and provide the elements pinion, gear, cam, rotor, worm. Tile 11448 provide to the remaining search term spline. As will be understood, tiles 11444, 11340, and 11448 comprise 35 USC Section 103 rejection criteria. To allow a user to understand elements contained in each tile, legends 11454, 11460 and 11458 are provided under each tile. Further, selection of the elements in search term listing 11450 modifies the search results shown by the respective tiles to include or exclude the selected elements. For example, if all of the search term listing 11450 are selected except for spline, then only tiles 11444 and 11446 and not tile 11448 will be displayed. Similarly, class selector 11454 may be used to add or remove classifications and corresponding patents from the search results.

With continued reference to FIG. 114, the tiles having elements corresponding to claim 2 are shown as tile 11476. Similar to that described with respect to claim 1, a search term listing 11474 is based on noun phrases of claim 2 is provided. A legend 11478 is also provided though the terms found in that tile.

Tiles 11462 and 11464 represent a second set of search results having the elements and shown by tile legends 11466 and 11468.

Relevancy fader 11480 may be used to increase or decrease the number of search results based on any of the relevancy algorithms described this patent application or the Related Patent Applications. Likewise, the number of patents fader 11482 may be used to adjust a number of patent is returned in response to the search. For example, if the user desires no more than one patent to be displayed in response to a search, the fader may be so set and in response, only patents employing all of the search terms will be displayed by display for user 220.

Referring now to FIG. 115, another embodiment of the present invention is shown and described. In FIG. 115, an algorithm employed by server/processor 210 is described for identifying figures and embodiments associated with each claim in the same patents or patent application. In FIG. 115, the algorithm begins with step 11584 where the desired claims are identified similar to that as discussed with respect to FIG. 113. In step 11586, a search term is generated based on the selected claim similar to that discussed with respect to FIG. 113. In step 11588 a search is conducted through the patents or patent application in which the claim applies to identify the embodiments and figures associated with that particular claim. In step 11590, the embodiments and figures associated with the claim are identified. And in step 11592, the results of such search our output. In one example, a report is generated by display for user 220 that shows the claim text and adjacent thereto is provided the relevant figures and text portions.

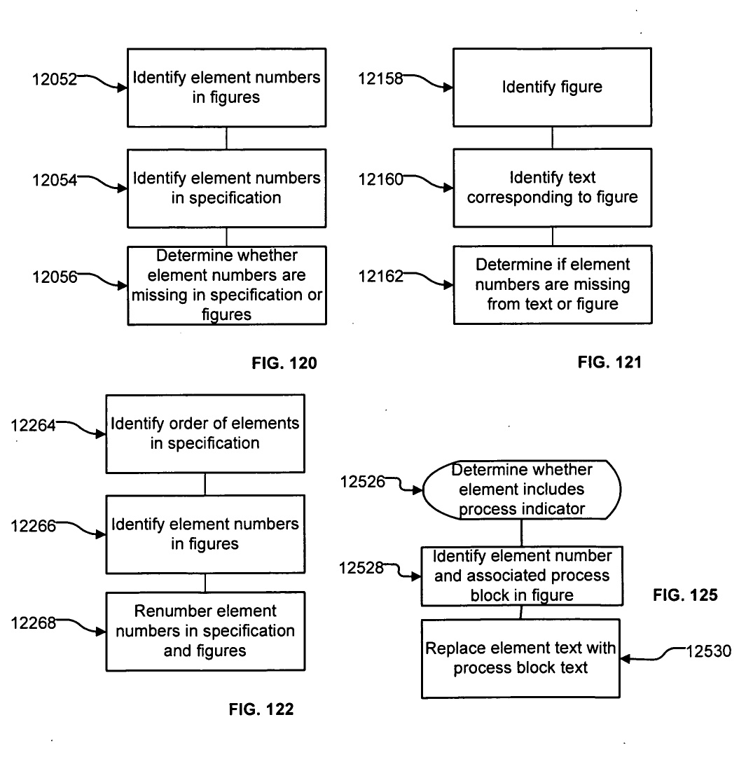

FIG. 120 shows an example of a flow chart for determining missing element numbering. Using the concepts identified below with respect to FIGS. 121 and 122, the method may identify whether element numbers are missing from the specification or figures.

In step 12052, the method identifies the element numbers present in each figure. The element numbers may then, for example, be associated with a data structure identifying each figure, and associated the element numbers found with each figure. Alternatively, metadata may be assigned to each figure that includes the element numbers found.

In step 12054, the element numbers are identified in the specification. The element numbers may be, for example, stored in a data structure or list.

In step 12056, the method determines whether there are element numbers missing from the specification or figures. For example, where the figures include element numbers 10, 12, 14, and the specification includes element numbers 12, 14, 16, the method determines that element number 10 is missing from the specification and element number 16 is missing from the figures. Such checking and determining may be done at a global level (e.g., the whole specification checked against the whole set of drawings, and/or vice versa) or it may be on a figure-by-figure basis (e.g., FIG. 1 may be checked against the text in the specification associated with FIG. 1, and/or vice versa).

In this way, the system can identify if element numbers are either missing from the specification or drawings, and if desired, can check against text portions associated with each figure against the figure.

FIG. 121 shows an example of a flow chart for determining missing element numbers and/or text in accordance with one aspect of the invention.

In step 12158, a figure is identified from the drawings. As discussed in the Related Patent Applications, the figure may be identified by a blobbing method, or metadata associated with the drawings, etc. In this example, FIG. 1 may be identified.

In step 12160, the text in the specification, claims, summary and/or abstract may be identified with respect to the figure. For example, at the text portion that includes “Figure 1” or the equivalent, the text may be identified and related to Figure 1.

In step 12162, the text identified with Figure 1 may be checked against the element numbers identified with Figure 1.

FIG. 122 shows an example of a flow chart for renumbering element numbers in the specification and figures of a patent document. For example, after a patent document is drafted, the element numbers may be out of order, or otherwise unstructured. The method presented herein allows a user to renumber the text of the patent document and the element numbers in the drawing figures to create an orderly element numbering for the document.

In step 12264, the elements may be identified from the specification. The elements may be found by identifying element numbers associated with element names, as discussed herein. The element names may then be ordered by their first appearance in the body of text. The ordered list also includes the element number associated with each element name in the text.

In step 12266, the element numbers in the figures may be identified. This can be, for example, by an OCR method or by metadata, etc.

In step 12268, the element names may be renumbered by their order of appearance in the text. The original element numbers are then mapped to new element numbers. The new element number (if changed) then allows the method to search/replace each original element number with the new element number. Similarly, the method renumbers the original element number in the drawings with the new element number. This may be accomplished, for example, where the drawing document contains text embedded for the element numbers, by replacing the old element number with the new element number. Alternatively, when the figures are purely graphical based, the method may save the size and location of the element number when found and replace the old element number text with a graphical representation of the new element text. This may be accomplished by determining the font, size, and location of the original text, applying a white area to that graphical text, and inserting the new element number in the same area. One of skill in the art will recognize that other methods exist for replacing text in a graphical document that may also be utilized.

FIG. 139 is a method for replacing element text with process block text.

In step 13926, a determination is made whether an element includes a process step indicator, such as “Step 10”.

In step 13928, the step indicator may then be associated with the matching process block in the figures.

In step 13930, the text in the specification may be related to the step indication may be replaced with the text from the process block in the figures.

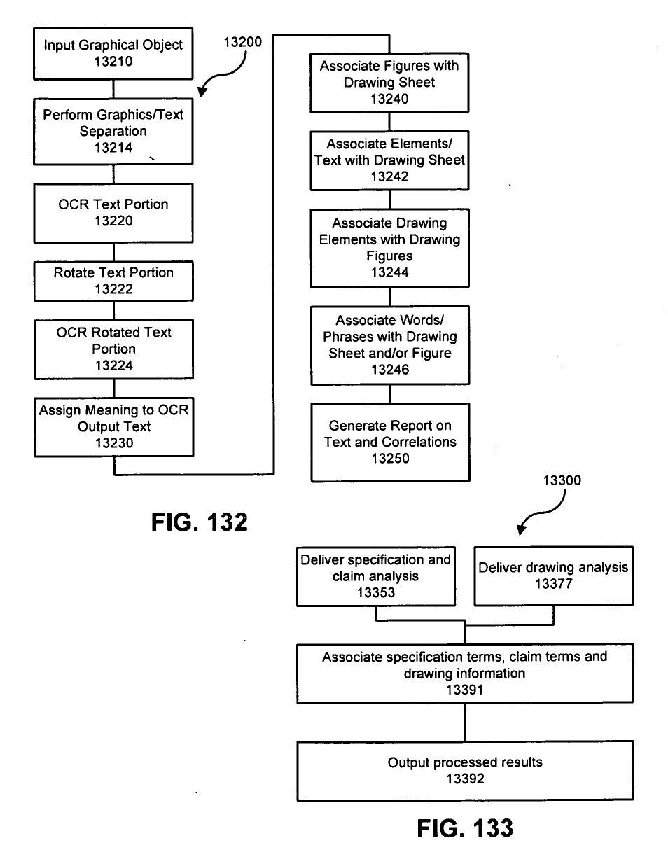

FIG. 132 is a method 13200 for identifying text elements in graphical objects, which may include patent documents. For the analysis of documents, it may be helpful to identify numbers, words, and/or symbols (herein referred to as “element identifiers”) that are mixed with graphical elements and text portions of the document, sections, or related documents. However, existing search systems have difficulty with character recognition provided in mixed formats. One example of a method for identifying characters in mixed formats includes separating graphics and text portions and then applying OCR methods to the text portions. Moreover, in some circumstances, the text portion may be rotated to further assist the OCR algorithm when the text portion further includes horizontally, vertically, or angularly oriented text.

Method 13200 is an example of identifying element numbers in the drawing portion of patent documents. Although this method described herein is primarily oriented to OCR methods for patent drawings, the teachings may also be applied to any number of documents having mixed formats. Other examples of mixed documents may include technical drawings (e.g., engineering CAD files), user manuals including figures, medical records (e.g., films), charts, graphics, graphs, timelines, etc. As an alternative to method 132, OCR algorithms may be robust and recognize the text portions of the mixed format documents, and the forgoing method may not be required in its entirety.

In step 13210, a mixed format graphical image or object is input. The graphical image may, for example, be in a TIFF format or other graphical format. In an example, a graphical image of a patent figure is input in a TIFF format that includes the graphical portion and includes the figure identifier as well as element numbers (e.g., 10, 20, 30) and lead-lines to the relevant portion of the figure that the element numbers identify.

In step 13214, graphics-text separation is performed on the mixed format graphical image. The output of the graphics-text separation includes a graphical portion, a text portion, and a miscellaneous portion, each being in a graphical format (e.g., TIFF).

In step 13220, OCR is performed on the text portion separated from step 13214. The OCR algorithm may now recognize the text and provide a plain-text output for further utilization. In some cases, special fonts may be recognized (e.g., such as some stylized fonts used for the word “FIGURE” or “FIG” that are non-standard). These non-standard fonts may be added to the OCR algorithms database of character recognition.

In step 13222, the text portion may be rotated 90 degrees to assist the OCR algorithm to determine the proper text contained therein. Such rotation is helpful when, for example, the orientation of the text is in landscape mode, or in some cases, figures may be shown on the same page as both portrait and landscape mode.

In step 13224, OCR is performed on the rotated text portion of step 13222. The rotation and OCR of steps 13222 and 13224 may be performed any number of times to a sufficient accuracy.

In step 13230, meaning may be assigned to the plain-text output from the OCR process. For example, at the top edge of a patent drawing sheet, the words “U.S. Patent”, the date, the sheet number (if more than one sheet exists), and the patent number appear. The existence of such information identifies the sheet as a patent drawing sheet. For a pre-grant publication, the words “Patent Application Publication”, the date, the sheet number (if more than one sheet exists), and the publication number appear. The existence of such information identifies the sheet as a patent pre-grant publication drawing sheet and which sheet (e.g., “Sheet 1 of 2” is identified as drawing sheet 1). Moreover, the words “FIG” or “FIGURE” may be recognized as identifying a figure on the drawings sheet. Additionally, the number following the words “FIG” or “FIGURE” is used to identify the particular figure (e.g., FIG. 1, FIGURE 1A, FIG. 1B, FIGURE C, relate to figures 1, 1A, 1B, C, respectively). Numbers, letters, symbols, or combinations thereof are identified as drawing elements (e.g., 10, 12, 30A, B, C1, D′, D″ are identified as drawing elements).

In step 13240, each of the figures may be identified with the particular drawing sheet. For example, where drawing sheet 1 of 2 contains figures 1 and 2, the figures 1 and 2 are associated with drawings sheet 1.

In step 13242, each of the drawing elements may be associated with the particular drawing sheet. For example, where drawings sheet 1 contains elements 10, 12, 20, and 22, each of elements 10, 12, 20, and 22 are associated with drawing sheet 1.

In step 13244, each of the drawing elements may be associated with each figure. Using a clustering or blobbing technique, each of the element numbers may be associated with the appropriate figure.

In step 13246, complete words or phrases (if present) may be associated with the drawing sheet, and figure. For example, the words of a flow chart or electrical block diagram (e.g., “transmission line” or “multiplexer” or “step 10, identify elements”) may be associated with the sheet and figure.

In step 13250, a report may be generated that contains the plain text of each drawing sheet as well as certain correlations for sheet and figure, sheet and element number, figure and element number, and text and sheet, and text and figure. The report may be embodies as a data structure, file, or database entry, that correspond to the particular mixed format graphical image under analysis and may be used in further processes.

In FIG. 133, a process flow 13300 shows an example for associating the specification terms, claim terms and drawing element numbers in step 13310. For example, information relating to specification terms, element numbers, claim terms and drawing element numbers, figures and locations are matched up. In step 13320, a server/processor outputs results to the user for further processing.

Referring now to FIG. 120, another embodiment of the present invention is shown described. In FIG. 120, server/processor 210 executes an algorithm as shown in FIG. 120. The algorithm of FIG. 120 begins with step 12052 where the element numbers in a patents or patent application are identified. In one example, on the numbers are identified through an optical character recognition program as described in the Related Patent Applications

In step 12054, the element numbers in the specification are identified by server/processor 210. In one example, the element numbers are identified as described in the related patent applications.

In step 12056, the element numbers in the specification are compared against the element numbers in the drawings the report is output showing element numbers that do not appear either the specification or the drawings. Accordingly, a patent drafter can determine whether or not elements in the text were either not put in the drawings or whether element numbers in the drawings do not have corresponding elements in the text.

Referring now to FIG. 121, another embodiment of the invention a show that described. In FIG. 121, server/processor 210 executes an algorithm starting with step 12158 where specific figures are identified in a patent or patent application. The figures may be identified by looking at the specification and teachers out of the figure as discussed in the Related Patent Applications. The element numbers in that figure are then read by server/processor 210.

In step 12160, the text associated with the particular figure is identified in the specification. In one example, the text is identified through looking for the term “figure” with the correct figure number and the associated paragraph in which it is located. Other means also may be employed to identify the requisite text as described in the Related Patent Applications.

In step 12162, the element numbers in the text related to the figure are compared to the element numbers in the figure it's self to determine whether or not element numbers are missing from the specification or the figure.

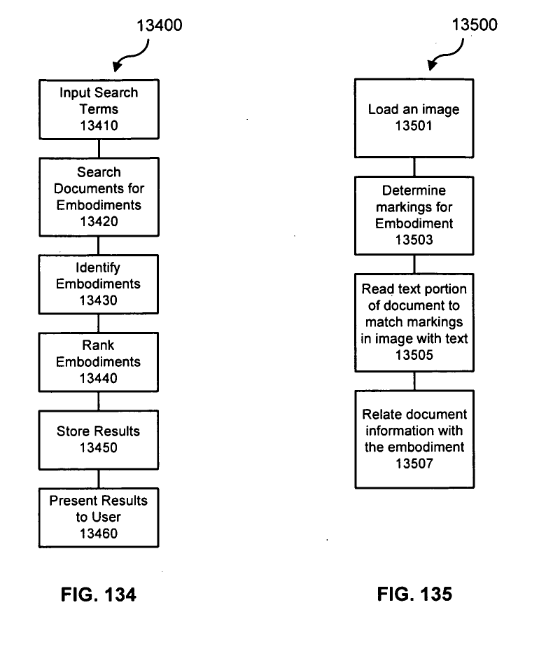

FIG. 134 is a method of searching.

In step 13410, the user may input search terms. The user in this case may also be another system.

In step 13420, a search may be performed on a collection of documents. The search may not be performed to identify the document per-se, but may be identifying embodiments within each document for later ranking and/or analysis.

In step 13430, the embodiments within each document may be identified.

In step 13440, the embodiments may be ranked according to a ranking method. For example, a general relevancy ranking method for may be used for patent documents and embodiments within the patent documents.

In an example, the search may include the element name/numbers as indexed for each figure in the document. The figures may be considered embodiments for the purposes of this example. The index may then be searched and the results may identify, for example, FIG. 1 of a first document, and FIG. 8 for a second patent document. Each of the embodiments may be ranked according to the existence of the search terms in the embodiments. For example, where an embodiment includes all of the search terms, this embodiment may be given a higher ranking than a second embodiment that includes fewer of the search terms. The result may then identify the embodiment, e.g., as showing that figure in the result, as well as the underlying document that the embodiment was found in.

In an alternative example, the ranking may be provided as a combination of the patent documents with the embodiments within the documents. For example, the least relevancy is provided by term hits in the background section of the document. The highest relevancy is provided by all of the search terms used in the same drawing figure. In an example, the user may search for terms X, Y, Z in patent documents. Relevancy may be based on keywords being in the same figures and in the same text discussion (e.g., same section, same paragraph). An example of a ranking of search results is provided. Rank 0 (best) may be when X, Y, Z are used in the same figure (e.g., an example of an embodiment) of a document. Rank 1 may be when X, Y, are used in same figure of a document, and Z is used in different figures of the document. Rank 2 may be when X, Y, Z are used in different figures of the document. Rank 3 may be when X, Y, Z are found in the text detailed description (but not used as elements in the figures). Rank 4 may be when X, Y, Z are found in the general text (e.g., anywhere in the text) of the document, but not used as elements in the figures. Rank 5 (worst) may be when X, Y are discussed in the text, and Z is found in the background section (but not used as elements in the figures). In this way, a generalized search of patent documents can be performed with high accuracy on the relevancy of the documents.

In step 13450, the results may be stored, for example, on a server or in memory.

In step 13460, the results may be presented to the user in a general search result screen, in a report, or in a visual search result where the figure associated with the embodiment is shown.

FIG. 135 is a method of identifying embodiments in a patent document.

In step 13501, an image/figure in a document is loaded. This may be provided as one of plurality of figures identified in the document analysis as described herein and in the Related Patent Documents.

In step 13503, the markings for the may be determined. This may include retrieving the associated element names related to the element numbers found in the figure.

In step 13505, the text associated with the figure may be determined. For example, where FIG. 1 is being processed, the text portion related to that figure may be identified. This may include, for example, the text including and between where FIG. 1 is mentioned and the text where another figure is mentioned.

In step 13507, the document information, that may include the element names/numbers and the text associated with the embodiment, may be related to the embodiment. The text to at least partially define the embodiment may include the figure number(s), the element names and or numbers associated with the figure(s), the specification text, background, summary, and/or claims text associated with the figure(s). This embodiment information may then be associated with the document, or separately as an embodiment, in metadata or another structure, or indexed for searching. When searched, the search method may then search the documents, and/or the embodiments.

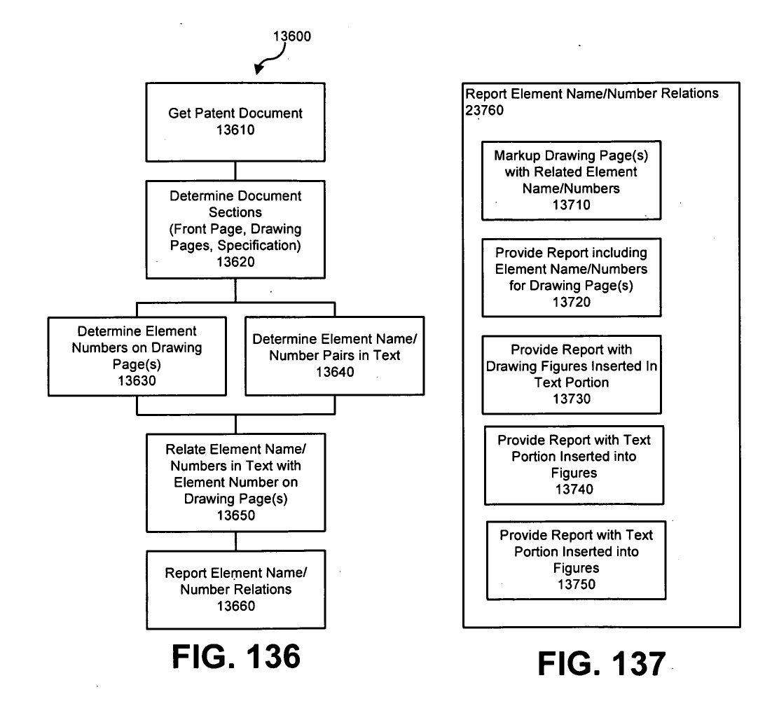

FIG. 136 is a flow diagram for a report generator related to patent documents.

In step 13610, a patent document may be identified and/or retrieved from a repository. The identification, for example, may be by a user inputting a document number, or for example, by a result from a search or other identifying method.

In step 13620, the document may be analyzed, for example, by determining document sections for the front page, drawing pages, and specification. Additional document sections may be identified from a graphical document, full text document, or mixed graphical (e.g., for the figures) and text for the text portion (e.g., the specification).

In step 13630, the element numbers may be determined for each drawing page and/or each figure on the drawing pages.

In step 13640, the element name/number pairs may be identified from the text portion of the document.

In step 13650, the element name/numbers from the text portion may be related to the element numbers found in the figures and drawing pages. The relation may also extend, for example, to the claims (for identifying potential element names/numbers in the specification and relating them to the claims), and relating to the summary, abstract, and drawings. Indeed, each of the drawing pages, drawing figures, detailed description, claims, abstract, summary, etc. may be related to each other.

In step 13660, a report may be generated and provided to the user having useful information about the relation of element names/numbers in the entire document. Examples of reports are described with respect to FIG. 27, among others, and additionally in the Related Patent Documents.

FIG. 137 is a flow diagram for a report generator related to patent documents, related to step 13660 of FIG. 136. Each of the steps described herein may be used independently or in combination with each other.

In step 13710, a report may be generated with the element names and numbers placed on each drawing page. This may assist the reader of the patent document with understanding the figures, and the entire document, more rapidly by allowing the reader to find the element names quickly, rather than having to search through the patent document. In an example, the element numbers from each drawing page may be determined, as discussed herein and as discussed in the Related Patent Documents. The element numbers may then be related to the text portion to determine the element name/numbers. The element name/numbers may then be added to the drawing page. In another example, the element name/numbers may be added to the drawing page near the figures, rather than the whole page. In another example, the element names may be added to the figures near the appearance of the element number in the figures to provide labeling in the figures, rather than a listing on the page. Alternatively, the element name/numbers may be added, for example, to the PDF document on the back side of each page. This may allow the reader to simply flip the page over to read it when printed. At the user's preference, this labeling scheme may be less intrusive if the user desires the original drawings to remain clean and unmarked.

In step 13720, an example of a report may include a separate page for the “parts list” of element name/numbers for the patent document. In another example, a report may be generated that includes the element names/numbers associated with each figure. This may include a header identifying the figure, and then a listing of the element name/numbers for that figure.

In step 13730, the report may include the figure inserted in the text portion. This may include reformatting the dual-column format of a standard patent document to a different format, and interstitially placing the appropriate figure in the text so that the reader need not refer to a separate drawing page. The insertion of the drawing figure may allow the reader to quickly understand the patent document by simply reading through the text portion, and referring to the figure directly from the text portion. The reformatted patent document may also include cites inserted for the original column number so that the reader may quickly orient themselves with the original dual-column format for column/line number citation.

Alternatively, a report may be generated for the claims portion that includes the claim and additional information. For example, a listing of drawing figures associated with each claim may be inserted. The relevant figures may be determined from the relation of claim terms with the figure's element names. The figure may also be inserted with the claims for quick reference. The figure may be scaled down, or full sized.

In step 13740, the report may include related portions of the text from the patent document inserted into the figure region. Where a figure is introduced in the specification, for example, that paragraph of text may be inserted into the drawing figure page, or on the back of the page, for quick reference.

In step 13750, the report may include a reformatted drawing page portion that includes the figure and additional information. For example, the additional information may include the associated element names/numbers, the column/line number and/or paragraph number where the figure is first introduced. It may also include the most relevant paragraph from the specification related to the figure. It may also include a listing of claims and/or claim terms related to the figure.

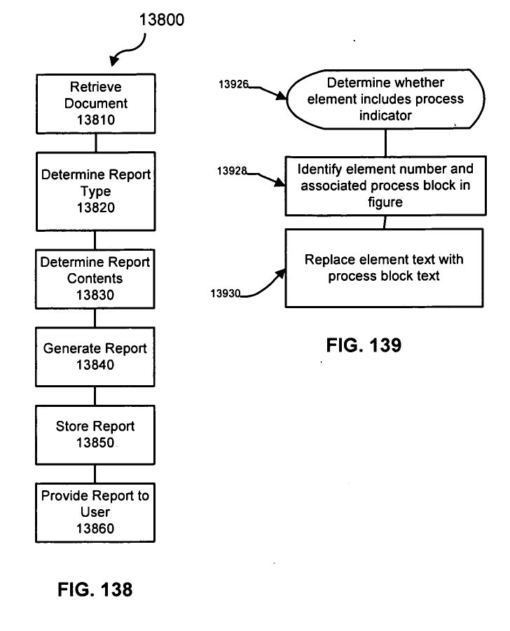

FIG. 138 is an example of a document retrieval and report generation method.

In step 13810, a document may be identified and/or retrieved from a repository. The identification may be by a user or by another method, e.g., a search result.

In step 13820, the report type is determined. For example, the user may specify a report type having marked up drawings, an element listing, a patent document having figures placed interstitially with the text, etc. Examples of various report types are described above with respect to FIG. 137.

In step 13830, the method may determine the contents of the report based on the report type chosen. For example, where the user chooses marked up drawings, the report contents may include a standard patent document with element names/numbers placed in the drawings.

In step 13840, the report may be generated by a system or method, as discussed herein and in the Related Patent Documents.

In step 13850, the report may be stored, for example, in memory and/or a disk.

In step 13860, the report may be provided to the user for download, viewing, or storage.

All terms used in the claims are intended to be given their broadest reasonable constructions and their ordinary meanings as understood by those skilled in the art unless an explicit indication to the contrary is made herein. In particular, use of the singular articles such as “a,” “the,” “said,” etc. should be read to recite one or more of the indicated elements unless a claim recites an explicit limitation to the contrary.

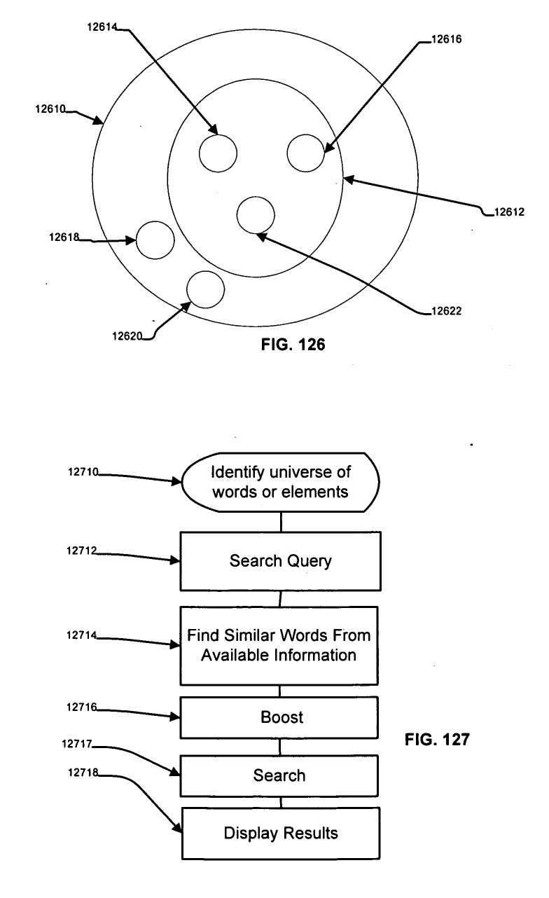

Referring now to FIG. 126, another embodiment of the invention is shown and described. In FIG. 126, an illustrative example of a search is conducted. Border 12610 represents an outer border of a search conducted, classification selected or all of the available information in a database (for example the USPTO or EPO databases). The search may represent all available information prior to the search, the results of a keyword search, or classes or multiple classes or subclasses. Within the border 12610 lies the available universe of information, such as the information 12616, 12618, 12620, 12614 and 12622. The available universe of information may include the elements in the patents falling within a class defined by the border. The available universe of information may include simply the words or numbers falling within the border. For example, if a classification is selected, the information 12616, 12618, 12620, 12614 and 12622 may represent all of the elements, element numbers or individual words or other information in each of the patents within the classification. Likewise, if a word search is conducted, the elements may be the elements, numbers or words or other information being within any of the patents resulting from the word search.

As the search is refined, the border shrinks to border 12612 with the available information 12614, 12616 and 12622 and information 12618 and 12620 is no longer being within the available universe of information defined by the search or class selection. For example, if a word search is conducted that weeds out U.S. Pat. No. 1,234,567 and that patent is the only patent that contains element A, that element will no longer be within the available information

Referring to FIG. 127, a method is provided for identifying and using similar words, such as synonyms, in connection with any of the described search algorithms. The process begins with step 12710 where the available universe of information is identified. The universe of information may be elements, element numbers, figure numbers, words or other information.

In step 12712, a search query is entered through any of the algorithms described or otherwise known in the art by server/processor 210.

In step 12714, the available universe of information is determined based on the search and similar words are determined. In one example, the similar words are synonyms of the search terms that are within the available universe of information. For example, the search term may be “gear” and a word within the universe of available information may be “cog.” In another example, the similar words are elements in the available universe of information having any combination that includes any of the search terms. For example, the search term may be “connector” and the element may be “connector portion.”

In step 12716, the similar words are boosted in accordance with that described in the present application for different usages. For example, if a word in the universe of available information matches the search term, it may be given a certain boosting. If the search term exactly matches an element, it may be given a certain boosting. If the search term is a subset or superset of an element, it may be given a certain boosting. If a word in the available information is a synonym of the search term, it may be given a certain boosting.

In another example, a word in the available universe of information may be given a boosting depending on how many times it occurs in the available universe of information. For example, word A may be used the most frequently in the available universe of information. Word A may also be a synonym of a search term. Therefore, word A would be boosted a certain amount because it is both a synonym and used most frequently.

In step 12717, a search is conducted based on the above boosting. In step 12718, the search results are output to the user.

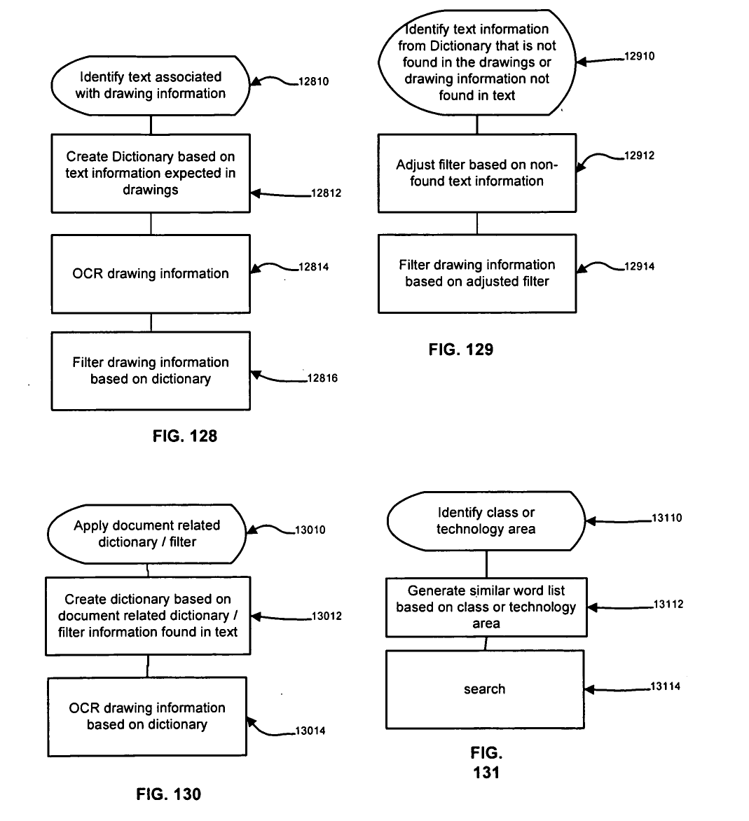

Referring now to FIG. 128, another embodiment as is shown and described. In FIG. 128, a process for OCR is shown that employs a dictionary generated from text portion corresponding to a document such as a patent. In FIG. 128, the process includes step 12810 where information associated with a drawing or other information to be OCR is identified. Such information may be figure numbers, element numbers, the word “figure” or “fig” or other information read from the text.

In step 12812, a dictionary for OCR is built from the information. In step 12814, OCR is performed on the drawing information. In step 12816, the OCR information is filtered according to the dictionary. In one example, only information in the dictionary is recognized as text information from the OCR process. Such may be accomplished by adjusting the filtering processing conducted by the OCR process.

In step 12816, the text information is output from the OCR process.

In another example shown in FIG. 130, a pre-dictionary is developed based on information expected to be in the drawings based on document type. For example, in step 13010, the type of document is recognized or the type of information expected to be in a particular document is recognized. For example, where the document is a patent, element numbers, figure numbers and different forms of the word figure may be expected to be in accompanying drawings and a dictionary or filter built accordingly. Thus, other information in the document, such as particular words or element names for example, may be ignored due to that information not being typically being in the drawings for patents. For a medical records document, for example, different information may be expected to be found in drawings and the pre-dictionary developed accordingly.

In step 13012, a dictionary is built based on the expected information found in the document. For example, in a patent document, the expected information in the drawings is element numbers, figure numbers and varying forms of the word figure. Thus, in step 13012, this information is identified in the text. Thus, patent numbers, inventor names, and element names may be filtered out from the dictionary.

Expected patterns may also be applied by the process in step 13010 regardless of the presence or absence of information in the text. For example, where the numbers identified in the text are numbered sequentially (10, 12 . . . 42), it may be recognized in step 13010 that there should be even numbers from 10-42 and the expected information would include such including the number 40. In step 13012 therefore, the number “40” is added to the dictionary even if the number is not found in the text.

Similarly, specific fields such as the brief description of the drawings may be reviewed to identify the figure numbers expected to be in the drawings. For example, the brief description of the drawing section is first identified (or other suitable section), the specific information such as the figure numbers is next identified, and the dictionary created accordingly.

In step 13014, the OCR process is conducted in accordance with the dictionary built.

In FIG. 129 another embodiment is shown and described. In FIG. 129, a process is described for adjusting a filter corresponding with an OCR process. In step 12910, information not found in either the text or drawings is identified. For example, expected information generated in the dictionary developed from the text portion of a specification includes the element number 10 and that element number 10 is not found in the drawings. Or, where the OCR process outputs an element number such as the number 10 and that information is not found in the text.

In step 12912, filtering for the OCR process is adjusted correspondingly. In one example, where the information is found in the text but not the drawings, the filter for the OCR is relaxed or expanded and the OCR process is repeated in step 12914 to determine if the information is actually in the drawings but was not read by the OCR process.

In another example, where information is found in the drawings, such as an element number (for example “3”) and that information is not found in the text, the filter may be tightened and the OCR process repeated in step 12914 to determine whether the OCR process read a false positive.

Referring now to FIG. 131 another embodiment is shown and described. In FIG. 131, an algorithm for identifying and conducting a search based on similar words is shown and described. In step 13110, a classification or technology area is identified based on the search conducted. For example, a user may select a US classification. Or, processor 210 may conduct a search to identify a classification based on occurrences of search terms in the classification title of the classification or the text as elements or words for example or drawings of the patents within the classification. For example, processor 210 may determine the most occurrences of search terms in a particular classification and deem that the classification for purposes of identifying similar words.

In step 13112, similar words are generated. For example, if a classification is identified for gearing, then similar words for teeth may include cog as it would be a word found within that class, but may not include molar or dental device if those words are not found within that classification.

In step 13114, a search is conducted as described in this application. The search may be beyond the classification or technology area, but for purposes of identifying similar words, the universe of available information would include only those words or elements found within the classification or technology area.

With regard to the processes, methods, heuristics, etc. described herein, it should be understood that although the steps of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted. In other words, the descriptions of processes described herein are provided for illustrating certain embodiments and should in no way be construed to limit the claimed invention.

Accordingly, it is to be understood that the above description is intended to be illustrative and not restrictive. Many embodiments and applications other than the examples provided will be apparent upon reading the above description. The scope of the invention should be determined, not with reference to the above description, but should instead be determined with reference to the appended claims, along with the full scope of equivalents to which such claims are entitled. It is anticipated and intended that future developments will occur in the arts discussed herein, and that the disclosed systems and methods will be incorporated into such future embodiments. In sum, it should be understood that the invention is capable of modification and variation and is limited only by the following claims.

All terms used in the claims are intended to be given their broadest reasonable constructions and their ordinary meanings as understood by those skilled in the art unless an explicit indication to the contrary is made herein. In particular, use of the singular articles such as “a,” “the,” “said,” etc. should be read to recite one or more of the indicated elements unless a claim recites an explicit limitation to the contrary.

1-11. (canceled)

12. A computer implemented method, comprising:
receiving a document, wherein the document includes text and graphics;
identifying a location of at least a first alphanumeric reference in the graphics;
identifying at least a second alphanumeric reference in the text; and
associating the second alphanumeric reference with the location of the first alphanumeric reference.

13. The computer implemented method according to claim 12, wherein the location is a member of a set consisting of a page or a figure.

14. The computer implemented method according to claim 13, wherein the location is a position on a page associated with the first alphanumeric reference.

15. The computer implemented method according to claim 13, wherein at least two different second alphanumeric references are respectively associated with at least two different locations.

16. The computer implemented method according to claim 12, wherein the location is an absence or presence of the first alphanumeric reference in the graphics.

17. The computer implemented method according to claim 12, further comprising:
receiving a search term;
associating the search term with the second alphanumeric reference; and
associating the search term with the location through the second alphanumeric reference.

18. The computer implemented method according to claim 17, further comprising labeling a position in the graphics associated with the location with the search term.

19. The computer implemented method according to claim 13, comprising identifying the location as relevant to the search term.

20. The computer implemented method according to claim 12, further comprising:
labeling a portion of the graphics associated with the location with the second alphanumeric reference;
wherein at least a portion of the first alphanumeric reference is different from at least a portion of the second alphanumeric reference.

21. The computer implemented method according to claim 12, further comprising:
creating an index of a plurality of second alphanumeric references;
associating the plurality of second alphanumeric references in the index with a plurality of locations in the graphics.

22. The computer implemented method according to claim 21, wherein the plurality of locations is a plurality of positions of respective ones of a plurality of first alphanumeric references.

23. The computer implemented method according to claim 22, further comprising identifying the plurality of first alphanumeric references in the graphics as associated with the plurality of alphanumeric references in the index.

24. The computer implemented method according to claim 21, wherein the plurality of second alphanumeric references in the index are positioned proximate identifications of the locations in the index.

25. The computer implemented method according to claim 12, further comprising:
identifying the second alphanumeric reference based on a grammar type of the second alphanumeric reference or a grammar type of a word located adjacent to the second alphanumeric reference and a first alphanumeric reference in the text.

26. The computer implemented method according to claim 12, further comprising:
the second alphanumeric reference in the text proximate the first alphanumeric reference;
the second alphanumeric reference in the text is associated with the first alphanumeric reference in the graphics through the first alphanumeric reference in the text.

27. A computer implemented method, comprising:
receiving a document, wherein the document includes text and graphics;
identifying a page or a figure in which at least a first alphanumeric reference in the graphics is located;
identifying at least a second alphanumeric reference in the text, wherein at least a portion of the first alphanumeric reference is different from at least a portion of the second alphanumeric reference;
associating the second alphanumeric reference with the page or figure of the first alphanumeric reference; and
labeling the graphics with the second alphanumeric reference at a position associated with the page or figure.

28. The computer implemented method according to claim 27, further comprising associating a search term with the second alphanumeric reference.

29. A system, comprising:
A processing device programmed to:
receive a document, wherein the document includes text and graphics;
identify a page or a figure in which at least a first alphanumeric reference in the graphics is located;
identify at least a second alphanumeric reference in the text, wherein at least a portion of the first alphanumeric reference is different from at least a portion of the second alphanumeric reference; and
associate the second alphanumeric reference with the page or figure of the first alphanumeric reference.

30. The system according to claim 29, wherein the processing device is further programmed to:
label the graphics with the second alphanumeric reference at a position associated with the page or figure.

31. The system according to claim 29, wherein the processing device is further programmed to:
identify the page or figure relevant to the second alphanumeric reference.
